(19) United States
(12) Patent Application Publication
(10) Pub. No.: US 2024/0278494 A1
(43) Pub. Date: Aug. 22, 2024

(54) THREE-DIMENSIONAL ADDITIVE FABRICATION WITH SUPPORT FLUID

(71) Applicant: GEORGIA TECH RESEARCH CORPORATION, Atlanta, GA (US)

(72) Inventors: Nicholas Steven MULKA, Oakwood, GA (US); Amit S. JARIWALA, Marietta, GA (US); Kevin GE, Macungie, PA (US); David W. ROSEN, Marietta, GA (US); Robert E. SCHWERZEL, Johns Creek, GA (US)

(21) Appl. No.: 18/292,693

(22) PCT Filed: Jul. 26, 2022
(86) PCT No.: PCT/US2022/038368

§ 371 Date: Jan. 26, 2024

Related U.S. Application Data
(60) Provisional application No. 63/225,743, filed on Jul. 26, 2021.

(51) Int. Cl. B29C 64/245; B29C 64/124; B29C 64/255; B29C 64/264; B29C 64/393; B33Y 10/00; B33Y 30/00; B33Y 50/02

(52) U.S. Cl. CPC B29C 64/245; B29C 64/124; B29C 64/255; B29C 64/264; B29C 64/393; B33Y 10/00; B33Y 30/00; B33Y 50/02; B29K 2995/0065

(57) ABSTRACT

This disclosure provides methods and systems for the additive manufacturing of three-dimensional workpieces using a support fluid build. In one aspect, a method is provided for forming a three-dimensional workpiece, the method comprising dispensing a resin in a liquid state into a container, irradiating at least a portion of the resin layer at the fluid interface with light to polymerize an irradiated portion of the resin layer as a current build layer of the three-dimensional workpiece at the fluid interface, wherein a portion of the three-dimensional workpiece is affixed to a build platform immersed in the support fluid; and advancing the build platform to a next position in the support fluid to submerge the current build layer within the support fluid. The process is repeated to successively build the workpiece in the support fluid.

### CROSS-REFERENCE TO RELATED APPLICATIONS

This application claims the benefit of priority to U.S. Provisional Application No. 63/225,743, filed Jul. 26, 2021, the disclosure of which is incorporated herein by reference in its entirety.

### TECHNICAL FIELD

This disclosure relates to additive manufacturing methods and systems, and more particularly to such methods and systems, which can diminish or eliminate the need for sacrificial support structures that would otherwise have to be removed from the final printed object.

### BACKGROUND

Conventional polymer-based 3D printing solutions such as material extrusion, vat photopolymerization, and material jetting systems employ sacrificial support structures to build overhangs (support structures below overhanging geometry) to stabilize the workpiece in place. The sacrificial support structures ensure components of a workpiece are secured together during the print process without deflection from forces incurred during the printing process.

Fabrication of sacrificial support structures can increase the print time while wasting material and adding cost. In polymer powder bed fusion fabrication, a non-reusable powder bed has been used to act as a supporting medium for fabricated geometry. The powder bed can further leave indentations within the part, and the addition of the powder between layers increases print time. There is often additional post-processing time and cost to remove the intermediate supporting structures and address rough surface finishes.

Concepts for mitigating the challenges of support structures have been developed for these methods of additive manufacturing. One strategy reduces the need for manual support structure removal by printing with a dissolvable material. When a print is completed, the part can be soaked in the proper solution to remove the dissolvable supporting structures.

Similarly, the use of soluble support structures in material extrusion (such as fused deposition modeling (FDM)) is commercially available, but the technology still lacks widespread adoption due to the increased system complexity and cost. Another approach employs a dynamic print bed that can change its shape to support overhangs as a part is printed with powder-based AM. Multi-Degree of Freedom printers have been created for FDM printing, with actuation technology to minimize the need for supporting structures through the rotation of the platform or deposition nozzle. During the printing process, the build platform or nozzle rotates as needed to redistribute the weight of the segment that is being printed.

While there have been successful advancements in support structure reduction in other types of additive manufacturing, these have not translated to vat photopolymerization systems, such as stereolithography (SLA). SLA cannot implement multi-axis fabrication to adjust the planarity of the build surface due to the liquid resin within the system and cannot implement dissolvable support material due to the single-material composition of the build vat. The quantity of support structures present within stereolithography remains one of the largest across all AM processes, with the most room for improvement.

Thus, there is a clear need for improved additive manufacturing methods, especially those which reduce the need for support structures in the build.

### SUMMARY

The present disclosure provides methods and systems for forming three-dimensional workpieces by additive manufacturing (e.g., stereolithography) that reduce, or in some instances, eliminate, the need for support structures in the build. The disclosed methods and systems reduce the need for support structures by submerging the build into a support fluid during construction. This fluid provides physical support to structures that would otherwise require the use of support structures in prior additive manufacturing systems. This reduces the need to incorporate support structures in the build design, along with their subsequent removal once manufacturing of the workpiece is complete.

In one aspect, a method is provided for forming a three-dimensional workpiece, the method comprising:
(i) dispensing a resin in a liquid state into a container configured to house a support fluid to form a fluid interface having (a) a resin layer above and in immediate contact with (b) the support fluid, wherein the resin is substantially immiscible with the support fluid;
(ii) irradiating at least a portion of the resin layer at the fluid interface with light to polymerize an irradiated portion of the resin layer as a current build layer of the three-dimensional workpiece at the fluid interface, wherein a portion (e.g., first layer portion) of the three-dimensional workpiece is affixed to a build platform immersed in the support fluid; and
(iii) advancing the build platform to the next position in the support fluid to submerge the current build layer within the support fluid,
wherein the process (i), (ii), and (iii) is repeated to successively build the workpiece in the support fluid.

In another aspect, a liquid additive manufacturing system (e.g., stereolithography system) is disclosed for building a three-dimensional workpiece is also provided, the system comprising:
a container configured to house a support fluid;
a dispensing module configured to dispense a resin into or over the support fluid of the container to form a fluid interface having a resin layer above and in immediate contact with the support fluid, wherein the resin is substantially immiscible with the support fluid;
a light projection system configured to irradiate and polymerize a portion of the resin layer at the fluid interface with light to form a top polymer layer;
a mechanized-arm system (or mechanical system) having a build platform immersed in the support fluid of the container; and
a controller having (i) a processor and (ii) memory operatively coupled to the process and having instructions stored thereon, wherein execution of the instructions causes the process to direct a successive layer-by-layer build of the workpiece in the support fluid by:
   directing the dispensing module to dispense a current resin portion to form a current fluid interface of the workpiece over the support fluid, wherein the workpiece has a layer (e.g., a first layer) coupled to the build platform of the mechanized-arm system;
   directing the light projection system to irradiate a portion of the current resin portion at the current fluid interface with light to polymerize the irradiated portion as a current build layer of the workpiece; and
      advancing the build platform of the mechanized-arm system into the next position in the support fluid to submerge the current build layer within the support fluid.

Also provided are three-dimensional workpieces produced by the methods and systems described herein.

The details of one or more embodiments of the disclosure are set forth in the accompanying drawings and the description below. Other features, objects, and advantages of the disclosure will be apparent from the description and drawings and from the claims.

### DESCRIPTION OF DRAWINGS

FIG. 1 shows an example liquid additive manufacturing system for building a three-dimensional workpiece in accordance with an illustrative embodiment.

FIG. 2 shows an example liquid additive manufacturing system configured with a build window in accordance with an illustrative embodiment.

FIG. 3 provides a diagram of a discrete, cured layer of resin in the liquid additive manufacturing system.

FIG. 4 shows a diagram of an example control operation for the light projection system and mechanized-arm subsystem of the system of FIG. 1.

FIG. 5 shows an example build interface between the support fluid and resin layer for the liquid additive manufacturing system of FIG. 1.

FIG. 6 shows an example build interface among the support fluid, resin layer, and build window for the liquid additive manufacturing system of FIG. 2.

FIG. 7 shows an example liquid additive manufacturing system (referred to as the Fluid Interface Supported Printing (FISP) system) that was fabricated in the examples.

FIG. 8 provides a diagram of the control system of the system of FIG. 7.

FIG. 9 shows overhang not requiring support (top) and overhang requiring supporting anchors due to geometric spacing (bottom).

FIG. 10 shows a disk-shaped droplet of a photopolymerizable liquid resin droplet on the supporting solution as it begins to spread.

FIGS. 11A-11C show modeling of the surface wetting configurations relevant to the FISP system.

FIGS. 12A, 12B show a fluid spreading experimental setup for the FISP system of FIG. 7.

FIGS. 13A-13K show results and analysis of surface wetting, resin flow, and resulting polymerization experiments for the system of FIG. 7.

FIGS. 14A-14E show various optical components of the FISP optical system.

FIG. 15 shows overhang geometry test prints using and not using a build window.

FIGS. 16A-16E show mechanical and electrical subassemblies of the FISP system.

FIG. 17 is a representative user interface for the FISP system of FIG. 7.

FIG. 18A shows the variance of cure depth between two experiments with near identical independent variables due to differences in optical characteristics.

FIG. 18B shows the variance of resin curing behavior for identical material compositions and similar process parameters, experimentally separated by two months.

FIG. 18C shows 10% molar concentration of photoinitiator (PI), 5% 1,6-Hexanediol diacrylate (EHA) cantilever beam data and curve fit from FISP (11,18) and unconstrained (17,19) experimental results, displaying curvature difference dependent on the UV power.

FIG. 18D shows a diagram of the part geometry between the fluid interfaces of interest.

FIG. 18E shows the expected forces on cured part geometry for three separate steps: immediately after polymerization (2), during part lowering (3), and when the printed part is in location for a new layer to be added (4).

FIG. 18F shows a diagram of deflection due to density differences within the FISP system.

FIG. 18G shows the model and experimentation for deflection due to density differences within the FISP system (top) and in air (bottom).

FIG. 18H shows the surface tension vector differences in the top-down FISP system with a resin-liquid boundary (left) and traditional bottom-up SLA with a liquid-vapor boundary (right).

FIG. 18I shows the experimental setup to determine the work of surface tension γ in traditional bottom-up SLA process.

FIG. 18J shows the resulting force from the weight of the sample and the reactionary surface tension force, displaying the force from surface tension equal to 1.1 mN.

FIG. 18K shows unsupported overhand feasibility testing with Formlabs resin in early experimentation.

FIG. 18L shows thin layer deformation in a cantilever print from a Formlabs printer (left) and during polymerization within the FISP system (right).

FIG. 18M shows deflection from internal stresses in a cantilever beam explained due to inhomogenous and gradient polymerization and methods of its mitigation.

FIG. 18N shows the comparison of different exposure times for a 10% molar DMPA, 5% molar EHA solution exposed to 15.5 mW of UV light, inside and outside of the supporting solution.

FIG. 18O shows the lateral width (mm) averages across the cantilever beam trials with mask 8 compared. The figure indicates a linear correlation between the mol fraction of the photoinitiator and the lateral width.

FIG. 18P shows an unsupported bridge geometry comparison between a FISP print and a commercial SLA printer.

FIG. 18Q shows the fabrication results for two sets of unsupported geometry within the FISP system: a single layer cantilever (left) and a 20 layer 15° overhang (right) using 15% PI, 5% EHA.

Like reference symbols in the various drawings indicate like elements.

### DETAILED DESCRIPTION

The following description of the disclosure is provided as an enabling teaching of the disclosure in its best, currently known embodiments. Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As can be apparent to those of skill in the art upon reading this disclosure, each of the individual embodiments described and illustrated herein has discrete components and features that may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by,” “comprising,” “comprises,” “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of” As used in the specification and the appended claims, the singular forms “a,” “an” and “the” include plural referents unless the context clearly dictates otherwise. Thus, for example, reference to “a resin,” “a support fluid,” or “a build platform,” includes, but is not limited to, two or more such resins, support fluids, or build platforms, and the like.

It should be noted that ratios, concentrations, amounts, and other numerical data can be expressed herein in a range format. It can be further understood that the endpoints of each of the ranges are significant both in relation to the other endpoint and independently of the other endpoint. It is also understood that there are a number of values disclosed herein and that each value is also herein disclosed as “about” that particular value in addition to the value itself. For example, if the value “10” is disclosed, then “about 10” is also disclosed. Ranges can be expressed herein as from “about” one particular value and/or to “about” another particular value. Similarly, when values are expressed as approximations, by use of the antecedent “about,” it can be understood that the particular value forms a further aspect. For example, if the value “about 10” is disclosed, then “10” is also disclosed.

When a range is expressed, a further aspect includes the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z.’Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity and thus, should be interpreted in a flexible manner to include not only the numerical values explicitly recited as the limits of the range but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed of “adjacent” another feature can have portions that overlap or underlie the adjacent feature.

Spatially relative terms, such as “under,” “below,” “lower,” “over,” “upper,” and the like, may be used herein for ease of description to describe an element's or feature's relationship to another element(s) or feature(s) as illustrated herein. It will be understood that the spatially relative terms are intended to encompass different orientations of the device in use or operation in addition to the orientation depicted herein. For example, if the device is inverted, elements described as “under” or “beneath” other elements or features would then be oriented “over” the other elements or features. Thus, the exemplary term “under” can encompass both an orientation of over and under. The device may otherwise be oriented (e.g., rotated 90 degrees or at other orientations), and the spatially relative descriptors used herein interpreted accordingly. Similarly, the terms “upwardly,” “downwardly,” “vertical,” “horizontal,” and the like are used herein for the purpose of explanation only unless specifically indicated otherwise.

It should be understood that, although the terms first, second, etc., may be used herein to describe various elements, components, regions, layers, and/or sections, these elements, components, regions, layers, and/or sections should not be limited by these terms. Rather, these terms are only used to distinguish one element, component, region, layer, and/or section, from another element, component, region, layer, and/or section. Thus, a first element, component, region, layer, or section discussed herein could be termed a second element, component, region, layer, or section without departing from the teachings of the present disclosure. The sequence of operations (or steps) is not limited to the order presented in the claims or examples unless specifically indicated otherwise.

Compounds are described using standard nomenclature. Unless defined otherwise, all technical and scientific terms used herein have the same meaning as is commonly understood by one of skill in the art to which this invention belongs.

As used herein, the term “resin” and “monomer” may be used interchangeably. In some embodiments, a “resin” may be composed of monomer(s), oligomger(s), photoinitiator(s), dye(s), absorber(s), loaded microparticles or nanoparticles, or any other component desired for polymerization or the resulting three-dimensional workpiece or combinations thereof. The resin can include metal, polymer, ceramic, and/or a mixture thereof, such as organic molecules, monomer, or polymer with dispersed metal or ceramic nanoparticles. The resin may be any suitable composition to form the desired solid polymer.

As used herein, the term “polymerization” or “curing” may refer to the process of converting a liquid resin into a “solid polymer.” The method may not be limited to creating “polymers” (e.g., “plastics”). The disclosed devices and methods may be used to create any three-dimensional workpiece out of any suitable materials, for example, polymers, metals, ceramics, etc., and combinations thereof. The materials may be modified to prepare the desired object from the desired material. Thus, while the reaction process (e.g., the process of converting a liquid component to a solid component) is generally referred to as polymerization and with reference to a resin, the disclosed devices and methods may be used to create any three-dimensional workpiece out of any suitable materials, for example, polymers, metals, ceramics, etc., and combinations thereof, and may use liquid forms of these materials and then convert such forms to solid to form the three-dimensional workpiece.

Reference may be made throughout the present disclosure to “ultraviolet and/or visible light” as the light that initiates polymerization. Light may also allow for spatially controlling where polymerization occurs. However, light of any wavelength suitable for polymerization (e.g., narrow or broad spectrum) may be used. That is, the disclosure may be applied to the light of any wavelength that is absorbed by a reactive component of the resin.

Further, the disclosed devices and methods are not limited to only light-initiated polymerization. Other catalysts may initiate polymerization, such as heat, oxidants, reductants, etc. For instance, heat may be used to initiate polymerization, though heat may be more difficult to spatially control compared to light leading to lower resolution control than light-induced polymerization.

In an aspect, a method is disclosed for forming a three-dimensional workpiece, comprising:
(i) dispensing a resin in a liquid state into a container configured to house a support fluid to form a fluid interface having (a) a resin layer above and in immediate contact with (b) the support fluid, wherein the resin is substantially immiscible with the support fluid;
(ii) irradiating at least a portion of the resin layer at the fluid interface with light to polymerize an irradiated portion of the resin layer as a current build layer of the three-dimensional workpiece at the fluid interface, wherein a portion (e.g., first layer portion) of the three-dimensional workpiece is affixed to a build platform immersed in the support fluid; and
(iii) advancing the build platform to the next position in the support fluid to submerge the current build layer within the support fluid, wherein the process (i), (ii), and (iii) is repeated to successively build the workpiece in the support fluid in a layer-by-layer basis.

In another aspect, a liquid additive manufacturing system (e.g., stereolithography system) is disclosed for building a three-dimensional workpiece; the liquid additive manufacturing system comprising:
a container configured to house a support fluid;
a dispensing module configured to dispense a resin into or over the support fluid of the container to form a fluid interface having a resin layer above and in immediate contact with the support fluid, wherein the resin is substantially immiscible with the support fluid;
a light projection system configured to irradiate and polymerize a portion of the resin layer at the fluid interface with light to form a top polymer layer;
a mechanized-arm system (or mechanical system) having a build platform immersed in the support fluid of the container; and
a controller having (i) a processor and (ii) a memory operatively coupled to the processor and having instructions stored thereon, wherein execution of the instructions causes the processor to direct a successive layer-by-layer build or continuous basis as desired of the workpiece in the support fluid by:
directing the dispensing module to dispense a current resin portion to form a current fluid interface of the workpiece over the support fluid, wherein the workpiece has a layer (e.g., a first layer) coupled to the build platform of the mechanized-arm system;
directing the light projection system to irradiate a portion of the current resin portion at the current fluid interface with light to polymerize the irradiated portion as a current build layer of the workpiece; and
advancing the build platform of the mechanized-arm system into the next position in the support fluid to submerge the current build layer within the support fluid.

Any suitable resin can be used in the disclosed methods or systems. The resin can include a monomer, oligomer, or any other component desired for polymerization as described herein, particularly photopolymerizable and/or free radical polymerizable monomers, and a suitable initiator such as a free radical initiator, and combinations thereof. Examples include, but are not limited to, acrylics, methacrylics, acrylamides, styrenics, olefins, halogenated olefins, cyclic alkenes, maleic anhydrides, alkenes, alkynes, carbon monoxide, functionalized oligomers, multifunctional cure site monomers, functionalized PEGs, etc., including combinations thereof. Examples of resins, monomers, and initiators which may be used include, but are not limited to, those set forth in U.S. Pat. Nos. 8,232,043; 8,119,214; 7,935,476; 7,767,728, 7,649,029; and WO 2012/129968, CN 102715751, and JP 2012210408.

In some embodiments, the resin comprises an acid-catalyzed, or cationically polymerized, resin. In such embodiments, the resin comprises monomers containing groups suitable for acid catalysis, such as epoxide groups, vinyl ether groups, etc. These suitable monomers include olefins such as methoxyethene, 4-methoxystyrene, styrene, 2-methylprop-1-ene, 1,3-butadiene, etc.; heterocyclic monomers (including lactone, lactams, and cyclic amines) such as oxirane, thietane, tetrahydrofuran, oxazoline, 1,3-dioxepane, oxetan-2-one, etc., and combinations thereof. A suitable (generally ionic or non-ionic) photoacid generator (PAG) is included in the resin, examples of which include, but are not limited to, onium salts, sulfonium and iodonium salts, etc., such as diphenyl iodide hexafluorophosphate, diphenyl iodide hexafluoroarsenate, diphenyl iodide hexafluoroantimonate, triphenylsulfonium hexafluoroarsenate, triphenylsulfonium hexafluoroantimonate, triphenylsulfonium triflate, dibutylnaphthylsulfonium triflate, etc., including those described in, for example, U.S. Pat. Nos. 7,824,839; 7,550,246; 7,534,844; 6,692,891; 5,374,500; and 5,017,461; and “Photoacid Generator Selection Guide for the Electronics Industry and Energy Curable Coatings” (BASF 2010).

In some embodiments, the resin includes photocurable hydrogels like poly(ethylene glycols) (PEG) and gelatins. PEG hydrogels have been used to deliver a variety of biological agents, including growth factors. Conditions to maximize the release of biological agents from photopolymerized PEG diacrylate hydrogels can be enhanced by the inclusion of affinity binding peptide sequences in the monomer resin solutions prior to photopolymerization, allowing sustained delivery. Gelatin is a biopolymer frequently used in food, cosmetic, pharmaceutical and photographic industries. It is obtained by thermal denaturation or chemical and physical degradation of collagen. There are three kinds of gelatin, including those found in animals, fish and humans. Gelatin from the skin of cold water fish is considered safe to use in pharmaceutical applications. UV or visible light can be used to crosslink appropriately modified gelatin. Methods for crosslinking gelatin include cure derivatives from dyes such as Rose Bengal.

In some embodiments, the resin includes photocurable silicones. UV curable silicone rubber, such as Siliopren UV Cure silicone rubber, can be used, as can LOCTITE Cure silicone adhesive sealants.

In some embodiments, the resin includes a biodegradable resin. Biodegradable copolymers of lactic acid and glycolic acid (PLGA) can be dissolved in PEG dimethacrylate to yield a transparent resin suitable for use. Polycaprolactone and PLGA oligomers can be functionalized with acrylic and methacrylic groups to allow them to be effective resins for use.

In some embodiments, the resin includes a photocurable polyurethane. A photopolymerizable polyurethane composition comprising (1) a polyurethane based on an aliphatic diisocyanate, poly(hexamethylene isophthalate glycol), and optionally 1,4-butanediol; (2) a polyfunctional acrylic ester; (3) a photoinitiator; and (4) an anti-oxidant, can be formulated so that it provides a hard, abrasion-resistant, and stain-resistant material (U.S. Pat. No. 4,337,130). Photocurable thermoplastic polyurethane elastomers incorporate photoreactive diacetylene diols as chain extenders.

In some embodiments, a high-performance resin can be used. Such high performance resins may sometimes require the use of heating to melt and/or reduce the viscosity thereof. Examples of such resins include, but are not limited to, resins for those materials referred to as liquid crystalline polymers of esters, ester-imide, and ester-amide oligomers, as described in U.S. Pat. Nos. 7,507,784 and 6,939,940. Since such resins are sometimes employed as high-temperature thermoset resins, in the present disclosure, they further comprise a suitable photoinitiator such as benzophenone, anthraquinone, and fluoroenone initiators (including derivatives thereof), to initiate cross-linking on irradiation.

Further useful resins include EnvisionTEC's Clear Guide, E-Denstone Material, e-Shell 300 series of resins, HTM140IV High-Temperature Mold Material, RC31 resin, or Easy Cast EC500.

In some embodiments, the resin may comprise a sol solution, or acid-catalyzed sol. Such solutions generally comprise a metal alkoxide including silicon and titanium alkoxide such as silicon tetraethoxide (tetraethyl orthosilicate; TEOS) in a suitable solvent. Additional ingredients such as dyes and dopants may be included in the sol solution, and post-polymerization firing steps may be included as is known in the art, see, e.g., U.S. Pat. Nos. 4,765,818; 7,709,597; 7,108,947; 8,242,299; 8,147,918; and 9,368,514.

The resin can have solid particles suspended or dispersed therein. Any suitable solid particle can be used, depending upon the end product being fabricated. The particles can be metallic, organic/polymeric, inorganic, or composites or mixtures thereof. The particles can be nonconductive, semi-conductive, or conductive (including metallic and non-metallic or polymer conductors); and the particles can be magnetic, ferromagnetic, paramagnetic, or nonmagnetic. The particles can be of any suitable shape, including spherical, elliptical, cylindrical, etc. The particles can comprise an active agent or detectable compound as described below, though these may also be provided dissolved or solubilized in the resin. For example, magnetic or paramagnetic particles or nanoparticles can be employed.

In some embodiments, the resin may carry live cells as particles therein. Such resins are generally aqueous, and may be oxygenated, and may be considered as emulsions where the live cells are the discrete phase. Suitable live cells may be plant cells (e.g., monocot, dicot), animal cells (e.g., mammalian, avian, amphibian, reptile cells), microbial cells (e.g., prokaryote, eukaryote, protozoal, etc.), etc. The cells may be of differentiated cells from or corresponding to any type of tissue (e.g., blood, cartilage, bone, muscle, endocrine gland, exocrine gland, epithelial, endothelial, etc.), or may be undifferentiated cells such as stem cells or progenitor cells. In such embodiments, the resin can be one that forms a hydrogel, including but not limited to those described in U.S. Pat. Nos. 7,651,683; 7,651,682; 7,556,490; 6,602,975; and 6,836,313.

The resin can have additional ingredients solubilized therein, including pigments, dyes, active compounds or pharmaceutical components, detectable compounds (e.g., fluorescent, phosphorescent, or radioactive compounds), etc., again depending upon the particular purpose of the workpiece being fabricated. Examples of such additional ingredients include, but are not limited to, proteins, peptides, nucleic acids (DNA, RNA) such as siRNA, sugars, small organic compounds (drugs and drug-like compounds), etc., including combinations thereof.

Any suitable radiation source (or combination of sources) can be used in the light projection system, depending on the particular resin employed, including electron beam and ionizing radiation sources. In some embodiments, the radiation source is an actinic radiation source, such as one or more light sources, and in particular one or more ultraviolet light sources. Any suitable light source can be used, such as incandescent lights, fluorescent lights, phosphorescent or luminescent lights, a laser, light-emitting diode, etc., including arrays thereof. The light source preferably includes a pattern-forming element operatively associated with the controller, as noted above. In some embodiments, the light source or pattern forming element comprises a digital (or deformable) micromirror device (DIMD) with digital light processing (DLP)), a spatial modulator (SLM), or a microelectromechanical system (MEMS) mirror array, a mask (aka a reticle), a silhouette, or a combination thereof. In some embodiments, the light source comprises a spatial light modulation array such as a liquid crystal light valve array or micromirror array or DMD (e.g., with an operatively associated digital light processor, typically in turn under the control of the controller), configured to carry out exposure or irradiation of the resin layer without a mask, e.g., maskless photolithography.

In some embodiments, the irradiating step can be carried out with patterned irradiation. The patterned irradiation may be a fixed pattern or may be a variable pattern created by a pattern generator (e.g., a DLP), depending on the particular item being fabricated. When the patterned irradiation is a variable pattern rather than a pattern that is held constant over time, then each irradiating step may be of any suitable time or duration depending on factors such as the intensity of the irradiation, the presence or absence of dyes in the resin, or the rate of growth. The intensity of irradiation may be monitored with a photodetector to detect a decrease in intensity. If detected, a process parameter may be adjusted through the controller to accommodate the loss of intensity.

In some embodiments, the resin is irradiated through a build-window located above or in contact with the support fluid. The build window may comprise a material having reduced stiction with the current build layer thus formed. In some embodiments, the build window may comprise a fluoropolymer (e.g., tetrafluoroethylene). In some embodiments, the build window may comprise an oxygen-permeable material. In other embodiments, no build window is used. Alternatively, the build window may comprise a fluid having a density and/or viscosity less than the resin.

In some embodiments, the support build fluid has a density and/or viscosity greater than the resin. In some embodiments, aqueous liquids are preferred as the support fluid. However, as water has a density of 1.0 g/cm³, it does not have a density high enough to be denser than many potential resins which may be used herein. A denser form of water known in the art as heavy water (deuterium oxide) only has a density of about 1.11 g/cm³ and may not be sufficient for many desirable resins. To increase the density of water, one or more salts can be added to the aqueous liquid to form salt solutions thereof. Exemplary solutions include water with 25 wt % NaCl (1.193 g/cm³) or Dead Sea water (1.240 g/cm³). Suitable salts include NaCl, NaBr, KBr, MgBr₂, MgCl₂, sodium acetate, sodium nitrate, CaBr₂, CaCl₂), Na₂CO₃, NH₄Br, and LiBr.

Soluble organic compounds can also be added to increase the density, increase the viscosity, or modify the wetting characteristics of the support fluid. Examples of soluble organic compounds which can be used include, but are not limited to, glycerol, glucose, fructose, sucrose, maltose, ethylene glycol, triethylene glycol, diethylene glycol, and glutaric acid.

In some embodiments, water-soluble polymers can be added to the support fluid to increase the viscosity. Examples of suitable polymers include, but are not limited to, poly(ethylene oxide), poly(vinyl pyrrolidone), poly(acrylic acid), poly(methacrylic acid), poly(ethyl oxazoline), poly(ethylene imine), poly(vinyl amine), carboxy methyl cellulose, and the like.

In some embodiments, support fluid may further comprise a surfactant. Numerous surfactants can be considered, including nonionic, anionic, and cationic surfactants. Examples include, but are not limited to, sodium stearate, sodium lauryl sulfate, sodium dodecyl benzene sulfonate, dioctadecyldimethylammonium chloride, octaethylene glycol monododecyl ethyl, poly(propylene glyol)-poly(ethylene glycol) block copolymers, polyoxyethylene glycol octylphenol ethers, polyethoxylated tallow amines. Classes of these compounds include linear alkylbenzene sulfonates, fatty alcohol ethoxylates, alkylphenol ethoxylates, and lignin sulfonates. Silicone surfactants and fluorocarbon surfactants are also known and can be used.

In some embodiments, nonaqueous liquids may be used for the support fluid for certain methods and systems. Examples include higher density hydrocarbon liquids such as ethylene glycol, diethylene glycol, triethylene glycol, glycerol, formamide, fluorocarbons and perfluorocarbon liquids such as Kytox or Fomblin perfluorinated polyether oil. Low toxicity chlorinated aliphatic hydrocarbon liquids could also be considered. Nonaqueous liquid salts (also referred to as ionic liquids) can also be employed, examples of which include, but are not limited to, 1-butyl-3,5-dimethylpyridinium bromide and 1-butyl-3-methylimidazolium hexafluorophosphate.

The methods described herein may further comprise removing a portion of the support fluid to maintain the fluid interface or a height level of the support fluid at a pre-defined position. Alternatively, the light projection system may be dynamically adjusted such that it is maintained at a pre-defined position relative to the resin layer, or even further the container may be physically lowered relative to the light projection system. In some embodiments, the controller is configured to direct removal of a portion of the support fluid from the container to maintain the fluid interface or height level of the support fluid at a pre-defined position or to dynamically adjust the light projection system such that it is maintained at a pre-defined position relative to the resin layer, or to physically lower the container relative to the light projection system.

Each resin layer above and in immediate contact with the support fluid may have a pre-defined thickness, for example, which allows the light to penetrate and polymerize the resin layer at the fluid interface. The pre-defined thickness may be adjusted by a controller parameter, such as via a measurement, when dispensing the resin into the container. In some embodiments, the pre-defined thickness is defined by the location of the previously built layer of the workpiece. In some embodiments, the methods described herein further comprise varying a property of the resin or selecting from different resins to vary the successive layers of the workpiece, such as to vary the color or mechanical property of the successive layers. In some embodiments, the methods described herein further comprise varying the density of the resin or selecting from different resins between at least one successive layer to the next successive layer to form a gradient of density or other property within the workpiece. The current build layer may be monitored, such as via an interferometry system, to measure its thickness, degree of cure, or other property (such as having a pre-defined irradiated thickness).

The liquid additive manufacturing system may further comprise a heat exchanger, such as a heater and/or cooler, disposed in the container, the controller being configured by instructions to adjust, via the heat exchanger, the temperature of the support fluid. In some embodiments, the methods described herein further comprise adjusting, via a heat exchanger, the temperature of the support fluid, wherein the support fluid cools the three-dimensional workpiece during fabrication. The liquid additive manufacturing system may also comprise a temperature sensor or thermocouple positioned within or near the container, the controller being configured by instructions to adjust, via the heat exchanger, the temperature of the support fluid based on measurements of the temperature sensor or thermocouple.

The mechanized-arm system may have from 1 to 6 degrees of freedom, e.g., from 1 to 3 translation and from 0 to 3 rotational degrees of freedom.

Also provided are three-dimensional workpieces formed by the methods and/or systems described herein. The three-dimensional workpieces may be final, finished, or substantially finished products, or may be intermediate products subject to further manufacturing steps such as surface treatment, laser cutting, electric discharge machining, etc., as needed. Intermediate products include products for which further additive manufacturing, in the same or a different system, may be carried out. Numerous different products can be made by the methods and systems described herein, including both large-scale models and prototypes, small custom products, miniature, and microminiature products or devices, etc.

The processes described herein can produce workpieces with a variety of different properties. In some embodiments, the workpieces are rigid, flexible, or resilient. In some embodiments, the workpieces are a solid or a gel, such as a hydrogel. In some embodiments, the products have a shape memory. In some embodiments, the products are unitary or composites. Particular properties may be determined by factors such as the choice of resin used.

The following further embodiments of the present disclosure are also provided: Embodiment 1. A method for forming a three-dimensional workpiece, comprising:
(i) dispensing a resin in a liquid state into a container configured to house a support fluid to form a fluid interface having (a) a resin layer above and in immediate contact with (b) the support fluid, wherein the resin is substantially immiscible with the support fluid;
(ii) irradiating at least a portion of the resin layer at the fluid interface with light to polymerize an irradiated portion of the resin layer as a current build layer of the three-dimensional workpiece at the fluid interface, wherein a portion (e.g., first layer portion) of the three-dimensional workpiece is affixed to a build platform immersed in the support fluid; and
(iii) advancing the build platform to the next position in the support fluid to submerge the current build layer within the support fluid, wherein the process (i), (ii), and (iii) is repeated to successively build the workpiece in the support fluid (e.g., in a layer-by-layer basis or a continuous process, as desired).

Embodiment 2. The method of embodiment 1, wherein the support fluid has a density and/or viscosity greater than the resin.

Embodiment 3. The method of embodiment 1 or embodiment 2, wherein the support fluid comprises water, an aqueous solution, or a non-aqueous liquid (e.g., a hydrocarbon or ionic liquid).

Embodiment 4. The method of embodiment 1 or embodiment 2, wherein the support fluid consists of water or an aqueous solution.

Embodiment 5. The method of any one of embodiments 1-4, wherein the resin is irradiated through a build window located above or in contact with the support fluid.

Embodiment 6. The method of embodiment 5, wherein the build window comprises a build window material having reduced stiction with the current build layer thus formed.

Embodiment 7. The method of embodiment 5 or 6, wherein the build window material material comprises an oxygen-permeable material.

Embodiment 8. The method of any one of embodiments 5-7, wherein the build window material comprises a fluoropolymer (e.g., polytetrafluoroethylene).

Embodiment 9. The method of any one of embodiments 1-8, further comprising:
removing a portion of the support fluid from the container to maintain the fluid interface or a height level of the support fluid at a pre-defined position.

Embodiment 10. The method of any one of embodiments 1-9, wherein each resin layer above and in immediate contact with the support fluid has a pre-defined thickness (e.g., that allows the ultraviolet and/or visible light to penetrate and polymerize the resin layer to the fluid interface).

Embodiment 11. The method of embodiment 10, further comprising:
adjusting a controller parameter when dispensing the resin into the container to maintain the pre-defined thickness (e.g., via a measurement).

Embodiment 12. The method of any one of embodiments 1-11, further comprising:
varying a property of the resin or selecting from different resins to vary the successive layers of the workpiece (e.g., to vary the color or mechanical property).

Embodiment 13. The method of any one of embodiments 1-11, further comprising:
varying the density of the resin or selecting from different resins between at least one successive layer to the next successive layer to form a gradient density in the workpiece.

Embodiment 14. The method of any one of embodiments 1-13, further comprising:
adjusting, via a heat exchanger, the temperature of the support fluid, wherein the support fluid cools the three-dimensional workpiece during fabrication.

Embodiment 15. The method of any one of embodiments 1-14, further comprising:
monitoring, via an interferometry system, the current build layer to measure its thickness, degree of cure, or other property (e.g., having a pre-defined irradiated thickness).

Embodiment 16. A liquid additive manufacturing system (e.g., stereolithography system) for building a three-dimensional workpiece, the liquid additive manufacturing system comprising:
a container configured to house a support fluid;
a dispensing module configured to dispense a resin into or over the support fluid of the container to form a fluid interface having a resin layer above and in immediate contact with the support fluid, wherein the resin is substantially immiscible with the support fluid; a light projection system configured to irradiate and polymerize a portion of the resin layer at the fluid interface with light to form a top polymer layer;
a mechanized-arm system (or mechanical system) having a build platform immersed in the support fluid of the container; and a controller having (i) a processor and (ii) a memory operatively coupled to the processor and having instructions stored thereon, wherein execution of the instructions causes the processor to direct a successive build (e.g., layer-by-layer or continuous build) of the workpiece in the support fluid by:
directing the dispensing module to dispense a current resin portion to form a current fluid interface of the workpiece over the support fluid, wherein the workpiece has a layer (e.g., a first layer) coupled to the build platform of the mechanized-arm system; directing the light projection system to irradiate a portion of the current resin portion at the current fluid interface with light to polymerize the irradiated portion as a current build layer of the workpiece; and
advancing the build platform of the mechanized-arm system into the next position in the support fluid to submerge the current build layer within the support fluid.

Embodiment 17. The liquid additive manufacturing system of embodiment 16, wherein the support fluid has a density and/or viscosity greater than the resin.

Embodiment 18. The liquid additive manufacturing system of embodiment 16 or 17, wherein the support fluid comprises water, an aqueous solution, or a non-aqueous liquid (e.g., a hydrocarbon or ionic liquid).

Embodiment 19. The liquid additive manufacturing system of embodiment 16 or 17, wherein the support fluid consists of water or an aqueous solution.

Embodiment 20. The liquid additive manufacturing system of any one of embodiments 16-19, further comprising:
a build window located above or in contact with the support fluid, wherein the resin is irradiated through the build window.

Embodiment 21. The liquid additive manufacturing system of embodiment 20, wherein the build window comprises a material having reduced stiction with the current build layer thus formed.

Embodiment 22. The liquid additive manufacturing system of embodiment 20, wherein the build window comprises an oxygen-permeable material.

Embodiment 23. The liquid additive manufacturing system of embodiment 20, wherein the build window comprises a nonstick material (e.g., polytetrafluoroethylene).

Embodiment 24. The liquid additive manufacturing system of any one of embodiments 16-23, wherein the controller is configured to direct removal of a portion of the support fluid from the container to maintain the fluid interface or a height level of the support fluid at a pre-defined position.

Embodiment 25. The liquid additive manufacturing system of any one of embodiments 16-24, wherein each resin layer above and in immediate contact with the support fluid has a pre-defined thickness.

Embodiment 26. The liquid additive manufacturing system of any one of embodiments 16-25, further comprising:
a heat exchanger (e.g., heater and/or cooler) disposed in the container, the controller being configured by instructions to adjust, via the heat exchanger, the temperature of the support fluid.

Embodiment 27. The liquid additive manufacturing system of any one of embodiments 16-26 further comprising:
a temperature sensor or thermocouple positioned within or near the container, the controller being configured by instructions to adjust, via the heat exchanger, the temperature of the support fluid based on measurements of the temperature sensor or thermocouple.

Embodiment 28. The liquid additive manufacturing system of any one of embodiments 16-27, wherein the controller is configured to adjust a controller parameter when dispensing the resin into the container to maintain the pre-defined resin thickness (e.g., via a measurement, e.g., height or liquid position).

Embodiment 29. The liquid additive manufacturing system of any one of embodiments 16-28, wherein the controller is configured to vary a property of the resin or select from different resins to vary the properties of successive layers of the workpiece (e.g., to vary the color or mechanical property).

Embodiment 30. The liquid additive manufacturing system of any one of embodiments 16-29, wherein the controller is configured to vary the density of the resin or select from different resin between at least one successive layer to the next successive layer to form a gradient density in the workpiece.

Embodiment 31. The liquid additive manufacturing system of any one of embodiments 16-30 further comprising: an interferometry system, wherein the interferometry system is used to monitor the current build layer to measure its thickness, degree of cure, or other property (e.g., having a pre-defined irradiated thickness).

Embodiment 32. A three-dimensional workpiece formed by the method of any one of embodiments 1-15 or the system of any one of embodiments 16-31.

A number of embodiments of the disclosure have been described. Nevertheless, it will be understood that various modifications may be made without departing from the spirit and scope of the invention. Accordingly, other embodiments are within the scope of the following claims.

By way of non-limiting illustration, examples of certain embodiments of the present disclosure are given below.

### Example System and Method

The following examples are put forth so as to provide those of ordinary skill in the art with a complete disclosure and description of how the articles, devices, and/or methods claimed herein are made and evaluated and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, the temperature is in degrees Celsius or is at ambient temperature, and pressure is at or near atmospheric pressure.

### Example Liquid Additive Manufacturing System

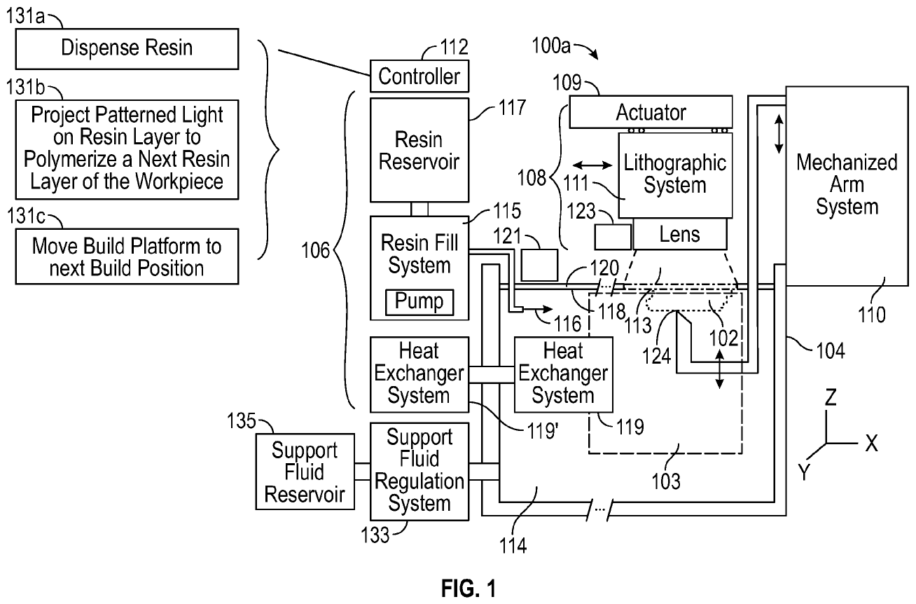

FIG. 1 shows an example liquid additive manufacturing system 100 (shown as 100a), e.g., as a stereolithography system or a continuous system, for building a workpiece 102. The system 100 is configured to fabricate the workpiece 102 (e.g., three-dimensional workpiece) by sequentially adding materials to the object being built until it reaches its final geometrical form. Each subsequent addition of material to the object is selectively placed in order to make the desired geometrical form of the final three-dimensional workpiece. As used herein, the product resulting from the application of the disclosed methods and use of the disclosed devices is generally referred to as the three-dimensional workpiece. The fabrication of parts in the liquid additive manufacturing system 100a can be considered in discrete steps similar to existing polymerization techniques in a discrete layer-by-layer build process, or it can be a continuous, layer-free build process. The uncured resin layer lies on top of the support fluid. The resin is exposed to a light source, photopolymerizing the monomer. Afterward, the cured part is lowered into the supporting solution, where the support fluid acts upon the cured part geometry. FIG. 3 shows a diagrammed view of these steps.

Stereolithography is one type of additive manufacturing; it allows for the fabrication of three-dimensional workpieces by sequentially depositing materials, e.g., through radical chain polymerization, to a solid polymer until the workpiece reaches its final geometrical form. Each subsequent addition of material may occur along the height of the workpiece (e.g., along the z-axis). Traditionally, the process may allow for “layer-by-layer” growth, where each layer has a finite thickness.

The liquid additive manufacturing system 100 may alternatively operate in a continuous manner to grow objects from a pool or layer of resin by carefully balancing the interaction of UV light (to trigger photo polymerization) and oxygen (to inhibit the reaction).

Resin-based additive manufacturing technology, such as SLA/DLP, shows significant potential for applications that require parts with high resolution, surface quality, and/or isotropic strength. SLA printing allows for micron-scale tolerances and resolutions, utilizing a UV-sensitive photoinitiator that can enable a cross-linking process, turning liquid monomers/oligomers into solid polymers when exposed to UV light. SLA 3D printing still retains the same drawbacks from support structure necessity below overhanging geometry. This increases the print time, wastes expensive material, and requires polishing, a tedious process that ultimately reduces the surface quality of the part.

In the example shown in FIG. 1, system 100 can be used to generate a workpiece 102, which can be rigid, flexible, or resilient. In some embodiments, the workpieces are a solid or a gel, such as a hydrogel. In some embodiments, the products have a shape memory. In some embodiments, the products are unitary or composites. Particular properties may be determined by factors such as the choice of resin used.

The system 100a may include a container 104, dispensing module 106, light projection system 108, mechanized-arm system 110, and controller 112.

Container 104 is configured to house a support fluid 114. The container 104 may house parts of the processing components, e.g., to regulate temperature, fluid support level, and resin dispensing. In certain embodiments (e.g., for industrial-scale production system), the container 104 may be an in-ground pool or above-ground tank or vessel to house the support fluid 114 and provide the build space 103. In other embodiment, the container 104 may be sized as a benchtop system, which may be a rigid wall or flexible-wall container (e.g., filled with air as an inflatable device). The container 104 may include ports and valves for fluid processing. In some embodiment, the valves for fluid processing may be disposed along the walls of the container 104 (and not necessarily therethrough).

Use of the support fluid can remove the need for support structures in SLA, which can significantly reduce the overall part fabrication overhead, e.g., the software planning of support structures, the material used in them, the time it takes to print them, the time it takes to remove them, and the time it takes to polish the surfaces after removal could all be reduced or removed with a system that reduces the forces incurred on the parts fabricated within the system.

Support fluid 114 has a density and/or viscosity greater than a resin 116. The support fluid 114 may be an aqueous liquid or a non-aqueous liquid, which may be further modified with additives. For aqueous liquids, the liquid may include one or more salts. Exemplary solutions include water with 25 wt % NaCl (1.193 g/cm³) or Dead Sea water (1.240 g/cm³). Suitable salts include NaCl, NaBr, KBr, MgBr₂, MgCl₂, sodium acetate, sodium nitrate, CaBr₂, CaCl₂), Na₂CO₃, NH₄Br, and LiBr. Non-aqueous liquids may include hydrocarbon liquids such as ethylene glycol, diethylene glycol, triethylene glycol, glycerol, formamide, fluorocarbons, and perfluorocarbon liquids such as Kytox or Fomblin perfluorinated polyether oil.

Additives may include soluble organic compounds such glycerol, glucose, fructose, sucrose, maltose, ethylene glycol, triethylene glycol, diethylene glycol, and glutaric acid. Additives may also include water-soluble polymers such as poly(ethylene oxide), poly(vinyl pyrrolidone), poly(acrylic acid), poly(methacrylic acid), poly(ethyl oxazoline), poly(ethylene imine), poly(vinyl amine), carboxy methyl cellulose, and the like. Additives may also include a surfactant.

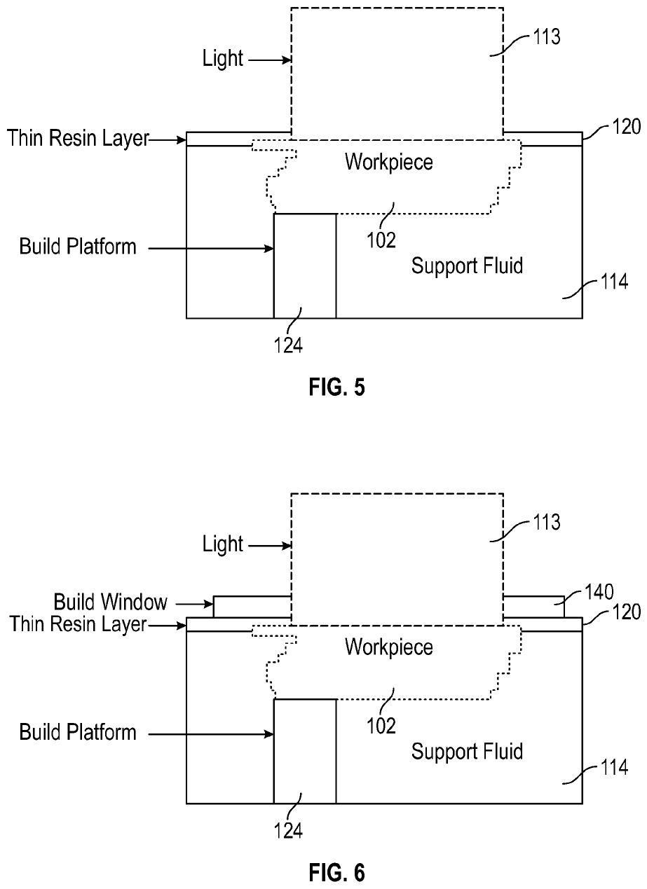

FIG. 5 shows an example build interface between the support fluid 114 and resin layer 120.

Dispensing system. The dispensing module 106 is configured to dispense the resin 116 into or over the support fluid 114 of the container 104 to form a fluid interface 118 having a resin layer 120 above and in immediate contact with the support fluid 114. The resin (e.g., 116, 120) is substantially immiscible with the support fluid 114.

The resin can include a monomer, particularly photopolymerizable and/or free radical polymerizable monomers, and a suitable initiator such as a free radical initiator, and combinations thereof. Examples include, but are not limited to, acrylics, methacrylics, acrylamides, styrenics, olefins, halogenated olefins, cyclic alkenes, maleic anhydrides, alkenes, alkynes, carbon monoxide, functionalized oligomers, multifunctional cure site monomers, functionalized PEGs, etc., including combinations thereof.

In some embodiments, the resin comprises an acid-catalyzed, or cationically polymerized, resin, photocurable hydrogels like poly(ethylene glycols) (PEG) and gelatins, photocurable silicones, a biodegradable resin, photocurable polyurethane, or other resins described herein.

In the example shown in FIG. 1, the dispensing module 106 includes a fill system 115 comprising a set of one or more pumps and valves to draw uncured resin from a reservoir 117. The fill system 115 may draw uncured resin to pre-defined thickness of the resin layer 120.

In some embodiments, the dispensing module 106 includes a heat exchanger 119, located within or along the surface of the container 104, configured to regulate the temperature of the support fluid 114, which is configured to draw heat from the workpiece 102 during the build process. The heat exchanger 119 may be coupled to a second heat exchanger 119′ located outside the container 104 to remove the heat from heat exchanger 119. In some embodiments, the heat exchanger 119 is configured to operatively couple to a cooling or a heating source via a circulator or heat pump.

The dispensing module 106 may include build-fluid regulation system 133 configured to remove a portion of the support fluid to maintain the fluid interface or a height level of the support fluid at a pre-defined position. The fluid level adjustment may be performed to maintain the build conditions (e.g., supporting build-fluid levels) that may vary due to a change in volume of the workpiece 102 during a build process as the resin is continuously added to the container 104.

The supporting build-fluid regulation system 133 includes pumps and valves to fill the container 104 with the support fluid 114 and to remove the support fluid 114 from the container 104. The supporting build-fluid regulation system 133 may be connected to a build-fluid reservoir 135 that stores the support fluid 114.

The dispensing module 106 may include a level sensor or sensor assembly 121 to measure the level of the support fluid 114. The level sensor/sensor assembly 121 or a second set of level sensors may measure the level of the resin layer 120 disposed above and in immediate contact with the support fluid 114. In some embodiments, an interferometer system or ultrasound system may be employed to measure the multi-layer liquid.

Light projection system. The light projection system 108 is configured to irradiate and polymerize a portion of the resin layer at the fluid interface 118 with light to form a top polymer layer. The light projection system 108 may include a UV, electron beam, ionizing radiation sources, or other light source described herein that can then be projected onto a resin to photopolymerize it. The light source may be an incandescent light source, fluorescent light source, phosphorescent or luminescent light source, a laser source, a light-emitting diode source, or any other light source described herein or an array or combination thereof. The light projection system 108 may mask the projected light beam to generate a desired pattern or geometry. Examples may include a digital (or deformable) micromirror device (DMD) with digital light processing (DLP)), a spatial modulator (SLM), a microelectromechanical system (MEMS) mirror array, or any other pattern generating device described herein. The light projection system may include optical subcomponents to condition the light.

The lithographic system 111 houses the UV or other light source. The lithographic system 111 includes a mask subassembly and optical and lens subassemblies to project a defined pattern of light 113 over the resin layer 120.

In the example shown in FIG. 1, the light projection system 108 includes an actuator 109 that is operatively coupled to a lithographic system 111. The actuator 109 may translate the lithographic system 111, e.g., along the XY plane, through computer control inputs to expose different regions of resin to the projected light, e.g., for the fabrication of more complex or larger geometries. The translation of the stage may be performed during the projection system exposure to allow shapes to be drawn atop the surface of the build area. For example, if a 3-dimensional parallelogram is desired, a rectangular mask can be loaded, and the stage can be translated along one axis at a set distance between the cured layers.

In some embodiments, the light projection system 108 may include multiple lithographic systems 111 arranged in an array to allow for higher-scale production.

In some embodiments, the light projection system 108 is configured to adjust its z-position to maintain a pre-defined position relative to the resin layer.

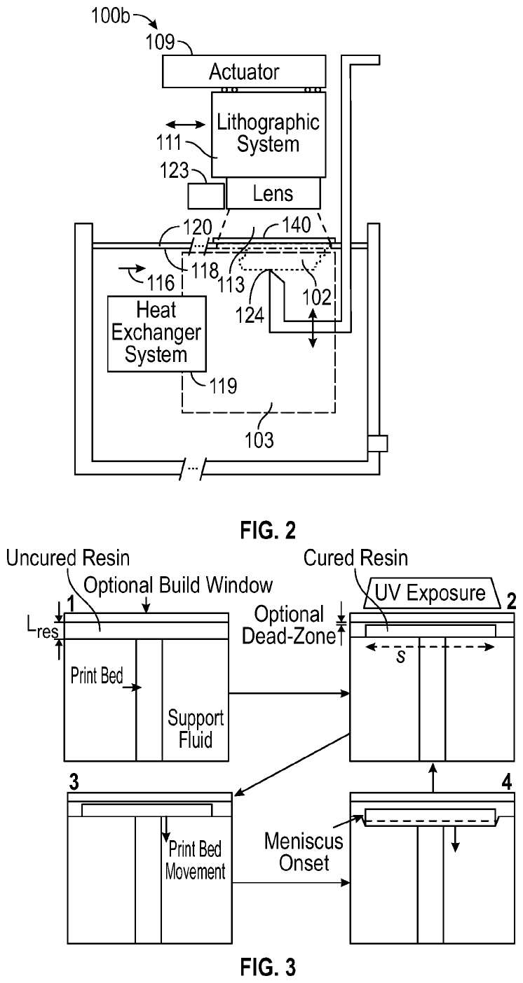

The light projection may or may not pass through a build window (not shown—see FIG. 2) before exposing the uncured resin layer and initiating crosslinking. Photopolymerization of this resin layer onto the print bed creates the cured part geometry.

The light projection system 108 may include an interferometry system 123 (e.g., white light interferometry system) configured to assess the thickness of a cured resin. The interferometry system may determine the boundaries between a cured and uncured resin to determine the thickness of the current layer after or during its exposure by the lithographic system 111, e.g., for process control. The measurements may be employed, e.g., in close-loop, to the light projection system 108 to adjust the light intensity, filter configurations, or exposure time. In some embodiments, the interferometry system is employed to determine cured thickness, e.g., for quality control. The measurements may be employed to reject a workpiece (i.e., to halt further fabrication for that workpiece) or to initiate a rectification process to fix or undo the last layer of processing.

Multiple light projection systems 108 may be employed for a single container 104 having a shared support fluid 114 to provide multiple build space 103 for that container 104.

Mechanized-arm system. The mechanized-armsystem 110 has a build platform 124 immersed in the support fluid 114 of the container 104. The mechanized-arm system 110 may include linear actuators on guided rail assembly, hydraulic, pneumatic manipulator arms, vertical lifters, or any other mechanized component, to translate the build platform 124 and the cured geometry attached to the print bed, at least along the Z-axis, to facilitate the polymerization of subsequent layers in a top-down fabrication process. In the example shown in FIG. 1, the mechanized-arm system 110 is disposed to the side of the build space 103. In other embodiments, the mechanized-arm system 110 may include vertical platform lifts, motorized actuators, or the like that can be disposed below or above the build space 103.

In some embodiments, the mechanized-armsystem 110 may have from 1 to 6 degrees of freedom to allow the build platform 124 (and the attached workpiece 102) to move, e.g., within X, Y, Z axis, and/or with 0 to 3 rotational degrees of freedom.

Multiple mechanized-armsystem 110 may also be employed for a single container 104, having the shared support fluid 114 to provide multiple build space 103 for that container 104.

Controller and Method of Operation. The controller 112 has (i) a processor and (ii) memory operatively coupled to the processor and having instructions stored thereon, wherein execution of the instructions causes the processor to direct a successive layer-by-layer build or a continuous process, as desired, of the workpiece in the support fluid.

The controller 112, via the instructions, may direct the dispensing module 104 to dispense (131a) a current resin portion to form a current fluid interface of the workpiece over the support fluid 114. The workpiece 102 has a layer (e.g., a first layer) coupled to the build platform 124 of the mechanized-arm 110.

The controller 112 may then direct (131b) the light projection 108 system to irradiate a portion of the current resin portion at the current fluid interface with light to polymerize the irradiated portion as a current build layer of the workpiece.

The controller 112 may then advance (131c) the build platform 124 of the mechanized-arm 110 into the next position in the support fluid 114 to submerge the current build layer within the support fluid 114.

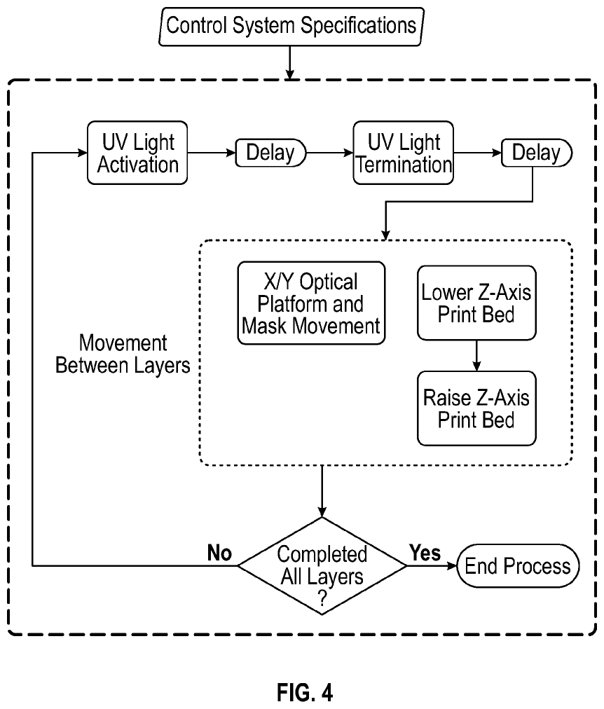

FIG. 4 shows a diagram of an example control operation for steps 131b and 131c.

The UV light may be activated and irradiated onto the build area for a specified amount of time. Depending on whether the user wants to wait for a dark reaction after irradiation, they can have an additional delay before moving the build platform. Dark reaction is the residual polymerization in a cure after the UV exposure has ceased, which can alter the resulting cure depth, density, and deflection.

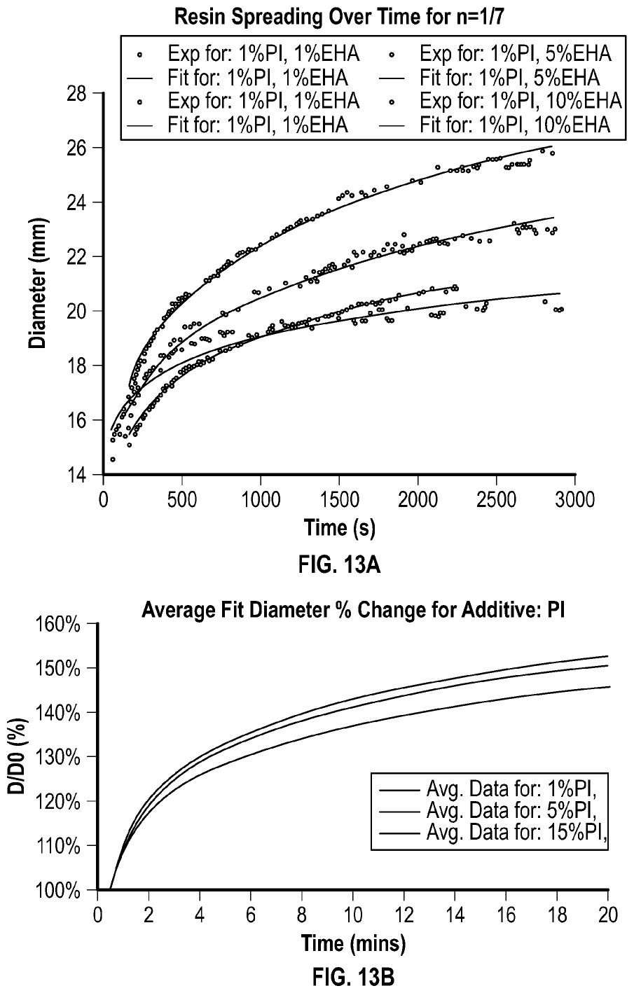

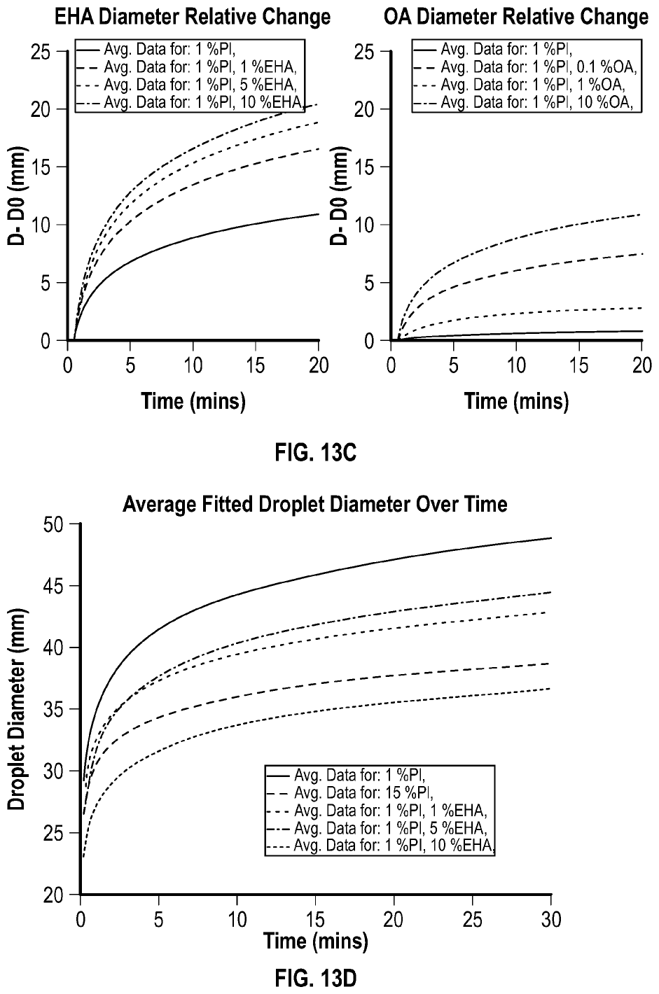

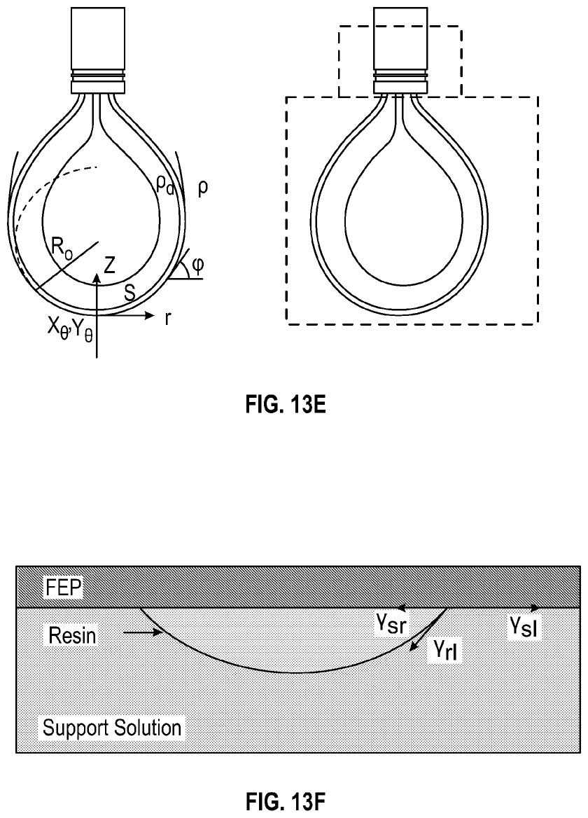

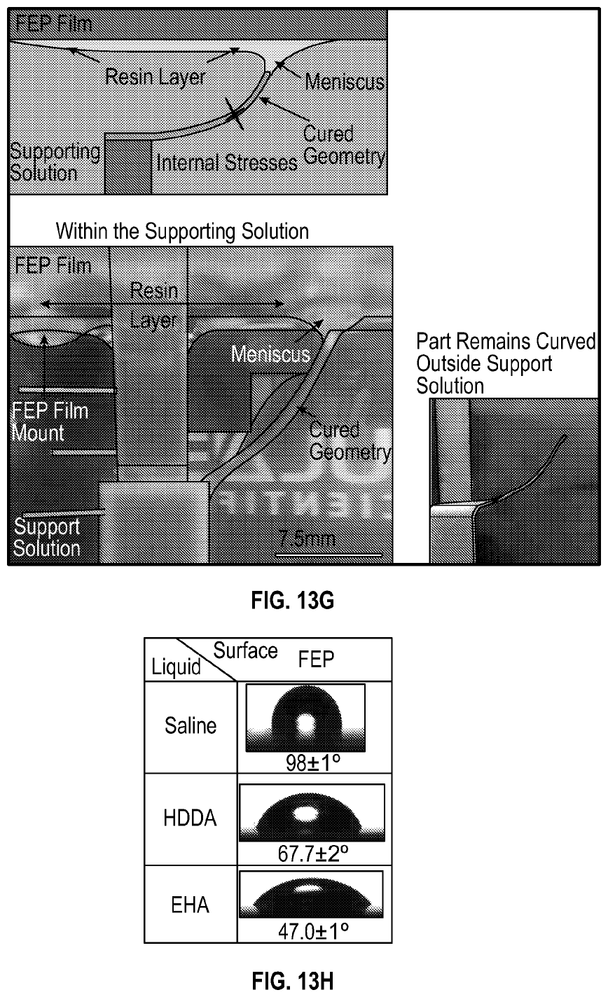

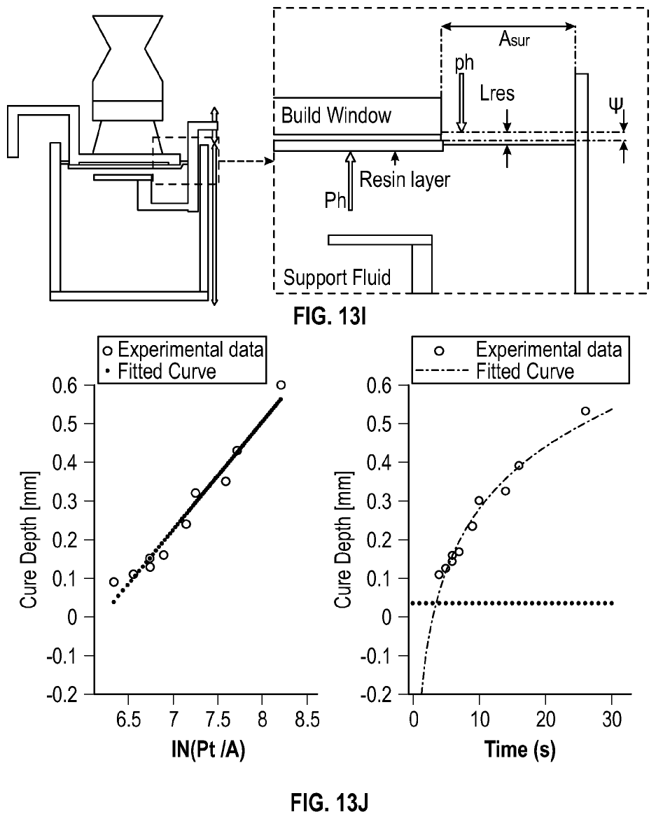

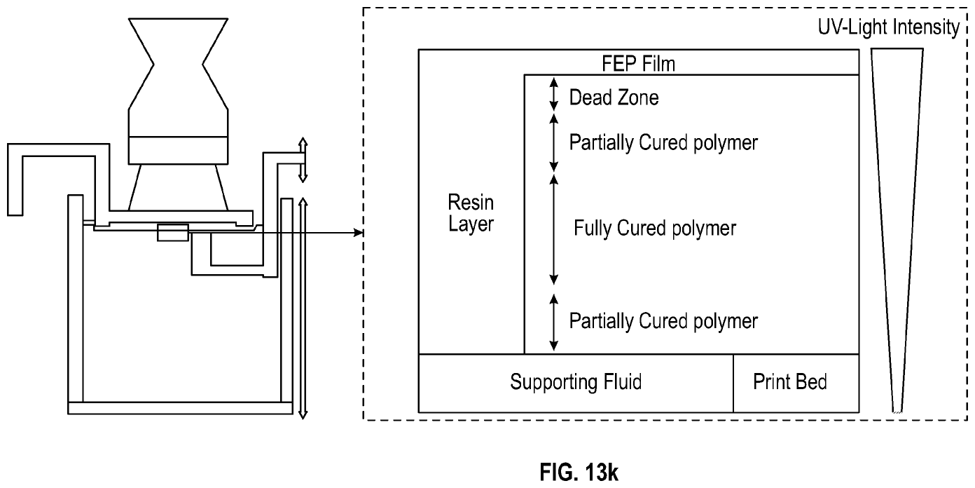

The distance that the part needs to be lowered into the supporting solution is dependent on whether complete de-wetting from the fluid interface and the printed part of each layer is desired or if removal from the optional build window necessitates it. If so, the build platform is raised up under the build window at a distance equal to the distance moved in FIG. 13.

The processes are repeated to successively build the workpiece in the support fluid in a layer-by-layer or a continuous process, as desired. That is, in some embodiments, the processes are repeated to successively build the workpiece in the supporting fluid in a layer-by-layer basis. In other embodiments, the controller may direct the optical system and the mechanical system to change synchronously with one another, such that the optical pattern projected into the resin changes in a controlled manner as the mechanized arm 110 lowers the build platform into the support fluid 114, resulting in a continuous, layer-free build process.

The controller 112 may include a central control device that operates with sensor controls or subassembly controls. In some embodiments, sub-controllers may be employed to regulate the support fluid level in the container 104, add resin between each build to a pre-defined resin layer thickness, and/or regulate the temperature of the support fluid 114.

The controller 112 may interface with or provide a user interface (e.g., graphical user interface) to receive inputs and provide outputs of, at least, the current progress of the build. The controller 112 may receive a file having instructions for the build of the workpiece 102.

### Example Liquid Additive Manufacturing System with Build Window

FIG. 2 shows an example liquid additive manufacturing system 100 (shown as 100b) (e.g., of FIG. 1) configured with a build window 140. The liquid additive manufacturing system 100b may include the various subcomponents of the system 100a, as described in relation to of FIG. 1, though is shown with emphasis on the build window 140.

In the example shown in FIG. 2, the resin is irradiated through the build window 140 located above or in contact with the support fluid 114. The build window 140 may comprise a material having reduced stiction with the current build layer (e.g., resin layer 120) thus formed. In some embodiments, the build window 140 comprises a fluoropolymer (e.g., tetrafluoroethylene). In other embodiments, the build window 140 comprises an oxygen-permeable material. In yet other embodiments, the build window 140 comprises a fluid having a density and/or viscosity less than the resin.

Top-down photopolymerization fabrication systems do not require a build window for part fabrication. However, the addition of a build window or thin film over the resin layer can improve the uniformity of the resin layer thickness, and can accordingly reduce the curvature of the cured part geometry resulting from non-uniform resin layer thickness. The addition of a build window or thin film over the resin layer can also be employed to facilitate continuous operation.

In some embodiments, the build window 140 comprises an oxygen-permeable window disposed above the ultraviolet image projection plane and configured to form a persistent liquid interface (also refer to as a “dead zone”) where photopolymerization is inhibited between the window and the polymerizing part. The workpiece can then be continuously drawn/pulled down of the resin in a top-down manner via the continuous motion of the build platform. An example of the continuous operation is described in Tumbleston et al., “Continuous liquid interface production of 3D objects,” Science 347.6228 (2015): 1349-1352.

FIG. 6 shows an example build interface between the support fluid 114 and resin layer 120.

### Experimental Results and Examples

A study was conducted to develop and evaluate a liquid additive manufacturing system (also referred to as a FISP system) employing a support fluid.

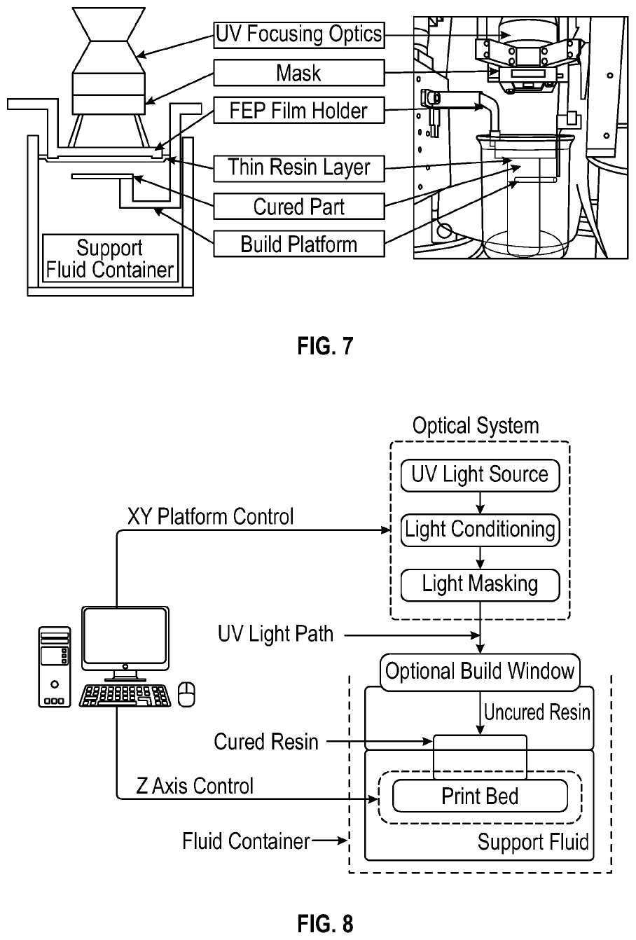

FIG. 7 shows an example FISP system that was fabricated in the study. The FISP system is a top-down SLA setup designed and utilized for experimentation. Like commercially available SLA printers, the setup used UV light to cure the photosensitive resin in successive thin resin layers and build up a 3D structure. The system included a movable optical setup positioned above a three-phase interface comprising a fluorinated ethylene propylene (FEP) film, a thin layer of photosensitive resin, and a support fluid (aqueous solution).

Within this interface, a build platform is positioned and is used to locate the part. The build platform is not necessarily flat and can be changed to accommodate different testing scenarios. FIG. 8 provides a diagram of the control system of the system of FIG. 7.

### Build-Fluid Supported Part Geometry

Printing micro-geometry unsupported three-dimensional geometries, i.e., without the use of sacrificial support structures, has not been considered in the art when fabricating macro structures larger than 1 cm², e.g., as they are being cured and with decreased polymerization homogeneity.

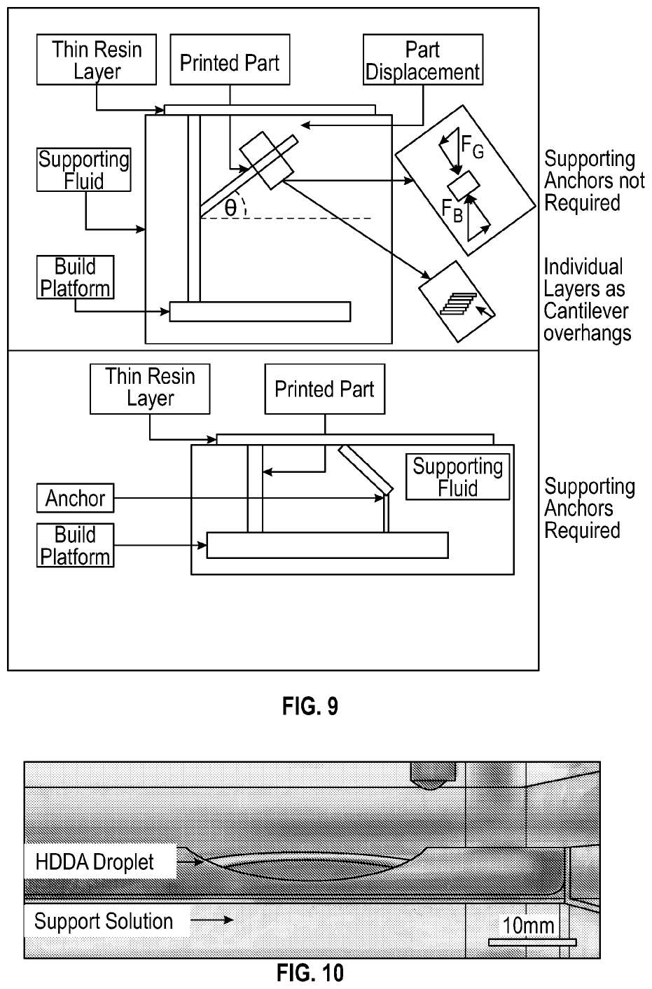

All part fabrication within a discrete or continuous layered photopolymerization system, such as within the FISP system, employed anchors for geometrically separated features below the build plane. These features may join as the part is continued to be fabricated in a subsequent layer. The types of overhangs that do and do not require anchors due to these intrinsic geometric constraints in the FISP system are displayed in FIG. 9.

The study evaluated the feasibility of an unsupported overhang less than 19°-from-level. The rule of thumb for overhang geometry within AM is that any overhang less than 45°-from-level requires sacrificial support structures due to the weight of each individual layer overcoming either the layer strength or stiffness. This rule of thumb is most directly applicable to FDM; however, the concept of overhang limit was still applicable to SLA fabrication. As an example, some of the most common commercial SLA systems were produced by Formlabs, which recommend a minimum unsupported overhang angle of 19° from level, using a 35×10×3 mm part as an example (see Formlabs. “Design specifications for 3D models (Form 2).” https://support.formlabs.com/s/article/Design-Specs?Language=en_US (accessed Jun. 23 2020)).

As shown in FIG. 9, discrete layers can be considered synonymous to a cantilever overhang when isolated. Thin layer cantilevers, therefore, are representative of initial unsupported overhang geometry and act as a foundation for the feasibility of macro-geometry fabrication within the system. The largest surface-area unsupported cantilever geometry reported was found to be 9 mm long, 600 um wide, and 150-200 um thick (see C. Credi, A. Fiorese, M. Tironi, R. Bernasconi, L. Magagnin, M. Levi, and S. Turri, “3D Printing of Cantilever-Type Microstructures by Stereolithography of Ferromagnetic Photopolymers,” ACS ApplMater Interfaces, vol. 8, no. 39, pp. 26332-26342, Oct. 5 2016).

### Fluid Composition Determination, Resin Refill Rate, and Thickness

A systematic design of experiments and analysis was conducted to understand the influence of the various material compositions on the resulting process outputs like the resin layer refill rate, area, and thickness. The resin thickness and refill rate of the system may then be modeled by the surface tension interfaces within the system for a given fluid composition.

Low viscosity, fluid immiscibility, and low sorption were determined to be critical characteristics of the fluid composition. For a water-based supporting solution, increasing the polar components of the resin through the addition of an insoluble additive can increase the surface spreading on the support fluid by reducing the interfacial tension between the fluids. The use of a polar solution was identified as one method of enabling the dissolution of additives into the supporting solution. The same polarity metrics were determined useful in maintaining immiscibility between the fluids. It was found that the utilization of a resin additive with a higher polar component increases the surface spreading on water through the reduction of interfacial surface tension.

The resin, or liquid photopolymer, in a free-radical photo-curing system may be a mixture of monomers and oligomers whose crosslinking is facilitated by the UV-activation of a photoinitiator within the mixture (see K. e. Holmberg, “Handbook of Applied Surface and Colloid Chemistry New York,” vol. 2: Wiley and Sons, 2002., ch. 219). Different resins/additives can change the resin curing characteristics, the spreading of the resin on the top of the support fluid, the cured material properties, and more.

When a solid such as the photoinitiator is mixed into the solution, the resulting volume of the solution after mixing may be expressed in molarity or mole fraction. The mole fraction gives the ratio of the mols of each additive to the total moles in the system, which is a useful indicator for observing how changes in molecular composition affect the curing behavior inside of the resin. In the study, the molar fraction (or its percent value) was employed when describing composition percentage and additive concentrations unless explicitly stated otherwise.

Water and saline solution was considered generally the preferred support solution, as it is a low-cost polar solvent with a neutral pH whose properties can be adjusted with a wide array of additives. After an evaluation of prior literature, cost, and initial feasibility tests, pure sodium chloride was chosen as an additive to increase the density of the solution to the expected density ranges of common resins. As a nonpolar solute, the saturation of salt in the solution may decrease the solubility of the supporting solution with a non-polar resin.

Indeed, the supporting solution may have a lower volumetric cost than the resin to be a suitable bulk liquid replacement. The supporting solution should be denser than the liquid photopolymer resin so the resin can lie on the surface of the support fluid, while simultaneously having a density similar to the cured polymer. The mitigation of density differences can minimize the resulting force on a cured part from buoyancy and gravity within the system. Common photopolymer liquid resins used in SLA have a density usually in the range of 0.9 g/L-1.15 g/L, (see Forecast_3D. “SLA Materials: Epoxy resins for producing fine detailed, rapid prototypes.” FORECAST 3D. Available at: https://www.forecast3d.com/materials/sla (accessed Feb. 26, 2021); and W. Chemical. “EMAC® and EBAC® Acrylate Resins.” 1 Westlake Chemical. https://www.westlake.com/_polyethylene-products/emac%C2%AE-and-ebac % C2%AE-acrylate-resins (accessed Sep. 19, 2021)), that is, a suitable supporting solution's density should be equal to or greater than this density range. A supporting solution should accept an additive to tune the support solution density, which can be achieved through the dissolution of another substance. Dissolution can be achieved through acidic, basic, amphoteric, ionic, or aprotic/protic solvent properties. The supporting solution should be able to accept an additive to tune its density without dissolving the photopolymer. A relatively unreactive fluid with a somewhat neutral pH is desirable for minimizing material degradation and complexity while maximizing the system's safety and broader adaptation. The supporting solution should be a relatively poor solute whist able to accept a density additive.

Adjusting fluid polarity can be one way to manage the solubility characteristics of the resin and the supporting solution without necessitating the supporting solution to be a strong solvent. Polarity can affect the viscosity and solubility of the fluids, as polar solvents can easily dissolve polar solutes, and the same goes for nonpolar solvents and solutes. Polarity may be driven by dipole forces, electronegativity, and hydrogen bonding. The higher the number of hydrogen bonds a compound can donate and accept, the more polar and more viscous the compound is likely to be. Common non-polar oils generally have densities less than 1 g/L (see EngineeringToolBox. “Liquids-Densities.” Available at: https://www.engineering_toolbox.com/liquids-densities_743.html (accessed Apr. 17, 2021)), and typically are unable to dissolute ionic compounds due to their non-polarity, making them undesirable for the FISP system. Specialized, dense, inert oils, such as fluorocarbon oils or Fluinert used in the static liquid constraint interface printing system (see A. A. Bhanvadia, R. T. Farley, Y. Noh, and T. Nishida, “High-resolution stereolithography using a static liquid constrained interface,” Communications Materials, vol. 2, no. 1, 2021) may be used as an alternative to water but can cost up to $3 per ml (see “Fluorinert FC-40.” The Lab Depot. Available at: https://www.labdepotinc.com/p-17459-fluorinert-fc-40?cat_code=F3540-250ML (accessed Feb. 21, 2021)).

For an ideal fluid interface supported printing system, the support fluid would be inert relative to the resin, with no interfacial chemical activity. The selected monomer for use in the fluid system may be minimally viscous as well as insoluble with the support solution. Solubility would correspondingly display a failure mode of the resin area and thickness requirements. Any solubility coefficient less than 0.1 g/L is considered insoluble (see E. Rogers, I. Stovall, L. Jones, R. Chabay, E. Kean, and S. Smith, “Fundamentals of Chemistry: Solubility.” [Online]. Available: Available at: http://www.chem.uiucedu/webFunChem/GenChemTutorials.htm). Low viscosity may be desirable to increase the refill rate of the used resin. Free radical photopolymerizable resins, such as acrylates, are widely used in additive manufacturing and thus desirable for evaluation due to their extensive prior literature. Some common monomers are outlined in Table 1.

TABLE 1
Comparison of Acrylate Monomers considered for the FISP system.

| | | | | Water | Molecular |
|---|---|---|---|---|---|
| | | Viscosity | Density | solubility | Weight |
| Name | Acronym | (cP) | (g/mL) | (mg/mL) | (g/mol) |
| Trimethylolpropane | TMPTA | 106 | 1.09-1.12 | 0.46 | 296.319 |
| triacrylate | | | | | |
| 1,6-Hexanediol | HDDA | 9 | 1.02 | 0.10 | 226.27 |
| diacrylate | | | | | |
| Urethane | UDMA | 6.75 | 1.129 | 6.62 | 470.6 |
| dimethacrylate | | | | | |
| Triethylene glycol | TEGDMA | 50 | 1.072 | 2.41 | 286.3 |
| dimethacrylate | | | | | |

Because of low water solubility and viscosity, HDDA was a clear candidate between the monomers outlined. TMPTA has been shown to have a greater rate of polymerization and better part strength when produced. However, from the solubility and viscosity characteristics alone, HDDA was employed to establish the initial feasibility of the process. For crosslinking activation of the photopolymer, 2,2-Dimethoxy-2-phenylacetophenone (DMPTA) is utilized due to its widespread use as an acrylate photoinitiator and its insolubility with the supporting solution.

Prior literature noted the degradation of the quality of both acrylate and epoxy monomers due to sorption, including both adsorption and absorption (see S. H. Tuna, F. Keyf, H. O. Gumus, and C. Uzun, “The evaluation of water sorption/solubility on various acrylic resins,” (in eng), Eur J Dent, vol. 2, no. 3, pp. 191-197, 2008.[Online]. Available: https://www.ncbi.nlm.nih.gov/pmc/articles/PMC2635902/; and A. F. Abdelkader and J. R. White, “Water absorption in epoxy resins: The effects of the crosslinking agent and curing temperature,” Journal of Applied Polymer Science, https://doi.org/10.1002/app.22400 vol. 98, no. 6, pp. 2544-2549, 2005 Dec. 15 2005). Sorption had been displayed to be independent of solubility characteristics. High equilibrium uptake of water had been noted to soften acrylic resins, increasing the material volume and acting as a plasticizer reducing the strength of the material. Cationic photopolymers, such as epoxies, were reported to have significant water sorption and solubility, undesirable characteristics within a photopolymerization system.

The materials presented here as the supporting solution and functional monomer are one combination of the possible fluids that can be used within the system, and future extension or revision can be completed under the guidance outlined in this example. This section introduced the solubility and sorption characteristics necessary to prevent the dissolution of the uncured resin layer, noted the importance of the viscosity in the corresponding resin refill rate, and evaluated alternatives for the support solution and resin monomer. The fluid interface between these two liquids can now be characterized.

### Estimation of Resin Wetting and Additive

In top-down polymerization processes, the resin is cured on the top surface of the support fluid, and the resin needs to rewet the surface that has been cured. To facilitate rapid printing in the exemplary system, the resin should wet the surface of the supporting solution in a short and consistent timeframe. For process control of the system, a consistent equilibrium layer thickness was also desired.

A 200 ul droplet of HDDA was observed to exhibit slow growth as disk-shaped droplets on the saline solution and thus failed the wetting and resin refill requirements (see FIG. 10).

### Wetting and Spreading Evaluation

To evaluate the factors influencing the resin layer thickness, area, wetting rate, etc., the study generated a model that evaluates the degree of equilibrium surface wetting, the rate of the wetting, and the resin additives in the exemplary system.

The degree of equilibrium surface wetting may be primarily determined by the intermolecular interactions defining the surface tensions. The rate of this wetting may be driven by the fluid viscosity, surface tension, and volume deposited. These factors may then be used to evaluate resin additives in the exemplary system.

Surface tension, represented by γ (or alternatively σ or T) may be considered as the work needed to exceed the sum of the forces holding separate surfaces together. A surface tension of 1 dyne/cm or 1 mN/m is equivalent to a surface free energy (SFE) of 1 mJ/m². Young's equation (see P. G. de Gennes, “Wetting: statics and dynamics,” Reviews of Modern Physics, vol. 57, no. 3, pp. 827-863) is the basis of all surface free energy theories, describing the balance of forces at a three-phase contact where three phases meet at a contact line. Young's equation is provided per Equation 1, where γₛᵥ is the surface free energy of the solid, γₗᵥ of the liquid, γₛₗ between the solid and liquid, and θ is the contact angle of the boundary between the mediums.

γₛᵥ=γₛₗ+γₗᵥ cos(θ) (1)

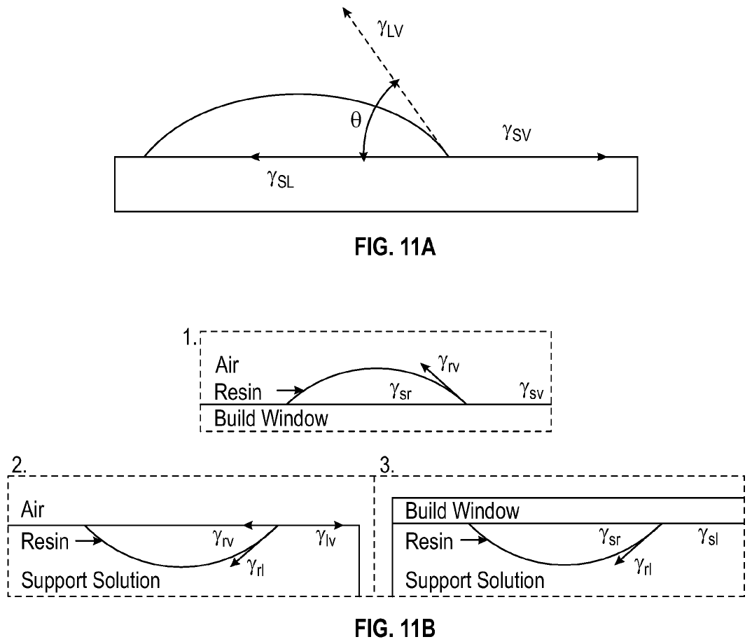

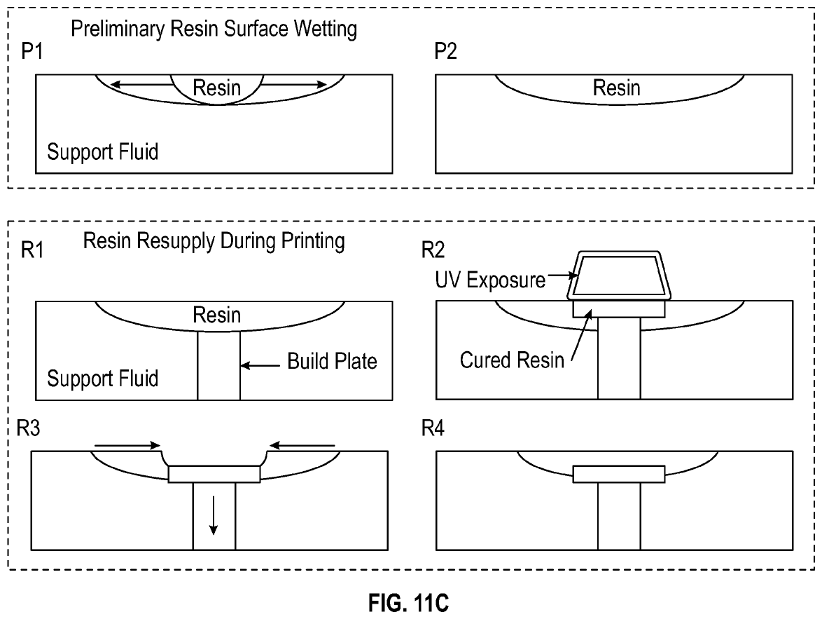

FIG. 11A displays the surface tension tensors for Equation 1. Each of these surface energies is expressed as the interfacial force between the three phases: solid-liquid, liquid-gas, and solid-gas, as separate mediums in which an evident contact boundary exists between them. The fluid-liquid-gas boundary may have the fundamental physical relationships as a solid-liquid-gas boundary, although additional complications exist. (see J. W. Drelich, “The significance and magnitude of the line tension in three-phase (solid-liquid-fluid) systems,” Colloids and Surfaces A: Physicochemical and Engineering Aspects, vol. 116, pp. 43-54, 1996.) As established by De Gennes (1985), Young's equation may be derived when global energetic arguments are not considered and the contact angle is measured macroscopically.

The liquid-solid interfacial tension can be modeled as the work expended to increase the size of the interface between two adjacent phases. In the bulk of an isotropic liquid, molecules only interact with molecules identical to themselves, meaning the total force field of each molecule is isotropic. When these molecules are at the interface with another liquid, attractive forces are felt by molecules of a different phase, which is where the interfacial tension, γ_{A/B} acts, expressed in mN/m or mJ/m². When interactions from hydrogen bonding, Van Der Walls forces, polar interactions, etc., are lower between the molecules at the interface than in the bulk phase, the fluid's cohesive energy may be higher than the interfacial energy. This cohesive energy can create a net force inside a fluid and forces the liquid surface to contract to the minimal area. The hydrodynamics of wetting may be modeled by the presence of the three-phase contact line separating “wet” regions from those that are either dry or covered by a microscopic film only. Wetting is the ability of a liquid to maintain contact with another surface, resulting from intermolecular interactions when the two are brought together. The degree of wetting (wettability) is determined by a force balance between adhesive and cohesive forces (see D. Bonn, J. Eggers, J. Indekeu, J. Meunier, and E. Rolley, “Wetting and spreading,” Reviews of Modern Physics, vol. 81, no. 2, pp. 739-805).

In the exemplary system and method, these forces can be acting between the resin and its surrounding mediums, whether that is air, a build window, or a supporting solution (l). Case “1” of FIG. 11B displays a classical Young's equation spreading experiment, in which a droplet of resin (r) lies atop a solid surface (s) in a vapor (v) medium. The orientation of the droplet was inverted within the exemplary system, however. This gave rise to cases “2” and “3,” where the droplet is partially submerged in the supporting solution. The difference between case “2” and “3” was the presence of a build window; however, in both of these cases, the resin-liquid interfacial boundary influences the resulting spreading characteristics.

The spreading coefficient, S, may be defined as the difference between the work of adhesion Wₐ and the work of cohesion W_{c}. When one phase is wetted by another, work, in the form of interfacial tension, must be done to increase the size of the interface. The adhesive and cohesive works are defined in Equation 2, and the resulting spreading parameter is defined in Equation 3, where the wetted surface-vapor interface has a surface tension of γⱼᵥ, the deposited fluid-vapor surface tension is yᵢᵥ, and interfacial wetted surface and deposited fluid surface tension is γᵢⱼ (see M. Kalin and M. Polajnar, “The correlation between the surface energy, the contact angle and the spreading parameter, and their relevance for the wetting behaviour of DLC with lubricating oils,” Tribology International, vol. 66, pp. 225-233, 2013/10/01/2013).

Wₐ=γᵢᵥ+yⱼᵥ−γᵢⱼ;W_{c}=2γᵢᵥ (2)

S=Wₐ−W_{c}=γⱼᵥ−γᵢᵥ−γᵢⱼ (3)

If the spreading parameter, S, is positive, the liquid would spread towards a complete film to achieve a favorable energy state between the substrates. If the parameter is negative, the fluid spreading would be partially wetting or fully non-wetting on the interface. The equilibrium wetting state, therefore, may be predicted to be higher with a fluid with a lower surface tension and a lower interfacial tension γᵢⱼ with the wetted surface.

The triple line is the interface in which the three mediums meet, whether it be the gas-liquid-solid interface, liquid-liquid solid interface, etc. With liquid-liquid surface wetting, a precursor film of dynamical origin can precede the spreading of the fluid, which complicates the triple line by enabling it to bend and take different conformations that were originally considered energy unfavorable. The precursor film results in an additional equilibrium state of pseudopartial wetting, where a thin film can cover the entire surface and surrounds the original spreading droplet. By measuring the adsorption isotherm between the phases and using the Gibb's adsorption equation to calculate the change of surface tension, variations of the interfacial surface tensions between the dynamic and equilibrium wetting states in a fluid-fluid interface may be addressed in the analysis. This dynamic interfacial equilibrium surface tension can be compensated for through the evaluation of the adsorption of molecules on between the phases using the surface entropy and chemical potential. Modeling equilibrium film thicknesses was done through the use of van der Waals body-body interactions. Components of these interactions include the number densities of the interacting particles, the London coefficient of the particle-pair interactions, the particle-pair potential, and the intermolecular equilibrium distances (see J. Sebilleau, “Equilibrium Thickness of Large Liquid Lenses Spreading over Another Liquid Surface,” Langmuir, vol. 29, no. 39, pp. 12118-12128, 2013 Oct. 1 2013).

It should be noted that temperature and surface tension display a correlation that can be linear at small temperature ranges per Eötvös rule, which relates the change in surface tension to the change in temperature by γV^{2/3}=k(T_{c}−T) (see S. Sugden, “The variation of surface tension with temperature and some related functions,” Journal of the Chemical Society, Transactions, vol. 125, no. 0, pp. 32-41, 1924). A fluid's solubility, viscosity, and surface tension can all be functions of temperature, in which as the temperature increases, the greater the solubility, the lower the viscosity, and the lower the surface tension of the fluid.

The exothermic properties of photopolymerization would have a small influence in the temperature of the surrounding fluids, and, therefore dynamically influence their surface tension and viscosity. However, since the ambient temperature was held constant and the supporting solution had a high specific heat capacity, the influence of the minimal temperature change on the overall system was considered negligible within the system.

A resin additive should decrease the time it takes to wet the support fluid. The drop radius of a wetting fluid on a solid surface is described by Tanner's law (see M. Delgadino and A. Mellet, “On the Relationship Between the Thin Film Equation and Tanner's Law,” Communications on Pure and Applied Mathematics, vol. 74, Oct. 1, 2020), as shown in Equation 4. The speed of spreading may be controlled by the balance of available energy (surface or gravitational) and dissipation, which occurs mostly near the contact line but also near in the bulk of the drop, which is described in Equation 4.

$$r ( t ) ∼ {R ( \frac{γ t}{μ R} )}^{n} \qquad ( 4 )$$

Tanner's law shows the drop radius (r) with respect to time as an inverse power law relationship function of the fluid interfacial surface tension (γ), the drop radius (R), and the fluid viscosity (μ), where n is the spreading or wetting exponent (see W. Bou-Zeid and D.

Brutin, “BEYOND TANNER'S LAW: ROLE OF CONTACT LINE EVAPORATION ON THE SPREADING OF VISCOUS DROPLET,” Interfacial Phenomena and Heat Transfer, vol. 3, no. 3, pp. 221-229, 2016Apr.-12 2015). This exponent generally was equivalent to 1/10 when balancing capillary and viscous forces. However, when the drop was in a spreading regime where the bulk phase fluid dissipation dominates or when the contact line fluid dissipation dominates, n is reported to be 1/8 and 1/7, respectively. When a drop was placed on a surface, it may generally be far from its equilibrium state. An additive that would increase the rate of change of the surface spreading should therefore have a larger surface tension and a lower viscosity. It has been recently suggested that spreading behavior on a fluid-fluid interface follows logarithmic temporal radial growth characteristics rather than a power-law outlined by Tanners Law in a fluid-fluid system (see M. R. Rahman, H. N. Mullagura, B. Kattemalalawadi, and P. R. Waghmare, “Droplet spreading on liquid-fluid interface,” Colloids and Surfaces A: Physicochemical and Engineering Aspects, vol. 553, pp. 143-148, 2018). The interface suggests a coalescence-like behavior during spreading, raising questions of the influence of the curvature on the droplet interface.

### Evaluation of Resin Additives of Interest

Additives used in the system should have a low viscosity and high interfacial tension to increase the rate of spreading on the supporting solution and increase the total wetting degree. Simultaneously, additives used in the FISP system must be price efficient, remain immiscible with the supporting solution, and be relatively safe to use in an environment without ventilation.

Table 2 displays a comparison of different additives that were considered for experimentation, with a comparison of their relevant attributes.

TABLE 2
Additives comparison per surface tension, density, water solubility,
reaction potential, and molecular weight.

| | | | | Water | | Molecular | |
|---|---|---|---|---|---|---|---|
| | | Viscosity | ρ | solubility | Active/ | Weight | γ |
| Name | Acronym | (cP) | (g/mL) | (mg/mL) | Inert | (g/mol) | (mN/m) |
| Decahydronaphthalene | Decalin | 1.788 | 0.896 | <0.10 | Inert | 138.25 | 3.15 |
| Dimethylbenzene | Xylene | 0.812 | 0.865 | <0.10 | Inert | 106.16 | 28 |
| 2-Ethylhexyl acrylate | EHA | 1.7 | 0.885 | <0.10 | Active | 184.27 | 26 |
| Butyl Acrylate | BA | 0.92 | 0.9 | <0.14 | Active | 128.17 | 20 |
| Oleic Acid | OA | 27.64 | 0.895 | <0.1 | Inert | 282.468 | 31.92 |
| n-Butyl Acetate | — | 1.1002 | 0.8825 | 0.68 | Inert | 116.16 | 25.3 |
| Methyl Methacrylate | MMA | 0.6 | 0.94 | 15.00 | Active | 100.12 | 31.4 |
| Propylene glycol | PGMEA | 0.8 | 0.962 | 19.80 | Active | 132.159 | 26.9 |
| methyl ether acetate | | | | | | | |
| Methyl Acrylate | MA | 0.6 | 0.95 | 50.00 | Active | 86.09 | |
| 1,3-Propanediol | — | 52 | 1.0597 | Miscible | Active | 76.09 | 46.2 |
| BYK UV-3500 | — | Unk. | 1.04 | Unk. | Active | Unk. | |

Per Table 2, Butyl Acrylate, 2-Ethylhexyl Acrylate, and Oleic acid were potential additives. An important property was the solubility with the supporting solution, as miscibility between the resin and the supporting solution would be detrimental to the resin purity and polymerization ability, which may eliminate many potential candidates.

Secondarily, an additive is desired that can be safely experimented with in an environment with minimal ventilation and little training to use, making decalin and xylene less desirable to test.

To validate the selected fluids, Tanner's law of spreading were referenced, where the rate of spreading across the surface may increase with lower fluid viscosity and lower interfacial and resin surface tension.

### Methods of Surface Wetting Characterization

The preliminary wetting of the resin layer may depend on the triple line growth of the droplet on the surface of the supporting liquid. The area of this droplet grows slowly over time and influences the resulting resin layer thickness when the part is being cured. The resin refill rate existed when a layer is cured, and the fluid from the previously existing area was removed. This can occur more rapidly than the growth of the triple line because the fluid is not relying on interfacial adhesive forces. Rather, it is pushed along by the cohesive forces of the resin and operates as a function of the fluid viscosity. FIG. 11C shows the difference between the initial wetting of the triple line.

The speed of the resin refill rate was much more rapid than that of the initial surface wetting, with a refill of a 9.5 mm diameter void occurring within 4 seconds experimentally. The initial spreading along the triple line, however, occurred much more slowly, and required observation over a much larger timescale. This may have occurred due to the high degree of cohesion within the resin relative to the interfacial adhesion between the fluids, and the height difference of the refill area, creating a zone of lower elevation that the resin may naturally fill.

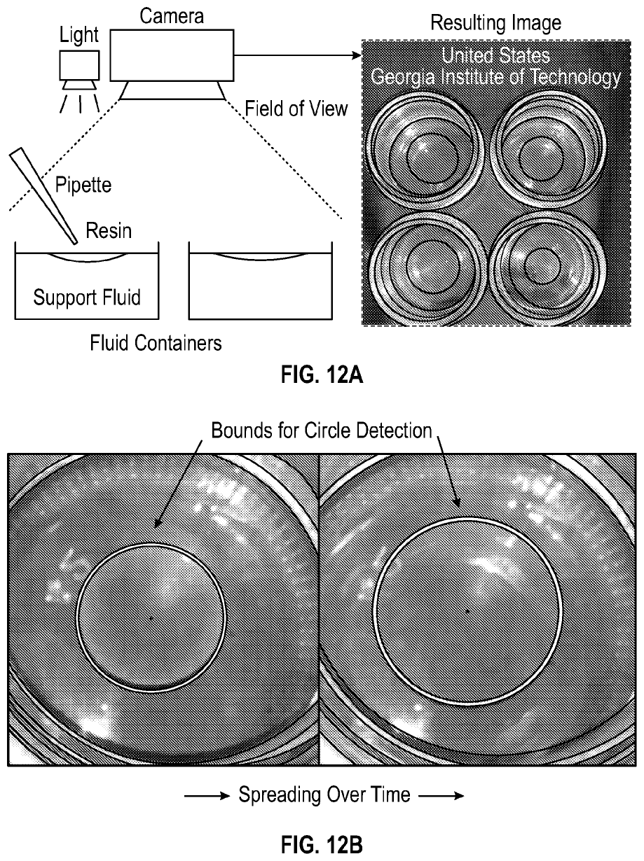

FIG. 12A displays the experimental setup for the spreading experiments and the resulting image in which top-down videos were taken of resin droplet spreading behavior on the support fluid interface without a build window. In FIG. 12A, the fluid spreading experimental setup is shown in the left pane, and the right pane panes shows a camera image of the four fluid containers used in the experiments.

The experiment was conducted without a build window in order to capture the interfacial behavior between the two liquids, without the influence of an external window, while characterizing the γᵣₗ. The experimental setup included four containers assessed in the camera field of view (FOV), in which droplets of the various resin solutions are deposited onto the support fluid.

FIG. 12B displays the visualization displayed during the circle detection software processing. A computer vision function library was implemented into a codebase created to track the advancing contact boundaries, and the resulting radii and times from the videos are inputted into MATLAB. The program uses Hough Circles from the opencv2 function library (see G. Bradski, “The openCV library,” Dr. Dobb's Journal: Software Tools for the Professional Programmer, vol. 25, no. 11, pp. 120-123, 2000), with implementation of automatic error compensation and circle-finding sensitivity adjustments. In FIG. 12B, the circles show the output of the circle detection operation for the resin wetting experiment, displaying the increase in diameter over time and the program's ability to capture the resulting diameter.

In MATLAB, data processing was performed to remove the circle outliers, smooth the data, and adjust the measurement of diameter from pixels (px) to millimeters. In one experiment, given the internal diameter of the container is equal to 48.5 mm and the corresponding pixel diameter is equal to 470 px, a scaling factor of 0.1032 was applied. The scaling factor was applied to samples with a fixed distance, cropping ratio, and zoom level on each of the samples tested.

### Surface Spreading Experimental Results

FIGS. 13A-13D show results of surface wetting experiments. Specifically, FIG. 13A shows fitted curved for four surface wetting experiments, with the experimental data (Exp) and the resulting fit lines. FIG. 13B shows relative changes in diameter for wetting experiments of varying photoinitiator content. FIG. 13C shows the relative diameter changes for different additive percentages of 2-exylhexyl acrylate (left) and oleic acid (right), showing an increase in relative surface spreading from additional EHA, and a decrease in spreading from the addition of OA. FIG. 13D shows the droplet change in absolute diameter for a variety of resin solution compositions, displaying a correlation between the addition of EHA and the resin's spreading speed and resulting surface area.

The figure displays inverse power law fit lines performed for each of the trials, in accordance with Tanner's law. By fitting Equation 4, Tanner's law, to the data with approximations for the interfacial surface tension and viscosity, one can obtain the best-fit exponential for the spreading dataset. For the HDDA resin on the saline supporting solution, n=1/7 displays the best fit. This indicates that the spreading is dominated by the bulk phase or contact line fluid dissipation rather than an exclusive balance of the capillary and surface tension forces within the system. This indicates that a proper prediction of the rate of spreading on the surface of the fluid requires an analysis of the chemical interactions and adsorption isotherm between the fluids as well. This also indicated that, with a resin-saline-air system, equilibrium wetting may occur over a significantly longer timeframe.

The fits within the graph display a clear trendline with respect to the collected data. However, the data from the 1% PI, 1% EHA solution in this example does not display the exact same behavior in both cases. Preliminary experimental results indicated a degree of uncertainty between trials.

For each individual trial, the uncertainty bounds were low, as the software solution that was created enabled an accurate fit to the data points. But due to the variation in the solution's wetting behavior between trials, the data was averaged between a series of tests for each of the resin compositions outlined below. This direct observation method failed for solutions that display no contact line boundary and dissolute into the surrounding medium. This was acceptable, as dissolution into the surrounding medium reasonably indicated the disappearance of the resin layer and a failure to meet the thickness and area specifications set forth previously.

Evaluation of varying photoinitiator content on the surface spreading behavior provided an indication of the motivation behind the investigation of different additives to the system. The resulting averaged fits for photoinitiator variation are calculated as a function of a relative change to initial droplet diameter and are displayed in FIG. 24.

FIG. 13B demonstrates that the variation of photoinitiator content in the resin does not result in a significant change in the relative diameter of the resin droplet. Although minimal, the surplus of photoinitiators in the solution had a small increase in its relative diameter.

FIG. 13C shows the effects of the additives Oleic acid and 2-Ethylhexyl Acrylate. It can be observed that the addition of Oleic acid into the resin solution did not create a thin liquid layer, as seen by Rayleigh, but it rather decreased the relative spreading of the droplets. The resin with an additional 1% OA displayed an initial diameter of approximately 12 mm, much smaller than without OA, at approximately 22 mm. This was contrary to literature predictions and can be attributed to unknown molecular interactions of the fluids that modify the surface energy, e.g., likely due to the significant difference between the resin base and additive molecular structure.

The addition of EHA displayed significantly more desirable spreading behavior over the trials conducted. A trend can be observed in which the more EHA is added to the HDDA, the greater the degree of spreading on the surface. While relative diameter change can be a guide for trends in the data, observing the absolute size of the droplets with and without EHA appeared to provide the clearest indication of the change in diameter as a function of time.

FIG. 13D displays an increase in spreading speed and wetting behavior due to the addition of EHA in the system. The addition of EHA in the resin appeared to be determined to decrease the thickness of the resin layer and increase the rate of refill of the resin on the top of the support fluid. For a 200 μl deposition of resin, and a droplet diameter of 40 mm, a cylindrical approximation results in a layer thickness of the resin to be 160 μm.

Since HDDA is a difunctional acrylate that creates a denser crosslinked network than EHA, it was desired to have a relatively higher concentration of HDDA. FIG. 25 displays a clear trend of increased wetting rate with increased EHA composition, with 5% EHA falling somewhere close in the middle of 1% EHA and 10% EHA. Therefore, an addition of 5% EHA was determined in one experiment to be a relatively suitable addition to the resin to both increased surface spreading while avoiding significant alteration in the polymerization behavior of the base monomer.

### Resin-Support Fluid Interfacial Tension Experimental Results

To validate the interfacial surface tension of the selected resin combination, pendant drop experiments were conducted in the study. The method is one of the most widely used to determine the interfacial surface tension between two immiscible fluids (see J. D. Berry, M. J. Neeson, R. R. Dagastine, D. Y. Chan, and R. F. Tabor, “Measurement of surface and interfacial tension using pendant drop tensiometry,” (in eng), Journal of Colloid and Interface Science, vol. 454, no. 1095-7103 (Electronic), pp. 226-237, Sep. 15, 2015). The experiment involved the extrusion of a denser fluid into another fluid's medium and measuring the resulting shape. The Young-Laplace relationship is shown in Equation 5, which describes the pressure difference between the external liquid phase (Pₑₓₜ) and the internal liquid phase (Pint), of a curved liquid surface with principal radii R₁ and R₂.

$$Δ P ( z ) = ( {P}_{i n t} - {P}_{ext} ) = {γ}_{lr} ( \frac{1}{{R}_{1}} + \frac{1}{{R}_{2}} ) \qquad ( 5 )$$

Surface tension seeks to minimize the surface area, while gravitation stretches the drop size via a pressure difference across the z-axis, according to Pascal's law. Therefore the Laplace pressure at a distance z from an arbitrary reference plane can be described as in Equation 68, with Δp describing the density differences between the two fluids.

ΔP(z)=ΔP₀±ρgz (6)

These two equations can give an indication of the behavior of a submerged fluid droplet within a secondary medium. The hydrostatic and Laplace pressure balance dictates the resulting fluid shape, by setting the reference plane to the point at a vertex located at the lowest drop level, R₁=R₂=R. By combing Equations 5 and 6, a parameterizable equation describing the fluid geometry is developed as Equation 7.

$$\frac{1}{R} + \frac{sin ( ϕ )}{x} = \frac{2}{R} \pm \frac{Δ pgz}{{γ}_{lr}} \qquad ( 7 )$$

Through the parameterization of the equation with arc length s, a set of three first-order differential equations was developed (Equations 8-10) with boundary conditions set in Equation 11.

$$\frac{d ϕ}{ds} = - \frac{sin ( ϕ )}{x} + \frac{2}{R} \pm \frac{Δ pgz}{{γ}_{lr}} \qquad ( 8 )$$

$$\frac{dx}{ds} = cos ( ϕ ) \qquad ( 9 )$$

$$\frac{dz}{ds} = sin ( ϕ ) \qquad ( 10 )$$

$$0 = x ( s = 0 ) = z ( s = 0 ) = ϕ ( s = 0 ) \qquad ( 11 )$$

The numerical fit of the droplet shape curvature around the arc of the droplet may eventually converge to the resulting interfacial surface tension. To facilitate this process and apply the parameteric partial differential equations to the fluid interface, an open-source software is used called Opendrop (see E. Huang, A. Skoufis, T. Denning, J. Qi, R. Dagastine, R. Tabor, and J. Berry, “OpenDrop: Open-source software for pendant drop tensiometry contact angle measurements,” Journal of Open Source Software, vol. 6, p. 2604, Feb. 23, 2021). This software allowed the user to set bounding boxes around the deposition tip (shown in a blue box) and the droplet (shown in a red box), and numerically solved for the set of partial differential equations outlined above.

FIG. 13D displays the relevant parametric variables used to solve for the interfacial surface tension and the bounding boxes used in the Open Drop software. Specifically, FIG. 13D shows a pendant drop experiment of 20% wt saline droplet in 2.5% PI, 5% EHA (mol fraction) resin continuum shown with relevant parameters (left), and OpenDrop boundary selection (right) of the tip and droplet. The suspended drops were photographed using a ramé-hart Contact Angle Goniometer/Tensiometer (model 210), which directs a diffuse light source behind a fluid droplet sample to isolate it in the frame.

Experiments were conducted by filling a cuvette with a continuous fluid medium of resin and extruding a 20% wt saline solution droplet through a 0.9 mm diameter aluminum syringe. Using a resin density of 1.04 g/cm³, a needle diameter of 0.9 mm, and a droplet (saline) density of 1.15 g/cm³, the average resulting interfacial tension is found to be 13.8 ±3 mN/m across the pendant drop experimental results from the Open Drop software. The accuracy of the Open Drop software was high, but the density parameters used in the analysis have a much larger uncertainty range due to the deposition equipment uncertainty (˜±20 μl), which was accounted for in the interfacial surface tension uncertainty bounds. This determination of the interfacial surface tension was sufficient for developing an understanding of the force components that affect a part moving through the FISP system, outlined further below.

The interfacial tension found in this example closely reflects the expected results from the OWRK model, displaying a value between the expected water interfacial surface tension with HDDA or EHA at 20.19 mN/m and 5.93 mN/m, respectively. This indicated the validity of the theoretical interfacial result and outlined methods for increasing spreading behavior in future adaptations of the FISP system. The study concluded that, for a water-based supporting solution, increasing the polar components of the resin through the addition of an insoluble additive can increase the surface spreading on the support fluid.

### Build Window Influence to the Resin Spreading Behavior

Characterization of the surface spreading behavior for an unconstrained liquid interface has been conducted, with an evaluation of additive compositions to increase spreading behavior. The addition of a build window into this interface makes the fluid system significantly more complex to characterize in a fluid-fluid-solid interface. The build window utilized within this system is comprised of a fluorinated ethylene propylene (FEP) film, in which the motivation behind its selection is outlined further below. The geometric placement of each of the components in the system, the volume of fluid deposited, and the intermolecular components of all of the materials influence the resin layer thickness when underneath this film. The resulting thickness of the resin becomes very difficult to model because of this.

The principles of spreading behavior reviewed in this example, however, remain. The theoretical interfacial surface tensions derived from the OWRK model predict a low interfacial solid-liquid interfacial surface tension (γₛₗ) between the FEP-HDDA interface of only 2.75 mN/m. The interfacial surface tensions between the FEP-Water interface (γₛₗ) and the HDDA-Water interface (γₛᵣ) were found to be 31 mN/m and 20.2 mN/m, respectively. Applying these surface tensions as tensors gives an indication of what kind of surface spreading behavior is expected. FIG. 13F shows surface tension components for an exaggerated resin droplet underneath an FEP build window.

The theoretical interfacial tension between the resin and the FEP film is significantly less than that of the Saline and FEP film. As reviewed within this example, this predicts a very significant degree of wetting. This influence is experimentally demonstrated when an FEP film is atop the fluid interface. The degree of wetting is so significant, in fact, that the resulting thickness is difficult to image. Due to this, a reference meniscus underneath the build window is useful to visualize the presence of the resin layer underneath the FEP film. As an example, the resin layer can be visualized by positioning an object on the edge of the interface to create a visible meniscus in the resin layer.

FIG. 13BG displays this meniscus through the positioning of a warped cantilever within the experimental FISP system. Specifically, FIG. 13G shows a diagram and image of the thin resin film underneath the FEP film within the fluid interface, displaying the presence of the resin layer through a meniscus formed atop a warped cantilever beam. It is noted that the warped, cured resin beam shown in this image remained curved outside of the FISP system as well, with no fluid interactions, indicating that the part's curvature was due to internal stresses within the beam. This printed part was for visualization purposes, whose meniscus forms due to a relatively low interfacial surface tension between the cured and uncured resin.

The resin layer was practically invisible when underneath the film, displaying minimal layer thickness while covering the surface of the build window. The spreading of the resin layer underneath the build window was observed to be incredibly rapid (less than five seconds), reaching a state of pseudo-equilibrium in a timeframe similar to that of a droplet in a solid-liquid-vapor interface rather than the liquid-liquid-vapor interface investigated previously. This more closely reflected a wetting case in which n=1/10 rather than n=1/7 in Equation 4, indicating the capillary and surface tension forces become more predominant. This rapid wetting speed and resulting thin layer thickness significantly motivated the permanent inclusion of the build window within the experimental fabrication within the FISP system.

The difference in magnitude of the interfacial surface tension between the resin and the saline solution on the FEP film can be further validated through contact angle tests. The smaller the contact angle, the lower the relative solid-liquid interfacial surface tension and the higher the surface spreading. The same ramé-hart Contact Angle Goniometer/Tensiometer used previously is utilized. FIG. 13H displays the contact angle tests conducted for Saline, HDDA, and EHA on the FEP film. Specifically, FIG. 13H shows the contact angles between selected liquid/solid interfaces, displaying increased surface spreading for EHA on the FEP interface.

The results of the contact angle experiments displayed a reflection of the expected wetting behavior between the different fluids on the FEP film surface. For a reduction in the interfacial energy for the fluid components, an increase in the resulting spreading behavior was observed. This was notably observed for EHA on the surface of the FEP film.

This outlined the resulting spreading behavior of a liquid-liquid-solid interface, which was helpful characterize the influence of the FEP film within the system. The prediction of the resulting thickness became increasingly difficult to model due to the complex pressures acting on the system with the addition of a constraining top surface. The height of the FEP film relative to the top surface of the fluid was variable, leading to a dynamic pressure gradient that affected the thickness underneath the film.

### Influence of Pressure on Resin Layer Thickness

In surface wetting for a free surface, there may be a balance between the hydrostatic pressure and the pressure due to surface tension disjoining and slip pressure. Therefore, to predict the equilibrium state of a solid-liquid-liquid interface, one may have take into account the effects of surface tension, intermolecular interactions, and hydrostatic pressure. An increase in the fluid level around the build window introduced a head pressure, Pₕ, that competed with the work of spreading to determine the resin layer thickness Lᵣₑₛ. This pressure head level was denoted by ψ, the distance from the bottom of the build window to the exposed air boundary, Aₛᵤᵣ. FIG. 13I displays these relevant parameters and a diagram of the hydrostatic head pressure acting within the system. Specifically, FIG. 13I shows a diagram of resin layer thickness affected by head pressure in surrounding fluid due to the static pressure head.

At its most simple, the change in volume of a resin during polymerization was inversely equivalent to the change in density of the resin. To illustrate this, when MMA polymerized into PMMA, the density increased from 0.94 g/cm³ to 1.18 g/cm³. Conservation of mass dictated the density increase, β, of 25% should correspond to a 25% volumetric decrease during polymerization. Given the negligible density difference between the cured resin (ρᵣₑₛ) and the support fluid (ρₛᵤₚ), the pressure due to the displacement of the support fluid (ΔPₕ) may be negated by the reduction of resin volume (Vᵣₑₛ) in the system. This is displayed in Equations 12-14.

$$Δ {P}_{h} = ( Δ {V}_{sup} {ρ}_{sup} - Δ {V}_{res} {ρ}_{res} ) \frac{g}{{A}_{sur}} \qquad ( 12 )$$

$$Δ {V}_{res} = ( 1 + β ) Δ {V}_{cure} = ( 1 + β ) Δ {V}_{sup} \qquad ( 13 )$$

$$( 1 + β ) {ρ}_{res} = {ρ}_{cure} = {ρ}_{sup} \qquad ( 14 )$$

This equivalency enabled the assumption of negligibility of variation of head pressure in the system from the crosslinking resin when no additional resin is added to the system. This assumption was valid for small-scale tests, where the volume of the manufactured parts was a fraction of the total resin layer present and when the build window was planar with the fluid surface. When the additional resin was added, when the build plate was submerged, or the FEP film holder (build window) was submerged below the fluid surface, additional head pressure was present in the system. Aₛᵤᵣ was equal to 0.0016 m² for a 250 ml beaker and 0.0035 m² for a 500 ml beaker. The change in the fluid head height can be found as a ratio of the exposed fluid area to that of the object submerged within the fluid layer, as shown in Equation 15. The change in head pressure was, correspondingly, the change in head height multiplied by the density of the additional liquid and gravity.

$$Δ ψ = \frac{{A}_{object}}{{A}_{sur}} \qquad ( 15 )$$

$$Δ P = Δ ψ {ρ}_{sup} g \qquad ( 18 )$$

To conserve fluid, the 250 ml beaker was utilized during experimentation. A larger build area or beaker, however, would decrease the change in head height from the submergence of various objects. The height of the head, V), and the change in head pressure are tabulated for the three factors that change the fluid level height while printing in the FISP system. Table 3 displays these results where each millimeter that the build window or build platform is submerged, a corresponding increase in the fluid height will occur (Alp). Additionally, when additional resin was deposited under the perfect wetting conditions on the surface of the fluid, the head height will increase on the surface of the fluid according to the ratio Vᵣₑₛ/Aₛᵤₚ.

TABLE 3
Head pressure variation on the resin layer from the system dynamics

| | A_{object} (m²) | Δψ (mm) | ΔPₕ (N/m²) |
|---|---|---|---|
| Build Window Submergence/mm | 1.78e−03 | 0.527 | 5.92 |
| Build Platform Submergence/mm | 2.54e−05 | 0.016 | 0.18 |
| Per 100 ul Resin Added | 1.59e−03 | 0.063 | 0.66 |

The build window was observed to have the largest influence on the head pressure to the resin layer, displacing the largest volume of fluid, outlining the necessity of maintaining planarity with the fluid surface. The table indicated a relationship between the volume of resin supplied for printed geometry and the increase in head pressure, with the fabrication and resin resupply displacing approximately the same liquid volume as the build window submerged for 1 mm. Similarly, the influence on head pressure from the submergence of the build platform is minimal, given the small cross-sectional area of the part.

The uncured resin thickness was found to be minimal underneath the build window due to the energy favorability of the droplet interface. The resulting droplet has been observed to form a thin film underneath the build window, covering the entirety of the desired projection area.

### Process Parameter and UV System Characterization

The study explored desired system characteristics, evaluate alternatives, and explore important system design variables. The study also focused on the design considerations necessary to achieve the desired specifications of the critical dependent variables. Alternative evaluation and design development of several subsystems to achieve the desired system requirements were outlined herein, with the masking, optical, and build window subsystems. Additional factors affecting polymerization variables are identified, and their relationships are characterized.

### Polymerization Parameters

To understand the effects of the variables acting upon the system, an investigation into polymerization kinetics relevant to the FISP system was performed. When undergoing photopolymerization, the degree of curing of the resin layer can be a factor when determining the behavior of the beam. The basic polymerization model presented by Jacob (see P. F. Jacobs, “Fundamentals of Stereolithography,” presented at the International Solid Freeform Fabrication Symposium, 1992. [Online]. Available: https://dx.doi.org/10.15781/t24m9lt5h) predicts the polymerization cure depth in stereolithography (C_{d}). According to Beer Lambert's law of absorption, the exposure (mJ/cm²) can decrease exponentially with depth, as outlined in Equation 17. This is fundamental to Jacob's working curve, where the maximum C_{d} of a UV radiant exposure on a resin surface is defined as a function of the maximum UV exposure Eₘₐₓ, the energy of activation E_{c}, and the depth of penetration Dₚ, as outlined in Equation 18.

$$E ( z ) = {E}_{m a x} {e}^{- \frac{z}{{D}_{p}}} \qquad ( 17 )$$

$${C}_{d} = {D}_{p} ln ( \frac{{E}_{m a x}}{{E}_{c}} ) \qquad ( 18 )$$

In this model, C_{d} should scale as the natural logarithm of the maximum light exposure. A semi-logarithmic plot of cure depth vs. In Eₘₐₓ (W/m²) should result in a straight-line relationship, known as the working curve. In this case, Eₘₐₓ=(Pt/A)ϕ, where the subscript ϕ denotes variables related to the UV exposure, P is the UV power (W), A is the incident area (m²), and t is the time of exposure (s). The slope of this line is equivalent to the penetration depth, Dₚ, and the intercept is the critical exposure of the resin at the optical wavelength. A MATLAB program was made to process the experimental results based on their input parameters and resulting C_{d} to output the critical exposure energy and depth of penetration. This program can take a large input array of input cure depths and times to output the resulting fits and fit data. Identifying E_{c} and Dₚ with the straight line relationship, a fitted curve of C_{d} vs. time can be created, as displayed in FIG. 13J. Specifically, FIG. 13J shows the working curve linear fit for a 1% PI, 5% EHA sample (left) to obtain E_{c} and Dₚ to estimate C_{d} (right).

Using the fitted curve, the critical exposure energy, E_{C} obtained is equal to 14.743 J/m², and the depth of penetration is 0.644 mm. The advantage of fitting experimental data to a curve like this is the ability to predict the resin curing behavior and tune the process parameters to achieve the desired cure depth.

Equations 17 and 18 describe the photopolymerization fundamentals and provide an outline of the critical process parameters fundamental to the cure depth. These comprise Eₘₐₓ and include the UV light power (Pϕ), the UV light exposure time (tϕ), and the exposure area (Aϕ). These process parameters will be classified into a subgroup of independent variables that can be adjusted for the experimental printing process.

The curing of a single layer within a masked stereolithographic system is known to be dependent on the oxygen inhibition and light absorbance within the resin. If oxygen is present on the surface on the surface of the resin layer, it will inhibit polymerization (see P. Kunwar, Z. Xiong, S. T. McLoughlin, and P. Soman, “Oxygen-Permeable Films for Continuous Additive, Subtractive, and Hybrid Additive/Subtractive Manufacturing,” (in eng), 3D printing and additive manufacturing no. 2329-7670 2020 2020). From Beer Lambert's law of absorption, the intensity of the UV light will decrease as it travels through the resin layer. These two factors are estimated to lead to a partially cured polymer gradient during the dynamic crosslinking process near the top and the bottom of the resin layer. FIG. 13K shows the polymerization gradient in a discrete layer in the FISP system. Specifically, FIG. 13K displays this curing gradient and shows the estimation that the fully cured polymer will exist in the z-axis in the zone in which the oxygen inhibition is low enough and the UV exposure is high enough to fully crosslink the resin into a cured polymer.

It is estimated that the relative location of the fully cured polymer zone within the resin layer influences the part warping behavior of the part. The upwards warping of parts forms the absorbance gradient in thin cantilever beams (see D. Xie, F. Lv, H. Liang, L. Shen, Z. Tian, J. Zhao, Y. Song, and C. Shuai, “Towards a comprehensive understanding of distortion in additive manufacturing based on an assumption of constraining force,” Virtual and Physical Prototyping, vol. 16, no. sup1, pp. S85-S97, 2021 Sept. 8 2021) has been previously observed, with a higher degree of crosslinking occurring at the area of the first light incidence. Additionally, inhomogeneity within the light exposure leads to part warping behavior. Adjusting the power and time of the UV-light exposure shifts this polymerization gradient, and balancing this against the free radical oxygen inhibition zone is desired to minimize solidified part warping. Additionally, residual oxygen can stay in the resin, even if the build window has a low oxygen diffusion rate. Due to this, an optical system developed for the FISP system must be able to precisely control the critical parameters of exposure time, energy, and incident area.

### Optical System Design

To create printed structures, SLA 3D printers use UV light projected in a specific shape which defines a cross-section of the part at that Z height. The accuracy and uniformity of this light to the image, dimensionally and geometrically, determines the dimensional accuracy and cured material uniformity. In the FISP system, understanding and optimizing the light behavior and projected shape help ensure the legitimacy of other tests and achieve the most accurate and isometric prints. In photopolymer additive manufacturing systems, the primary methods of light projection are either laser scanning or masked projection. Laser scanning is the method of directing a concentrated ultraviolet source onto the point of desired cure geometry, and rapidly scanning this point across each layer. The most common masked projection system is Digital Light Projection (DLP) (see X. Wu, C. Xu, and Z. Zhang, “Flexible film separation analysis of LCD based mask stereolithography,” Journal of Materials Processing Technology, vol. 288, p. 116916, 2021/02/01/2021), which utilized a photon source to illuminate an entire layer at a time. This may be done by masking through a digital micromirror device (DMD) or by projecting from a source of thousands of micrometer-sized LEDs. A basic system to demonstrate the feasibility of the FISP system was desired, while having minimal engineering lead time and cost. A version of DLP was implemented, whereas the part geometry would be defined by the light passing through a prefabricated mask. This system gave the ability to project simple shapes through the mask geometry and onto the curing resin layer. Desirable qualities of a light source for a static masked projection system included an adjustable luminous intensity range, homogenous projection, light wavelength of 365 nm, a method of controlling the exposure time, light collimation, and a method of control via a computer.

### Masked Projection

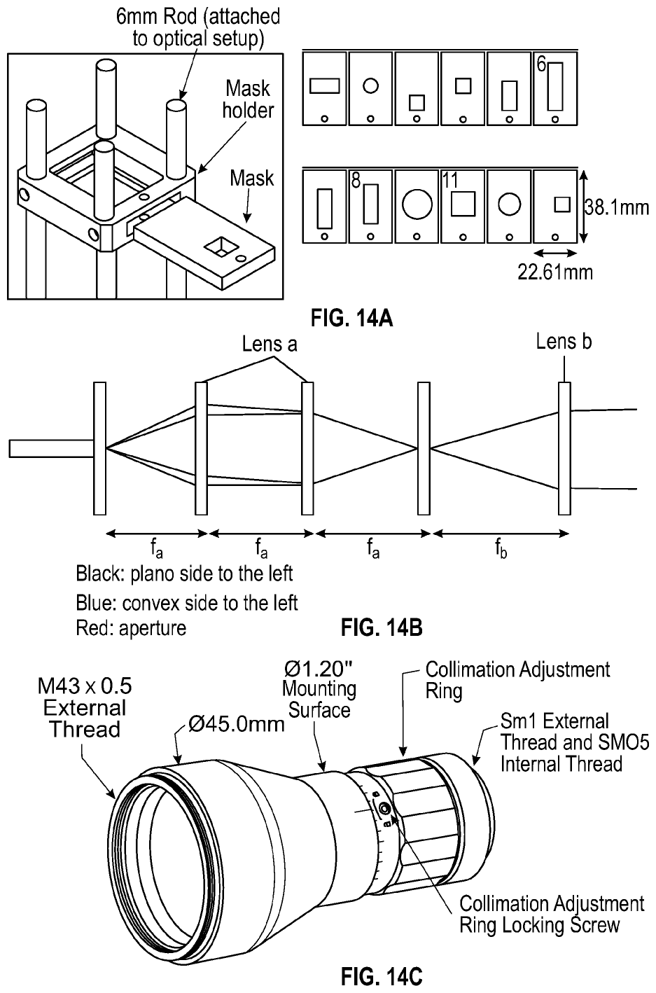

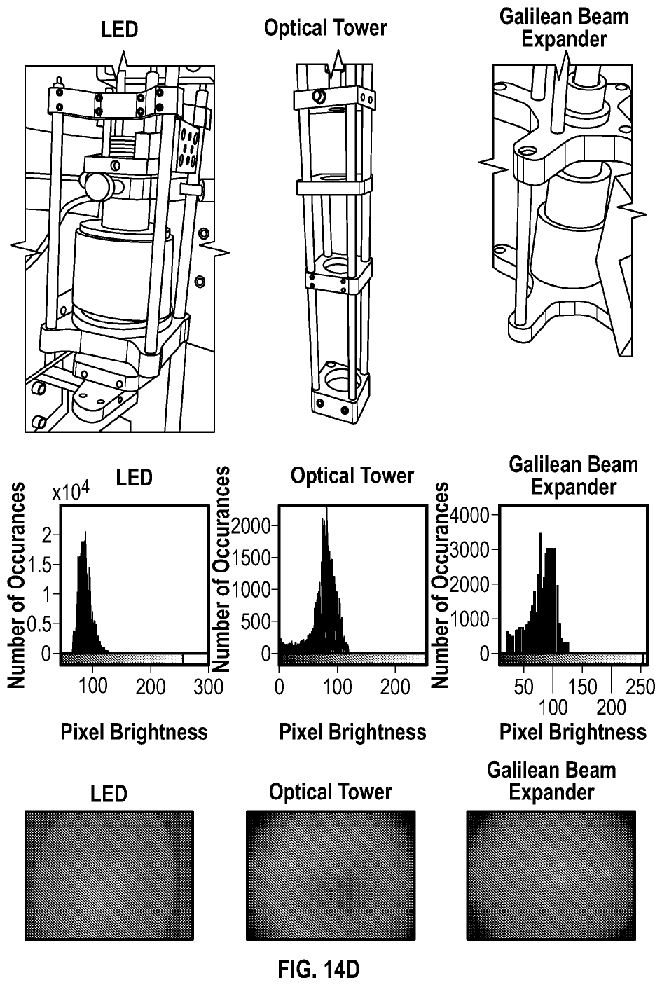

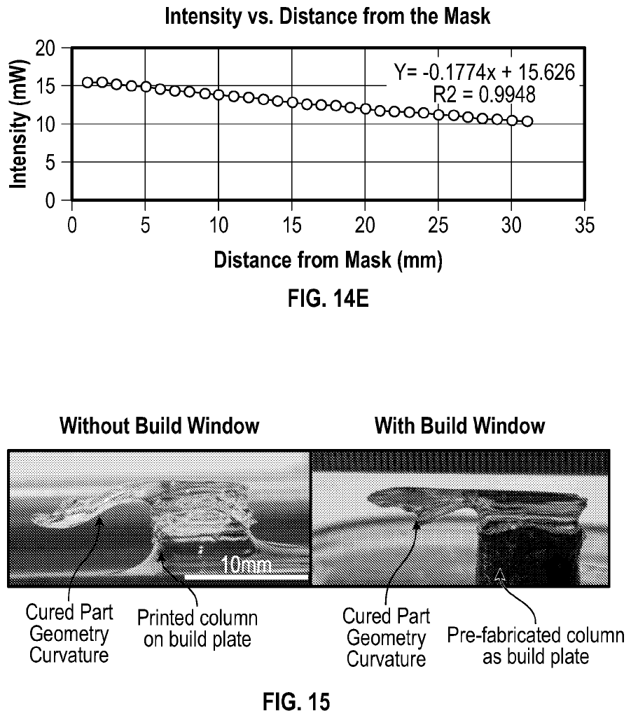

To control the shape of the projected UV light during experimentation a mask holder system was developed to control the quality of the print edges and ensure experimental repeatability. The system was designed to have a variety of easily interchangeable mask geometries in consistent locations. The mask holder was designed to be compatible with ThorLabs hardware, the primary set of hardware available and used within the research. FIG. 34 shows the mask holder CAD and mask geometry. Specifically, FIG. 14A displays the mask variations enabling the fabrication of various cantilever geometries and simple shapes desired for experimentation.

The mask holder was made to fit onto the existing four 6 mm rods on the optical setup underneath any lens used for curing. Mask geometry was created in standard shapes that would be moved parallel to the resin surface between layers to create 3-dimensional shapes. The rectangular mask geometry was used for cantilever cure tests to evaluate the effectiveness of the supporting solution in minimizing sacrificial support structures. Mask 11 input geometry was 12.57 mm×12.63 mm, mask 8 input geometry is 20.09 mm×7.61 mm, and mask 6 input geometry was 25.23 mm×7.67 mm. These masks were chosen because they offered large, rectangular shapes that would produce the large overhanging geometry desired. Mask 11 enabled the analysis of overhangs in every direction, while mask 8 provided a projection of a large, single cantilever area. Mask 6 was used periodically to test the limits of the system but not extensively enough to generate useful data. Mounting the mask holder was the same as mounting a lens, as there are set screws in the side of the mask holder for attaching to the rods. The mask was made to slide in and out of the mask holder and requires no fasteners to hold it in place. The mask holder was produced with PLA in an FDM printer, and the masks were laser cut from a minimally reflective, UV-resistant acrylic.

### Optical System Alternative Evaluation

The desired properties of an optical system outlined in Example 1 included a homogeneous projection of light within a 365 nm wavelength to activate the monomer crosslinking. All measurements of the UV light exposure were conducted via a ThorLabs energy power meter, which outputed the irradiance reading with the incident area of 7.1*10⁻⁵ taken into consideration, outputting power. The design of the system may enable the variation of exposure time and power. The first optical source evaluated was the Thorlabs M365L2-C1, a prefabricated collimated LED light source at 365 nm wavelength. The light source had an adjustable power range of approximately ±2.5 mW, and the collimated beam ensured that the projection retained the mask geometry after projection onto the build area. However, the system had low maximum output of the beam being 3.5 ×10⁻⁷ W/m² or about 6 mW limited the utilization of a 365 nm filter or experimenting with faster cure times. The collimating beam also displayed an area of higher intensity in the center of the projection. The LED source also lacked a way to natively control the time of exposure or interface with a computer control system.

A custom optical system was developed by interfacing with an ADAC Systems Dymax Cure Spot 50. The Cure Spot provided much more power than the LED system and had an integrated exposure timing control system that can be utilized. Collimating the beam from the optical cable ensured that the masked projection would perform as desired. The divergence angle of the optical cable was experimentally determined to be 51.1° by projecting the source to surfaces at surfaces set at various distances and measuring the resulting light diameter. In an idealized system, light wa collimated from an infinitesimally small source exactly one focal length away from an optical system with a positive focal length. In a real system, the divergence was approximately equal to the size of the source divided by the focal length of the collimating system. To characterize existing lenses, the following methodology may be utilized: the lens was placed under a large light source such that the lens-source separation distance was far above the predicted focal length, the lens-source distance was then be adjusted until the projected image has its highest clarity. Measurements between the lens, source, and image were taken and applied to Equation 19 (see R. Nave, HyperPhysics, Atlanta, Ga.: Georgia State University Department of Physics Astronomy, 2000. [Online]. Available: http://hyperphysics.phy-astr.gsu.edu/hphys.html), where f, o, and I represent the focal length, lens-source distance, and lens-image distance, respectively.

$$\frac{1}{f} = \frac{1}{o} + \frac{1}{i} \qquad ( 19 )$$

Using this principle, the system outlined in FIG. 14B was developed. Specifically, FIG. 14B shows the tower optical system diagram.

Two identical lenses (lens a) were utilized with focal length fₐ. The first lens collimated light with some divergence and the second lens focuses light at the aperture. The aperture then reduced the spread of light, and the last lens reverses the conditioning from the second lens. This light collimation setup resulted in 50 mW power without a filter and 10 mW power with a 365 nm filter, which provided the desired intensity bounds for experimentation. To check for the collimation's validity, diameters of the projected light were measured at different distances from the optical setup, resulting in a beam angle of approximately 4°. The tower optical system remedied the issues of light projection timing and enabled a larger variation of intensity, but ultimately, the system proved ineffective in retaining the mask geometry input onto the projected surface for predictable polymerization. Substantial tweaking and revision of the system did not remedy this issue, so another optical system is investigated.

The final optical system evaluated is the ThorLabs GBE03-A Galilean beam expander, shown in FIG. 14C, with an input from the Cure Spot optical cable. To determine collimation degree of the light, experiments were performed to determine the beam angle. By keeping the collimation ring adjustment constant and varying the distance of the projection from 0 to 254 mm, the beam angle could be found by measuring the projection's resulting change of diameter. The resulting beam angle was found to be −0.34°±0.98°, indicating a low degree of variance between the trials and a suitable setup for the experimentation. This beam angle varies depending on the degree to which the beam expander's collimation ring was adjusted. Experiments showed that adjusting the collimation knob allows the user to change the beam angle by approximately ±2.5°, which resulted in an intensity change of approximately ±2.5 mW. The affect of the resulting intensity change from the collimation knob on the curing system was more significant on the polymerization output than the beam angle, so the knob primarily was primarily used to adjust the intensity of the projected light in experiments. This enabled the variation of UV exposure power, but it created a variation in the collimation degree and beams angle, a systematic variable disvaluing the direct comparison of different intensities for polymerization output.

The homogeneity of the projected UV light from each of the optical systems was characterized by photographing the light projections with a Basler Aca2500-14 gm UV camera. Standard white printer paper fluoresces in the presence of UV light (see L. Coppel, “Whiteness and Fluorescence in Layered Paper and Board—Perception and Optical Modelling” Ph.D. Dissertation, Applied Science and Design, Mid Sweden University, 138, 2012) was used to reflect the light projections into the lens of the UV camera. The paper was angled” at approximately 45° (not pictured) from the optical sources to reflect the image into the camera lens. The homogeneity of the light projections was then compared and evaluated, as shown in FIG. 14D. Specifically, FIG. 14D shows the evaluation of the three optical sources based on their light homogeneity.

The figure displays a picture of each of the optical systems described previously in row 1. The images captured by the UV camera were processed in MATLAB to approximately match the distribution of pixel brightness for easier comparison between the systems. The resulting pixel brightness value histograms and images are displayed in rows 2 and 3, respectively. A perfectly homogenous light source would create a histogram with two-pixel brightness bins that are far more frequent than any other, one of the uniform brightness of the projection at a constant and one of the darker backgrounds. Homogeneity of the light source would be desirable to minimize non-uniform curing within printed parts that lead to internal stresses. The LED light source displayed the least Gaussian distribution of brightness, which would be desirable. However, the square shape of the LED source can be seen as a brighter cluster in the middle of the projection. This may create an area of concentrated exposure within the projection, potentially creating zones of non-homogenous crosslinking. The optical tower displayed the most gaussian distribution of light of the systems, indicating little homogeneity of the light source. It also displays a dark region in the center of the projection surrounded by a brighter ring. This result may most likely be due to the optical system displaying focal, non-collimating behavior, reflecting the difficulty of cleaning, controlling the location of, and selecting the large number of lenses in the system. The Galilean light expander also displayed a Gaussian-shaped distribution but retained a narrower band than the optical tower with a single bin that displays significantly higher frequency than its neighbors. The image of the Galilean beam expander's projection also displayed a variation in pixel brightness, indicating imperfect homogeneity.

None of the light projection methods have an ideal combination of exposure time and intensity control with perfect collimation and light homogeneity. In an ideal projection system, the timing control and uncertainty are zero, the projection power is maximized whilst having a maximum control range, and the homogeneity or pixel brightness variance is zero. To evaluate the alternative's ability to achieve these characteristics, a weighted evaluation matrix on the design criteria was performed and displayed in Table 4.

TABLE 4
Weighted evaluation matrix for the optical system selection

| | | | | | | | Galilean | |
|---|---|---|---|---|---|---|---|---|
| | | | | | Optical | | Beam | |
| | Desired | Weight | LED | | Tower | | Expander | |
| Time to Toggle | Min | −0.5 | ~0.5 s | | 0.015 s | | 0.015 s | |
| UV Exposure | | | (Manual) | | (Electronic) | | (Electronic) | |
| Max Power at | Max | 0.15 | 6.5 | mW | 50 | mW | 15.5 | mW |
| 365 nm | | | | | | | | |
| Variance of Pixel | Min | −0.025 | 117.8 | px\hat{ }2 | 371.0 | px\hat{ }2 | 124.3 | px\hat{ }2 |

| Brightness | | | | | | |
|---|---|---|---|---|---|---|
| Native Power | Max | 0.25 | 6 mW | 0 | mW | 6 mW |

| | | | |
|---|---|---|---|
| Control Range | (0.5-−6.5) | | (9.5-−15.5) |
| Resulting Score | −1.5 | −1.8 | 0.7 |

The table displays relative weighting scores for each of the three alternatives based on the discussion in this section and acts as a useful summary of the results. The Galilean Beam Expander was the chosen alternative between the systems due to its relative achievement between the desired system characteristics. While I may have imperfect homogeneity, its influence was determined to be minimized in the system.

By detecting the power of the beam expander at different distances, a linear regression can be fit to find the loss in intensity due to distance, as shown in FIG. 14E. Specifically, FIG. 14E shows the intensity change associated with an increase in distance.

The experimental results demonstrated a decrease of 0.177 mW for every additional millimeter that the incident area is from the Galilean optical setup, which was used as a calibration for future experiments and an additional way to control exposure power.

### Build Window Determination

Top-down photopolymerization fabrication systems do not require a build window for part fabrication. Preliminary print testing with the FISP system was conducted this way but overhangs continuously displayed distortion during polymerization. The addition of a build window or thin film over the resin layer significantly reduced cured part geometry curvature due to internal stresses and resin thickness variations, as shown in FIG. 15.

This is reasoned to be a result of the build window providing a surface for polymerizing resin to adhere to, functioning similarly to traditional sacrificial support structures in part fabrication. This adhesion was not chemical, enabling the removal of part geometry without necessitating fracturing of the part. This motivated the permanent inclusion of a build window into the experimental fabrication system.

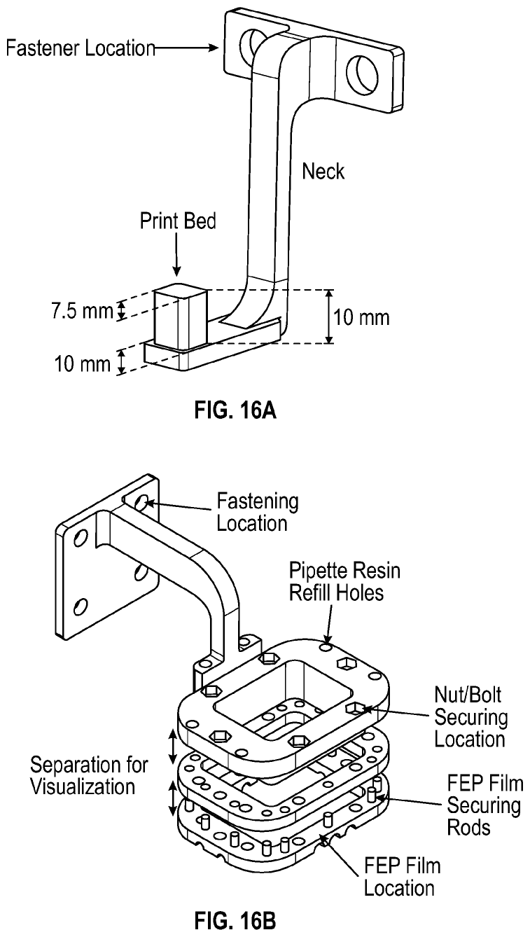

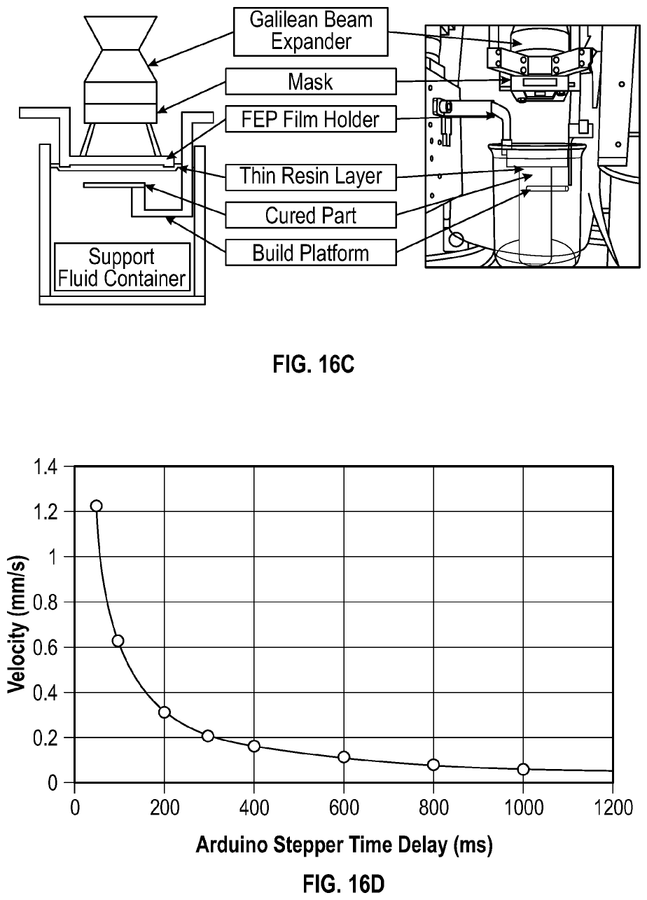

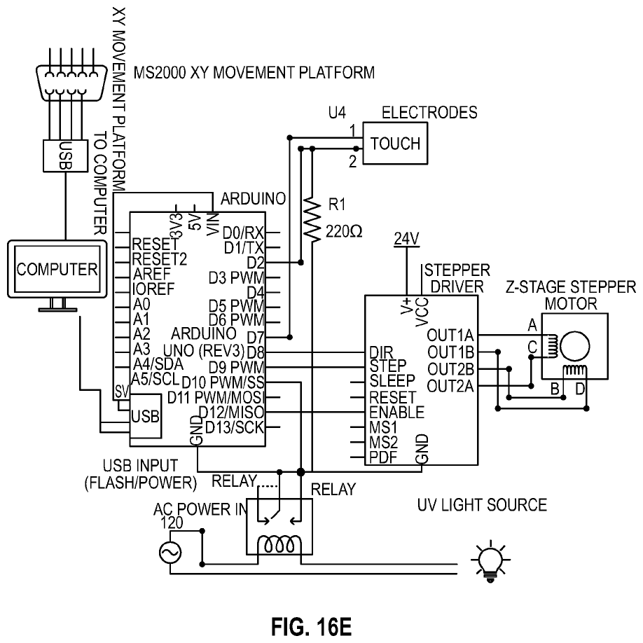

Cantilever beam printing required a raised portion of the build plate, in the form of a column, in order to isolate the polymerizing beam. Rather than polymerizing a column for each cantilever beam overhang test, a modified build plate was developed. FIG. 15A displays these two build plates and the raised columns, with a polymerized column on the left and a prefabricated column on the right. The build plate was connected to the translating Z-stage through a long neck. This additional height allowed for the print bed to be fastened to a stage outside of the fluid container in the FISP system, which was translated vertically to adjust the location of polymerization in the Z-axis. FIG. 16A displays an image of the build plate as the print bed used in the FISP system.

Oxygen Inhibition and Build Window Evaluation The Continuous Liquid Interface Production (CLIP) system, used an oxygen-permeable film to achieve continuous printing with a high surface resolution in an advanced form of traditional SLA-style printing (see J. R. Tumbleston, D. Shirvanyants, N. Ermoshkin, R. Janusziewicz, A. R. Johnson, D. L. Kelly, K. Chen, R. Pinschmidt, J. P. Rolland, A. V. Ermoshkin, E. T. Samulski, and J. M. DeSimone, “Continuous liquid interface production of 3D objects,” Science, vol. 347, pp. 1349-1352, 2015). An essential aspect of the CLIP system is the Teflon AF 2400 oxygen-permeable film, in which the film's passive control of oxygen flow created a small dead zone in the resin layer. Commercially available and fabricable oxygen permeable films were evaluated for use in the FISP system by comparing their cost, availability, oxygen diffusion rate, and their transmittance of UV light in the excitation range for the photoinitiator.

A build window material with existing literature relevant to stereolithography was desired. A team of researchers from Syracuse University has recently developed an alternative to Teflon AF 2400 film in the form of a polydimethylsiloxane (PDMS). Compared to Teflon AF 2400 film, the PDMS had equal or greater transmittance and oxygen diffusion while costing substantially less. It can be fabricated from the Sylgard 184 silicone elastomer kit with a PDMS-curing agent ratio of 10:1, following a molding and heating process. Given the limited access to the sort of equipment necessary to fabricate a custom film, a widely used build window alternative was desired. Fluorinated Ethylene Propylene (FEP) films have been widely used in stereolithography, due to their low surface energy. However, it has been stated to have a much lower oxygen diffusion rate and, therefore, oxygen inhibition characteristics than PDMS, making continuous part manufacturing unfeasible. (see J. Wu, J. Guo, C. Linghu, Y. Lu, J. Song, T. Xie, and Q. Zhao, “Rapid digital light 3D printing enabled by a soft and deformable hydrogel separation interface,” Nature Communications, vol. 12, no. 6070, 2021). This can be due to the bodies of literature indicating that the oxygen diffusivity of FEP is around one hundred times smaller than equivalent PDMS films, with a diffusion coefficient for FEP around 1.7*10⁻⁷ cm²/s (see D. J. Tarnowski, E. J. Bekos, and C. Korzeniewski, “Oxygen Transport Characteristics of Refunctionalized Fluoropolymeric Membranes and Their Application in the Design of Biosensors Based upon the Clark-Type Oxygen Probe,” Analytical Chemistry, vol. 67, no. 9, pp. 1546-1552, 1995 May 1, 1995) and that of PDMS being in the order of magnitude of 2.5−9*10⁻⁵ cm²/s (see D. A. Markov, E. M. Lillie, S. P. Garbett, and L. J. McCawley, “Variation in diffusion of gases through PDMS due to plasma surface treatment and storage conditions,” (in eng), Biomed Microdevices, vol. 16, no. 1, pp. 91-96, 2014; and S. Chowdhury, V. Bhethanabotla, and R. Sen, “Measurement of Oxygen Diffusivity and Permeability in Polymers Using Fluorescence Microscopy,” Microscopy and microanalysis: the official journal of Microscopy Society of America, Microbeam Analysis Society, Microscopical Society of Canada, vol. 16, pp. 725-34, Dec. 1, 2010). A continuous printing system due to oxygen inhibition was determined to be unnecessary in determining the feasibility of the FISP process and it was hypothesized that the diffusion coefficient of FEP would be sufficient to prevent chemical curing of the film for low-dose curing. Additionally, the transmittance of 355 nm wavelength light was cited to be 93.86% (see S. Chen, C. Huang, X. Jiang, X. Luo, Y. Fang, and W. Wu, “The Transmittance, Transmittance Wavefront, and Laser Induced Damage Properties of Thin Fluoride Polymer Films May Be Used as Short Pulse Laser Debris Shields,” International Journal of Polymer Science, vol. 2016, p. 1367537, 2016 May 12 2016), making it a suitable candidate for UV-curing applications. As shown in FIG. 15, the presence of the film was observed to give the polymerizing resin something to adhere to, reducing deflection during polymerization. Although oxygen inhibition was not necessary nor conducted in study.

### Design of the Build Window

Similar geometric and dimensional accuracy to commercially available SLA 3D printing systems is desired, so retaining a relatively constant tension in the FEP film is needed to mitigate uncertainty due to the deflection of the FEP film surface. The FEP film tensioner is modeled to reflect the design of a commercial FEP film tensioner, the Anycubic Photon FEP film (see “Anycubic Photon FEP Film: How to buy & replace it.” https://all3dp.com/2/anycubic-fep-film-photon-zero-3d-printing/(accessed Nov. 18, 2020)). FIG. 16B displays the design of the FEP film tensioner used within the FISP system.

The FEP film tensioner underwent numerous revisions in the researcher's experimentation. The first revision necessary was ensuring that the build area in contact with the resin was below the retaining walls and the retaining walls had ports for resin and air to be evacuated from the system. If the film's surface is constrained by surrounding walls, without a means for fluid and air to escape, a zone of increased pressure is present under the film, and resin cannot resupply the surface layer after a layer is printed. An issue with the first iteration of the FEP film holder was the independent tensioning unit and arm, as the connection lowered the tensioner's tolerance to be parallel to the horizontal plane at the build surface. To remedy this, the tensioning unit and the arm were integrated together, and additional mounting holes were added to the rear of the tensioner. Additionally, researchers determined that the resin deposition method of inserting the pipette tip into the supporting solution between the tensioner and the beaker, extruding resin, and allowing it to float to the surface of the build area did not allow for precise resin deposition. Angled and drafted holes were designed to pierce through the height of the subsystem, so the deposition pipette tip is located at the resin layer interface. The FEP film was experimentally found to reduce the incident power of the UV light by around 2 mW.

The tension of the FEP film was found to be another variable in the system, influencing the adhesion between the cured resin and the FEP film. This mount utilizes multiple mounting screws that allow the user to pull the film taught over the bottom edge of the mount, allowing the user to tension the film to a wide degree of tautness and maintain it over a long period of time.

### Control System Integration and UI

FIG. 16C shows subsystem integration in the experimental FISP system. The integrated system includes the Galilean beam expander, mask holder, FEP Film, build platform, and support fluid container subsystems. This is the finalized geometry fabrication system utilized through the experimentation.

In the initial feasibility testing for the FISP system, all stage motions and masking operations were performed manually. All printing steps described below were subject to a larger degree of uncertainty due to this. The x, y, and z axes were controlled by Thorlabs single-axis translation stages and manually adjusted to the desired location. The UV light exposure time was measured with a stopwatch and managed with a potentiometer. To increase the efficiency of performing print tests and to mitigate experimental uncertainty, a comprehensive automation system for the system was developed.

The vertical, or z, location of the print bed was controlled by a 3D printed part that is attached to a Thorlabs single-axis translation stage with a standard micrometer. The translation stage had micron-level accuracy and is automated by attaching a belt between a stepper motor and the adjustment micrometer. By programming an Arduino microcontroller, the platform movement can be automated to a repeatable, specified location between layers. The steps required to move a desired distance were calculated using Equation 20, derived from a 16× microstepped Nemal7 motor and the micrometer stage specifications, and was implemented in the Arduino programming.

$$steps = {steps}_{per rev} \times ( belt ratio ) \times ( \frac{{Dist}_{desired}}{{Dist}_{per rev}} ) \qquad ( 20 )$$

The precision of the microstepping motor and the micrometer stage results in a theoretical precision of the Z-platform of 0.13 um per step when automated. The actual accuracy of the platform was likely lower due to mechanical limitations, but this precision was well within the design specifications for the Z-platform. The speed of the platform's movement depended on the step delay input in the code. The corresponding speed of the platform's movement in relation to the step delay would decrease exponentially due to the torque output of the motor. Quantifying this relationship enabled the design of very specific experiments that require pull off velocity for the experimental system in the future, including cohesion between the build window and the cured resin and the fluid drag of part removal. This relationship was derived as shown in FIG. 16D. Specifically, FIG. 16D shows the relationship between stepper delay and platform movement speed.

A step delay of 50 ms-1000 ms for the Z-platform resulted in a velocity of 1.22 mm/s -0.063 mm/s, following an exponential fit vz=−0.0071+51.57 t^{-O9556}. To lower the platform 3 mm, it can take 2.46s-47.52s. This provided a way to predict and tune the z-axis platform movement speed, which dictates the printing speed, and the magnitude of the build window adhesive and fluid inertia forces.

The lateral, or XY movement of the masked optical system that was once controlled with two linear translation stages was controlled through a MS-2000 DC servo control platform. The automated stage platform provided a precision greater than 1 um, and can be operated via a joystick or serial control. The UV optical projection system was mounted atop the automated stage, and translation of the stage enables shapes to be drawn atop the surface of the build area. If a 3-dimensional parallelogram was desired, a rectangular mask can be loaded, and the stage can be translated along one axis at a set distance between the cured layers.

The activation of the Cure Spot 50 for the tower and Galilean optical systems was done through a 12V, 1A electrical signal from a foot pedal. To trigger this signal in an automatic system, a high-voltage relay was implemented to allow for a 5V microcontroller signal to toggle the UV light. The user can choose whether to use the manual or automatic control of the Cure Spot through the foot pedal or through the relay, respectively, through the use of an aux cable splitter connecting both the triggers into the same circuit. Both were wired as normally open, so no light is emitted in the system without an input.

Lastly, a wiring system for a pair of electrodes and a second stepper motor was developed that checked for a closed circuit loop. Two wires from the Arduino were mounted to nodes attached to the build window. The beaker underneath the build area would be raised by a stepper motor until the electrode nodes touched the support solution and could close a circuit. Once the circuit was closed, the stepper motor would turned off, and the fluids would be set at the correct height relative to the build window. This system was developed and made functional to accurately locate the interface boundaries.

Each of these subsystems interacting together comprised the basis for the FISP control system. The activation of the UV source and the movement of the z-axis control stage can all be accomplished through the Arduino code alone, and this was sufficient for many experiments. The integration of a Z axis control system alongside the UV-light activation, enabled the creation of extruded 2-dimensional masked geometry, such as a column from a circular mask or an overhanging cantilever beam. In order to fabricate more complex parts, however, integration of the XY movement platform into the control system was performed. This was done through UART serial connection to a computer and commanding it from a MATLAB application. The wiring diagram for the integrated system was displayed in FIG. 16E.

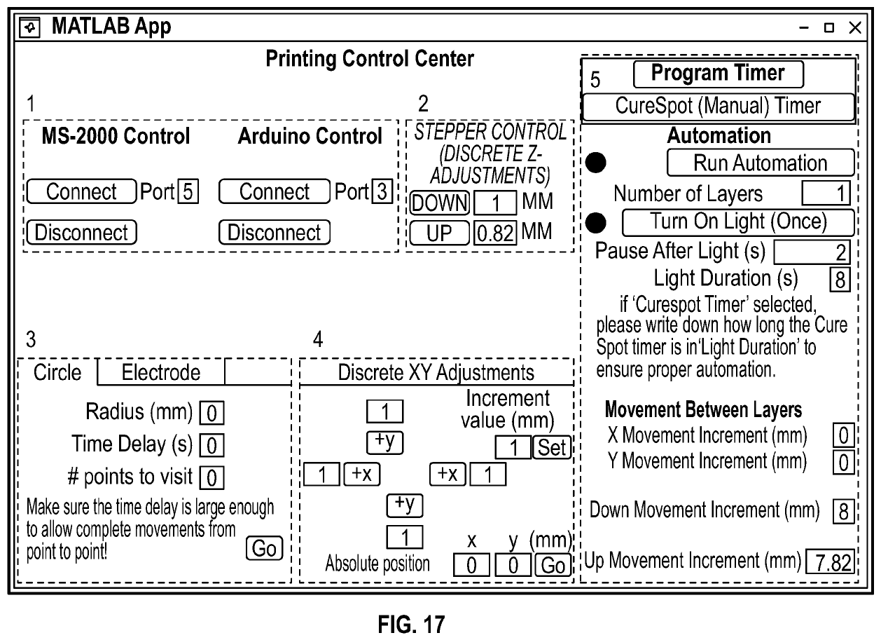

To integrate both Arduino code and the MS-2000 together in a central system, MATLAB app designer was used. This interface allowed for serial IO, as well as the ability to read/write the Arduino automation files. A graphical user interface (GUI) was built from scratch with all of the functionality desired. This interface was known as the printing control center and is outlined in FIG. 17.

The functions in zone 1 controlled the serial connection/disconnection of the computer to the Arduino Uno and the MS-2000. The inputs in zone 2 allowed for discrete relative adjustment of the print bed along the z axis in mm, calculated using Equation 20. Zone 3 had a function for circular movement of the XY stage, which allowed for the user to trace out a circular shape while the UV light is turned on. This is a preview of the possibilities for the geometries obtainable with the automation system, and shapes like these can be programmed into the automation cycle with ease in the future. Zone 4 translated the MS-2000 XY platform relative to its current position in defined increments via adjusting and pressing the ±x or ±y buttons. The platform moved to an absolute x-y position relative to the platform's zero via the row of inputs in the bottom of the zone. Zone 5 contained the user inputs for the automation control system. The buttons at the top of this area determined whether the program would send a pulse through the relay to activate the light's timer (Cure Spot Timer), or if the program would hold open the relay (program timer) to the Cure Spot for the time set by “Light Duration(s).” The “Pause After Light (s)” value allowed the user to wait for a dark reaction to occur while the cured layer was still attached to the build window and allowed the system to settle before moving the print bed. The distance moved between layers in the x, y, and z directions were inputted in the bottom of zone 5. Once the parameters was set, the user pressed “Run Automation” and the program conducted and automated the curing process for the number of layers inputted to the system.

TABLE 5
Desired Control System Specifications

| | Desired | Achieved | |
|---|---|---|---|
| Build Volume | ≥20 × 10 × 20 | 36 × 26 × 30 | mm |
| XY-Plane Control Resolution | ≤200 | ≤5 | μm |
| XY-Projection Resolution | ≤4 | ≤4 | mm |
| Z-Axis Resolution | ≤10 | 0.13 | μm |
| Z-Axis Velocity | 0.02-2 | 0.063-1.22 | mm/s |
| UV Wavelength | 350-365 | 350-365 | nm |
| UV Light Toggle Response | ≤1 | 0.015 | s |
| UV Light Power | 1.5-150 | 10-15.5 | mW |
| Printing Speed | ≥20 | 7-47 | mm/h |

Table 5 displays the control system specifications of the FISP system. It is clear that the implemented design for the FISP system met and exceeded the desired specifications set forth in the study. The control system enabled complex geometry to be created with low uncertainty and lead time. With this system, a repeatable and reliable experimental procedure for evaluating the effectiveness of the FISP system can be developed and studied.

### Systematic and Random Variable Identification

Throughout the FISP system's development and experimental validation, it has been observed that systematic variable inputs affected the resin's polymerization reaction. Characteristics such as the UV light beam angle, the light source homogeneity, the light's intrinsic wavelength spectrum, and the presence of a UV-filter alter polymerization similarly alter the polymerization behaviour. The light intensity may change depending on how far the light source is away from the curing interface. Even though the same power at 365 nm was recorded with the ThorLabs Handheld Optical Power and Energy Meter, the overall intensity from the optical source at all wavelengths was not characterized or adjusted for during polymerization testing. These systematic variables propagated variation between polymerization when unaccounted for due to their effects on the free-radical propagation during curing kinetics.

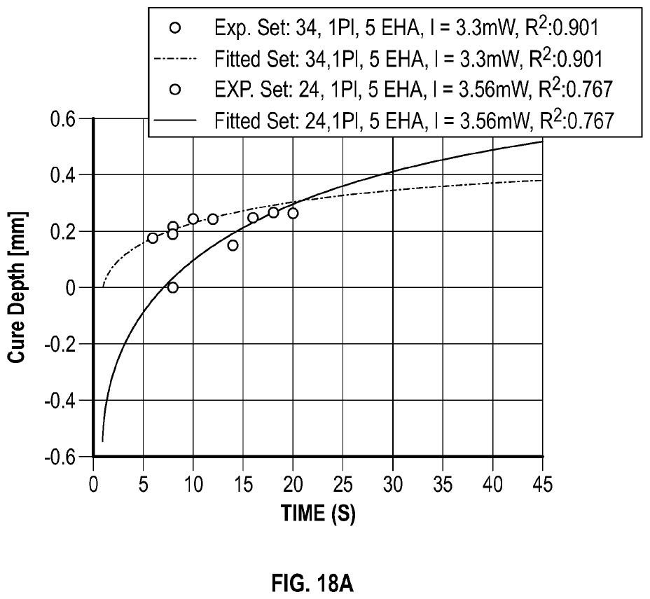

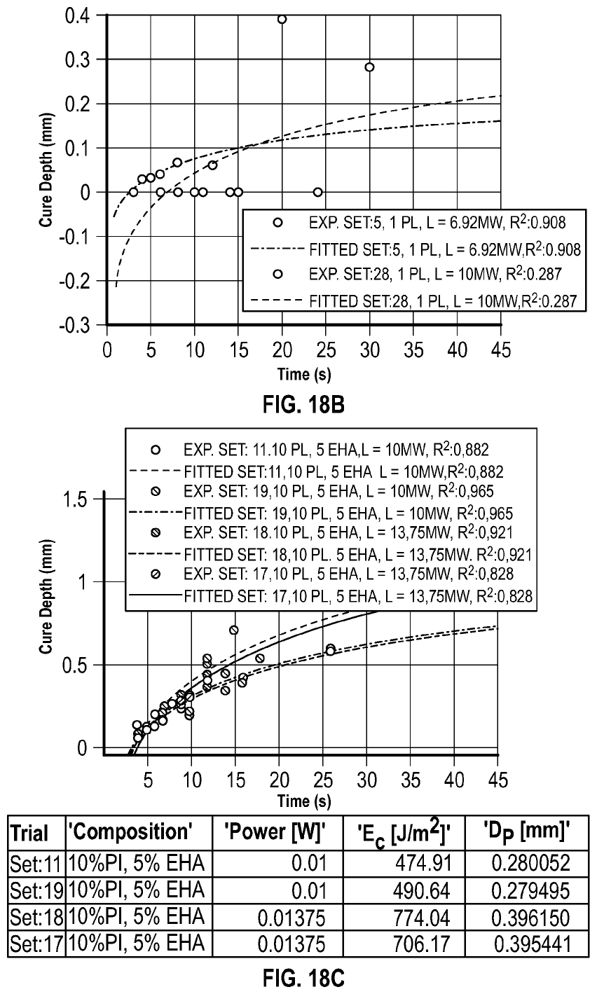

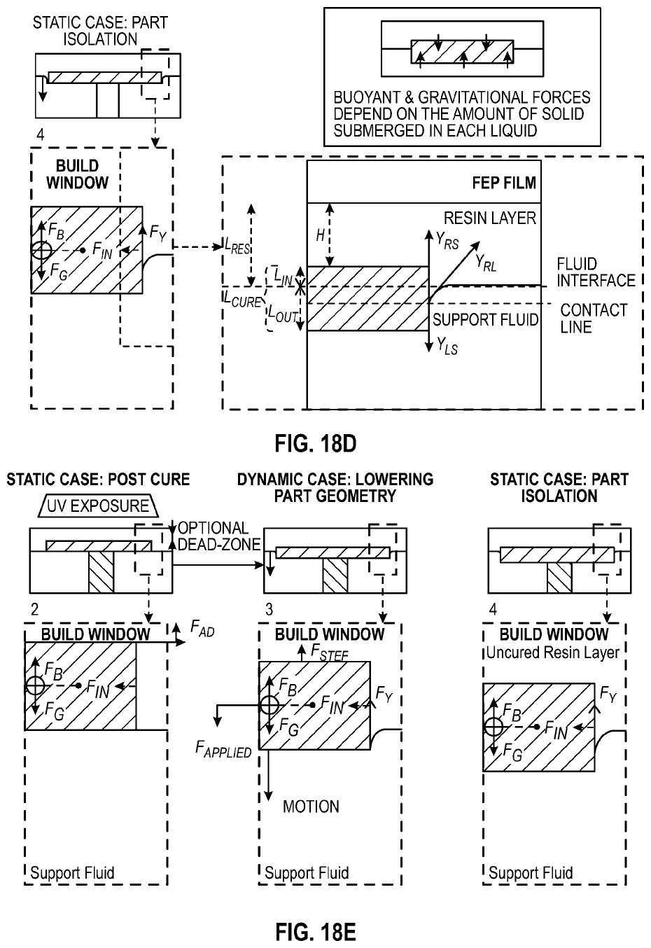

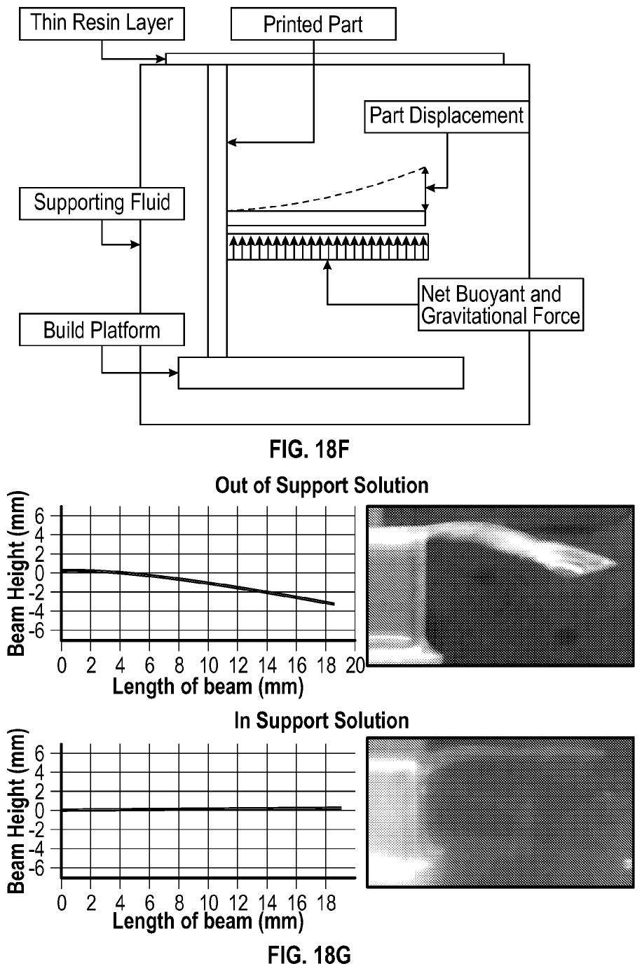

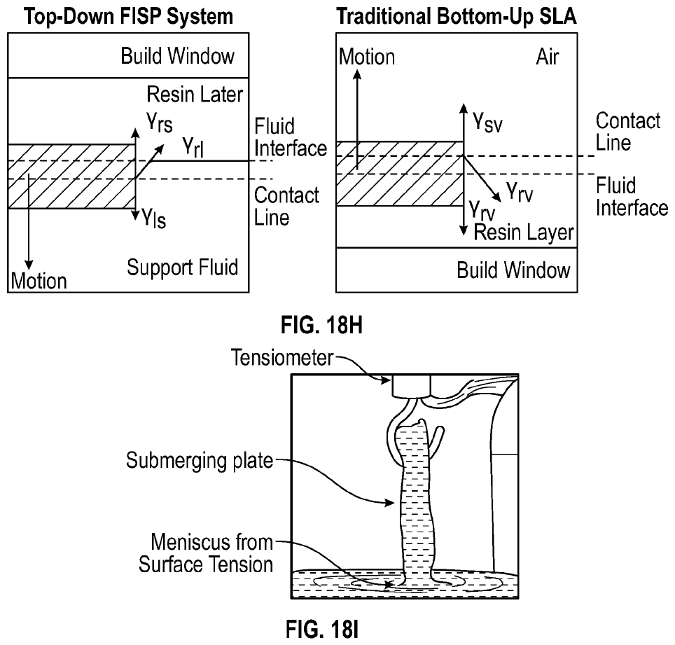

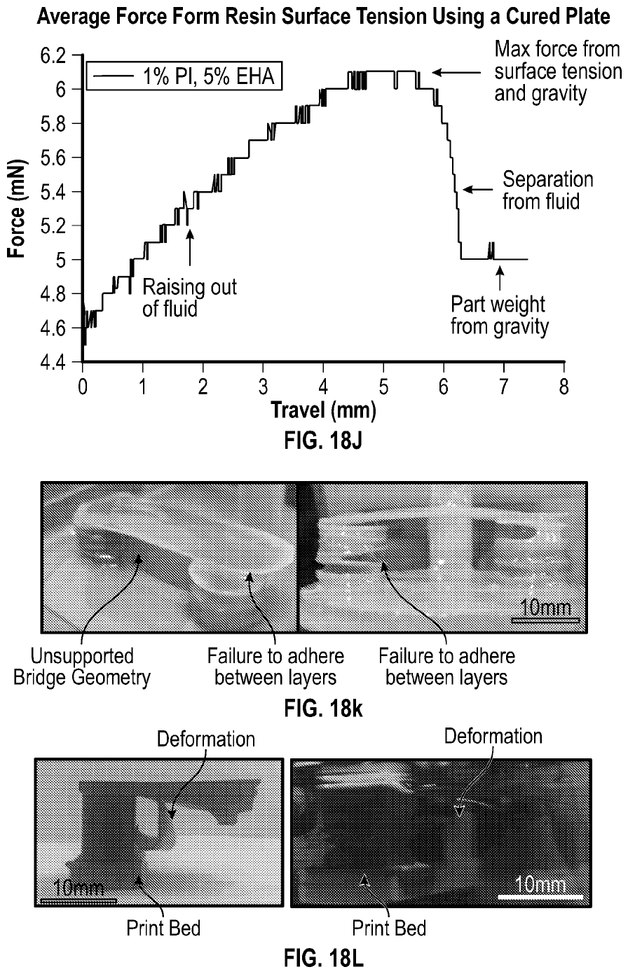

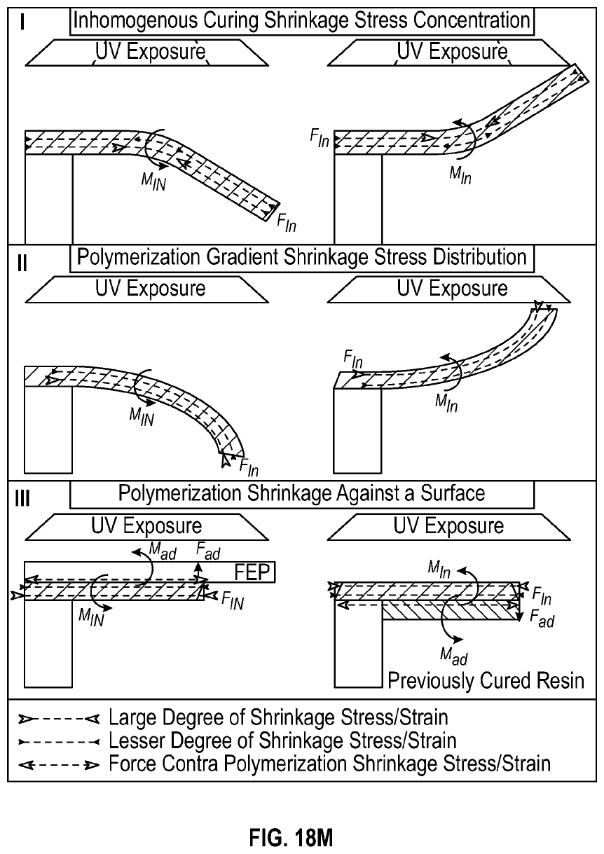

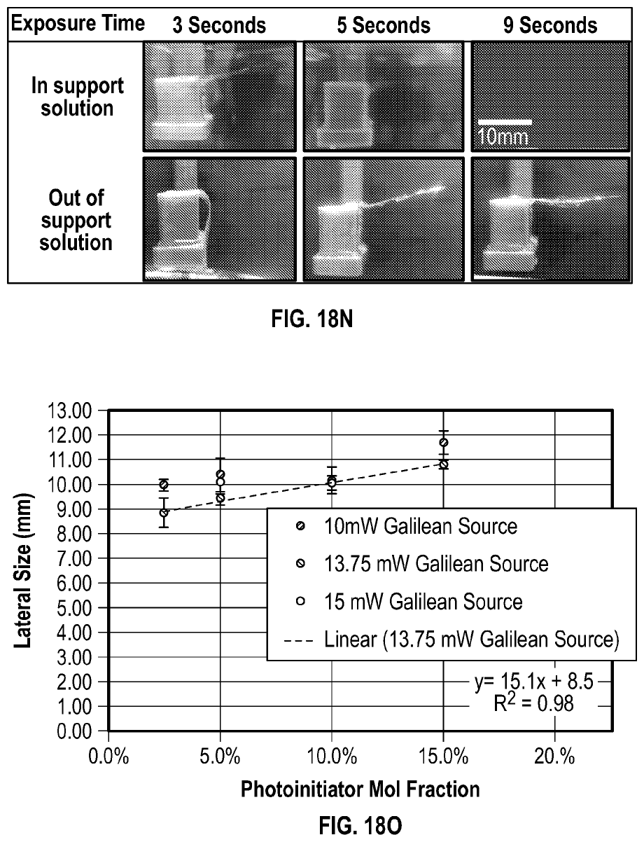

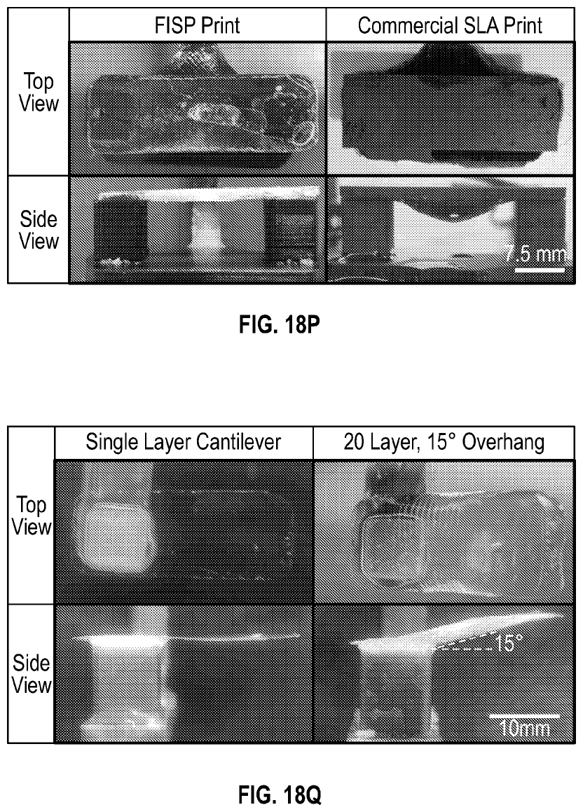

FIG. 18A shows the variance of cure depth between two experiments with near identical independent variables due to differences in optical characteristics.

For two identical systems, variation in the optical characteristics led to systematic error propagation between experiments. From their recognition and classification, these variables can be held constant during experimentation, nullifying the necessity of their quantification. In these experimental datasets, there also existed a small quantity of experimental data, which also raises the degree of uncertainty.

The quality of the polymerization trials had been observed to vary significantly due to variables of randomized origin, otherwise stated as variables that are not easily traced and correspond to variant dependent variable behaviour. A large number of researchers utilized the lab space at different times with varying levels of process control and documentation, eliminating the ability of their quantification. This included the time since the resin solution creation, as the resin had been observed to significantly degrade over time. These variables have been categorized as the time of air exposure, the surface area of resin exposed to ambient air during resin extraction and deposition in the pipette, time of resin contact with the supporting solution. This is displayed in FIG. 18B, where solution set 28 came from a resin solution that displayed very high cure depth or no cure depth at all compared to set 5 under similar process parameters.

All cure tests above were conducted with discrete resin droplets on glass slides, eliminating variations from prior UV exposure. FEP film surface defects, dirt or dust build up on optical systems, resin contamination, and air-oxygen saturation. Resin was reused in order to preserve the limited quantities available. Time of contact between the resin and the supporting solution is believed to influence polymerization to a degree, as many resins absorb varying amounts of water when in contact even when insoluble (see E. P. Irany, “Water absorption of resins,” Industrial & Engineering Chemistry, vol. 33, no. 12, pp. 1551-1554, 1941), and determination of these effects is recommended for the future.

Additional collection of random variates associated with UV exposure were evaluated. A combination of these random variates with those introduced previously is displayed in Table 6.

TABLE 6
Variates attributed to random error or unquantified in their effect on the system

| | Random Error Variates |
|---|---|
| Contamination | Time since resin solution creation |
| or Degradation | Time of resin air exposure |
| | Time of resin contact with supporting solution |
| | Resin contamination with IPA, soap, acetone, skin oils |
| | Surface area of resin exposed to ambient air during resin extraction and |
| | deposition |
| Process | Surplus exposure of UV light exposure to surrounding resin between |
| Dependent | layers |
| Environmental & | Dirt or grime on optical surfaces |
| Human Factor | Build window surface defects |

These variables were not adjusted to influence the overall input/output behavior of the system, but their presence influences the repeatability and uncertainty of the system.

Polymerization in the FISP system

Exploration into whether the cure depth of the resin varied between an unconstrained resin vat and a fluid interface supported resin layer is desired, as differences would necessitate novel polymerization modelling. Data from 43 individual cantilever beam geometry tests under strict variable control is collected for 10% PI, 5% EHA cantilever beam resin tests. These tests are divided into two experimental sets: within the FISP system (11 and 18), and within an unconstrained resin vat (17 and 19) for two powers of the Galilean beam expander optical source. The tests done in the conventional unconstrained resin vat have all the same system components: a top-down exposure of a vat of resin through a build window, except that there exists no support fluid, just additional resin. Data set 11 was collected first, and 17-19 were collected in order to facilitate comparisons to the 10% PI, and 5% EHA composition. Other data sets represent collections of different types of experiments or different material compositions, as the numbering of experiments is primarily for internal use; however, these trials and this composition were selected for comparison because of their large degree of consistency during experimentation under the same process parameters. The resulting cure depth polymerization information is shown in FIG. 18C.

The experimental data followed a successful logarithmic curve fit for the data, indicating little variation between the unconstrained and FISP datasets, with a similar Dₚ and E_{c} between the trials. The model presented by Jacob describes Dₚ and E_{c} as properties of the photopolymer, independent of the UV light exposure dose. However, this assumption generally failed for radically initiated photopolymers. Primary photochemical reactions such as absorbance and initiator cleavage failed to follow the first order proportionality, as radical polymerizations are known for their non-linear dependence on light intensity due to bimolecular radical termination (see A. C. Uzcategui, A. Muralidharan, V. L. Ferguson, S. J. Bryant, and R. R. McLeod, “Understanding and Improving Mechanical Properties in 3D printed Parts Using a Dual-Cure Acrylate-Based Resin for Stereolithography,” (in eng), Adv Eng Mater, vol. 20, no. 12, p. 1800876, 2018). Additionally, and importantly, variation to the penetration depth was due to the collimation variation of the light as the light intensity is adjusted with the Galilean beam expander, creating different light pathways through the polymerizing resin. It was shown that E_{c} and Dₚ values failed to remain constant between these sets of system conditions (material compositions and process parameters). The matching curves between the process parameter sets shared the same E_{c},Dₚ values within acceptable uncertainty. This indicated that the curing kinetics remained the same regardless of the fluid interface, which means that polymerization behavior was consistent within and outside of the FISP system.

Creation of Unsupported Geometry within the FISP System

The study established the necessary material characteristics within the FISP system and identified materials of interest. The study also established UV process parameters and system design to fabricate unsupported geometry through polymerization.

The study provided an outline of the forces that drive part warping within fabricated geometry. Parameters influencing the deflection of parts are identified, through which the experimental quantification or minimization of those deflection factors is achieved. The assumption of part fabrication with a minimal deflection from internal stresses can be shown to be valid for certain sets of system parameters, and fabrication of unsupported geometry within the system is evaluated against the hypothesis of the primary research question. The effects of the presence of the fluid interface in the system were investigated, which outline potential geometric applications of the system.

The study evaluated the different forces acting upon a part fabricated within the FISP system and the conditions in which unsupported geometry is feasible. The experimental variation of material characteristics and process parameters were assessed to minimize deflection due to internal stresses. The relevant process parameters that influence polymerization behavior in the experimental fluid interface supported printing system were identified, and a range of input parameters are given for the fabrication of unsupported geometry.

Modeling Expected Forces Acting within the System

To enable the fabrication of unsupported geometry in a polymerization system, an understanding of the forces behind cured part deflection was performed, e.g., forces that can cause the dislocation of static part geometry. Preventing dislocation of the static geometry, when parts are at a stationary equilibrium between UV exposures, would enable the fabrication of subsequent layers with minimal error. FIG. 18D diagrams the part border geometry within the fluid interface with the relevant influencing parameters.

Per the figure, a layer that had undergone polymerization and had been removed from the build window sits at equilibrium in the fluid interface: ready for an additional UV exposure to create a subsequent layer. A static part located within this zone would experience forces from the internal shear stresses from polymerization across its length, F_{In}, and surface tensional force pulling the part upwards along the part perimeter Fγ. For a part in which internal stresses and surface tension do not significantly dislocate the layer, the only remaining forces that can cause dislocation are from the differences in density of the cured part, uncured resin, and the surrounding fluid.

An equilibrium state exists when the part was lowered past the fluid interface, and the part was wholly submerged in the supporting liquid. This theoretical reduction of forces in an isolated medium was the benefactor of the FISP system, where the force from buoyancy (F_{b}) and gravity (F_{g}) nearly cancel. Equation 21 displays the consolidated relationship for the force acting equilibrium (F_{eq}). In this equation, the density difference was highlighted between the support fluid (ρᵥ) and the solid resin (ρₛ), where V is the volume of the cured resin.

F_{eq}=F_{b}−F_{g}=Vg(ρᵥ−ρₛ) (21)

This equation defined the driving principle behind the FISP system's ability to reduce support structure necessity, with the elimination of the force due to the solid-liquid density difference.

When the cured part lies within the fluid interface, as displayed in FIG. 18D, the balance between the buoyant and gravitational forces in the system can become compounded.

The force balance is expected to follow Archimedes principle (see T. Britannica, “Archimedes' principle.” [Online]. Available: https://www.britannica.com/science/Archimedes-principle), wherein the equilibrium force contains two components. In this instance, F₉ would remain the same, however F_{b} would have components from within both the resin layer and the support fluid. One component results from the part geometry submerged within the resin layer (Fᵢₙ), and another from outside the resin layer within the supporting solution (Fₒᵤₜ). This is the net equilibrium force of buoyancy and gravity in the density differences between the fluid mediums and the solid part. Equations 22 and 23 describe these force components, where L_{in/out} describes the height of the part within the fluids and s² is the part surface area.

Fᵢₙ=(Lᵢₙ)s²g(ρᵣ−ρₛ) (22)

Fₒᵤₜ=(Lₒᵤₜ)s²g(ρᵥ−ρₛ) (23)

Therefore F_{eq} was the sum of Fₒᵤₜ and Fᵢₙ, where Lᵢₙ goes to zero when the part is fully submerged in the supporting solution, and Lₒᵤₜ is zero before the part enters the supporting solution.

Archimedes' principle ignored surface tension (capillarity) acting on the body. As reviewed, the force acting upon a part within an interfacial boundary can be empirically described by Equation 24, where γᵢⱼ is the interfacial tension between the liquid resin and air (in the case of bottom-up stereolithography) or liquid resin and the supporting solution (as in the FISP system). This surface tension acts upon the perimeter, s, of the cured part geometry.

Fγ=γᵢⱼ4s (24)

The magnitude of deflection incurred from surface tension on a static part geometry within the fluid interface will be evaluated within this Example.

F_{In} results from the internal stresses within the cured part geometry. As established in Example 1, the fabrication of a cantilever beam can act as a surrogate to a discrete thin layer. Prior literature (see J. M. Hundley, Z. C. Eckel, E. Schueller, K. Cante, S. M. Biesboer, B. D. Yahata, and T. A. Schaedler, “Geometric characterization of additively manufactured polymer derived ceramics,” Additive Manufacturing, vol. 18, pp. 95-102, 2017) on the characterization of intrinsic stresses within a cantilever beam (CL) produced in a stereolithography process has been proposed to abide by Equation 25, where σₗₙ is the intrinsic stress (Pa), E_{b} is the elastic modulus of the beam, δ is the deflection of the beam, L is the length of the beam, and t is the thickness of the beam.

$${σ}_{In} = \frac{2 {E}_{b} δ {t}_{b}}{{L}^{2}} \qquad ( 25 )$$

From this equation, the intrinsic stresses of the beam are directly correlated to the deflection of the cantilever beam. An additional takeaway from this equation is when the deflection of the beam becomes negligible, the intrinsic stresses within the system can be reasoned to be similarly negligible. The force Fr, is internal to the part, acting across certain segments of or the entirety of the part's cross-section.

Dynamic and Reactionary Forces within the FISP System

The static forces F_{In}, F_{γ}, and F_{eq} are the primary factors that are investigated within this study, as they determine whether a thin layer will display deflection between UV exposures. However, dynamic reactionary forces, those that influence deflection and part failure when the print bed is in motion, can cause dislocation or failure of part geometry. These forces prohibit the successful creation of unsupported geometry if, during fabrication, their magnitude exceeds the part strength or the elastic deformation limit of the cured parts. Therefore, these forces are discussed in consideration of their relevancy to the FISP system. For a part with given material compositions, its strength and elastic deformation limit are dynamic, dependent on the exposure time, power, incident area. These forces do influence the necessity of support structures for part fracture but do not dislocate parts when the discrete layer is static, at equilibrium. Investigation into these forces results in experimental guidelines that can further facilitate a reduction in support structure necessity within the system. FIG. 18E expands the force element diagram for the printing steps of the FISP system, where the cured part geometry is moved between layers. In the figure, each of the expected forces acting upon cured part geometry is displayed using arrows, with reactionary forces having thin arrowheads.

For a static part, as in case 2, the only forces expected to be acting upon the part will be due to F_{g}, F_{b}, F_{In}, and F_{ad}. F_{ad} is the reactionary force of the adhesion between the cured part and the build window. The magnitude of F_{ad} will depend on the polymerization kinetics of the part and the oxygen diffusion characteristics of the medium above the resin layer. F_{ad} becomes present when the net force acts away from the build window surface, due either to the forces outlined previously or from an externally applied force lowering the part geometry. The reactionary adhesion force F_{ad}, has been previously characterized and studied as a cohesive zone separation mode. This force is mechanical in nature, but its magnitude stems from the chemical dynamics and polymerization kinetics of the curing resin. The models for the pull-off force between two surfaces were generated, including for the FEP films. The resulting pull-off force from build window removal was observed to be significant and relevant to the system.

When an externally applied force was applied to lower the part geometry, and after F_{ad} was overcome, dynamic case 3 of lowering the part geometry was realized. Additionally, F_{ad} acted upon the part when shrinkage strains create a force along the cantilever beam that either compressed it or created a resulting moment away from the build window, which is detailed further herein.

When the part was lowered from the build window, a reactionary force resulting from two parallel objects being separated in a fluid medium would be incurred in the form of the Stefan adhesion force (F_{stef}). The Stefan adhesion force can be derived from the lubrication approximation and is utilized by literature reviewing the forces incurred during Stereolithography (see Z. Pritchard, “Modeling Reaction and Transport Effects in Stereolithographic 3D Printing,” Ph.D. Dissertation, Chemical Engineering, The University of Michigan, 2020). This force is a function of fluid viscosity, the distance between the places, the plate geometry, and the separation speed. Therefore it was a mechanical force incurred immediately after the cured resin is removed from the build window. As noted, retaining the incurred load from this force below the plastic deformation limit of the cured resin would not affect the ability of subsequent layers to be fabricated. During fabrication, the part has not been completely crosslinked, and therefore would have a lower plastic deformation limit than a fully cured part.

The reactionary forces F_{ad} and F_{stef} can cause the cured part geometry to warp or fail. If the part warps from this movement, but the magnitude of the force remains below the elastic deformation limit of the part, it will return to its original shape, acceptable within the system. The bounds of the feasible system parameters was adjusted throughout experimentation through the observation of part fracture or permanent deformation due to these reactionary forces. The speed of the cured part geometry removal in the experimental process will be kept minimal, as both F_{ad} and F_{stef} depend on the velocity of the build plate. F_{ad} has also been previously identified to be minimizable with increasingly flexible films. Due to this, the FEP film tensioning frequency will be retained between 300-400 Hz.

For a cured, static, thin layer within the FISP system, the deflection that leads to subsequent layer errors is identified to be dependent on the density differences within the fluids, the surface tension acting along the part geometry, and the internal stresses within the part. This Example will investigate the magnitude of these deflection modes and the methods utilized to minimize them.

Deflection from Density Differences

The deflection from density differences can be modeled as a distributed force across a cantilever beam. The deflection (δ_{beam}) across the length, x, of a cantilever beam in a supporting medium with density ρᵥ can be modeled and experimentally validated. The observation of the resulting deflection of a beam within air can lead to the identification of the elastic modulus of the part for a set of process parameters. Additionally, a deflection equation can guide future developments of fluid boundary systems. The deflection equation for a cantilever beam within a fluid medium is given by Equation 26 with the density of the cured resin (ρₛ), the bulk fluid (air or support solution) density ρᵥ, the moment of inertia (I), and the elastic modulus (E); where w, h, and L describe the part geometry,

$${δ}_{beam} = - whg * ( {p}_{s} - {p}_{v} ) * \frac{{x}^{2}}{24 EI} * ( 6 {L}^{2} - 4 Lx + {x}^{2} ) \qquad ( 26 )$$

FIG. 18F displays an exaggerated example of the displacement of a CL beam due only to density differences.

As a polymer cured, its elastic modulus increased over time (see C. Macosko, “Rheology principles, measurements, and applications, VCH Publ,” in Inc, New York, 1994, ch. 568) as the degree of crosslinking increases. The degree of crosslinking is dependent on the process parameters dictating UV irradiance, resulting in stiffer parts for subsequently higher crosslinked parts. For this example, an experimental part may be considered in which the curing degree is low. The densities are as follows to be considered: cured part 1.07 g/cm³, fluid 1.12 g/cm³, and the air of 0.001 g/cm³.

The part geometry under consideration in this example is a 5% PI 5% EHA CL created under 9 seconds of 10 mW exposure, resulting in a part geometry 0.2 mm thick, 19.6 mm long, and 10 mm wide. By applying Equation 26 to an experimentally created, deflected beam, one can derive the elastic modulus of a partially-crosslinked part. Additionally, the theoretical deflection of the beam is reflected through experimentally created parts within the FISP system, as shown in FIG. 18G.

The vertical deflection of the part outside of the supporting solution was measured to be between 2.34 and 3.41 mm. The tip of the beam was warped slightly laterally across its width, causing one side to hang an extra 1.07 mm below the other. This discrepancy in the maximum deflection due to gravity is observed to be due to the inhomogeneity of the cantilever beam crosslinking along the width of the beam. This was most evident when the part is within the FISP system, as the part submerged within the fluid does not display appreciable warping in its lateral or longitudinal dimensions. This highlights an additional advantage of the system, as it supports a wide range of cantilever stiffnesses. Cured Poly(HDDA) has been previously identified to have an elastic modulus of up to 530 MPa (see X. Zheng, H. Lee, M. Shusteff, E. B. Duoss, J. D. Kuntz, M. M. Biener, Q. Ge, J. A. Jackson, N. X. Fang, and C. M. Spadaccini, “Title: Ultra-light, Ultra-stiff Mechanical Metamaterials,” Science, vol. 344, pp. 1373-1377, 2014 Jun. 20 2014) when fully cured, and as low as 2.5 MPa when in a gel-like state (see D. Espinosa Hoyos, H. Du, N. Fang, and K. Van Vliet, “Poly(HDDA)—Based Polymers for Microfabrication and Mechanobiology,” MRS Advances, vol. 2, pp. 1-7, Jan. 16, 2017). In this experiment, using the measured vertical deflection outside of the supporting solution, the elastic modulus can be derived with the deflection equation to be between 17 MPa and 25 MPa. The resulting elastic modulus resides between those reported in prior literature, and is reflective of a part that has undergone a low degree of crosslinking. This part has a very low degree of stiffness, similar to a flexible foam. Entering this number back deflection equation for a part within the supporting solution, the maximum deflection is predicted to be between 0.10 and 0.15 mm. The difference in deflection was significant between the two mediums. To represent the relative deflection with respect to the part size, a ratio between the part length and deflection was used. In air, the ratio is 12.3-16.5%, while in the supporting solution, the ratio is only 0.53-0.77%. The force densities (force per unit volume) acting upon part geometries within a medium can be found using g(ρₛ-ρᵥ), and is equivalent to 490.5 N/m³ within the support fluid compared to 10,486 N/m³ outside of the fluid interface. Therefore, fabrication within a fluid interface system has a quantifiable and demonstrable reduction in the forces incurred on overhanging part geometry. This makes it preferable for the fabrication of a part displaying overhanging geometry similar to the one investigated within this section to be conducted within a support fluid.

Deflection from Surface Tension

It has been noted that an issue in the fabrication of micron-size structures was the high-surface tension resulting from a high surface-to-volume ratio. This problem was overcome in a study through the use of a low viscous monomer, but it does not go into any detail on discovering the magnitude or characterizing these surface tension effects (see A. Goswami, A. M. Umarji, and G. Madras, “Degradation kinetics of poly(HDDA-co-MMA),” Journal of Applied Polymer Science, vol. 117, pp. 2444-2453, Aug. 15, 2010). An additional study on stereolithographic microfabrication (see C. W. Ha and D. Yang, “Fabrication of micro open structure using 3D laser scanning method in nano-stereolithography,” in 2014 International Conference on Manipulation, Manufacturing and Measurement on the Nanoscale (3M-NANO), 27-31 Oct. 2014 2014, pp. 299-303) found that critical failure of parts resulted from the surface tension related to the high surface area to volume ratio of the structure. Therefore, the researchers defaulted to the production of hollowed-out structures, removing faces with the largest surface areas to remedy this.

In the FISP system, surface tension acted similarly to traditional bottom-up SLA systems, except instead of a liquid-air boundary acting upon the part, the surface tension acts along a liquid-liquid boundary, as shown in FIG. 18H.

Surface tension can act as a restoration force acting against an object's displacement when placed at a fluid bath. A common method of measuring the liquid-vapor surface tension is the Wilhelmy plate method, which measures the force required to pull a solid object from a liquid bath. In the Wilhelmy method, the results of the experiment do not depend on the material used, as long as the material is wetted by the liquid. As the plate was raised from the liquid, the immersed solid-liquid interface area decrease, while the solid vapor interface increased by the same amount. The energy input was the work done to pull the plate from the liquid, and the force from surface tension (F_{γ}_{ₛᵥ}) was the reactionary force against this movement. This is outlined in Equation 27 (see A. Marchand, J. H. Weijs, J. H. Snoeijer, and B. Andreotti, “Why is surface tension a force parallel to the interface?,” American Journal of Physics, vol. 79, no. 10, pp. 999-1008, 2011 Oct. 1, 2011), where γₛᵥ is the liquid-vapor interface, l is the perimeter of the interfacial boundary, and θ is the contact angle between the liquid phase and the plate.

F_{γ}_{ₛᵥ},=γₛᵥl cos(θ) (27)

For a perfectly wetted surface, the contact angle goes to zero. In practice, literature values or complete wetting are assumed. The contact angle between uncured-cured resin was found to be less than 8°, which is suitable approximation to a perfectly wetted surface in this instance and therefore will be the material used for experimentation.

In a traditional, bottom-up printing process, the surface tension acts on printed parts in the resin-vapor interface as they are removed. To determine the reactionary force acting upon printed parts in traditional bottom-up SLA, the experimental setup in FIG. 18I is utilized.

A Mark-10 Mechanical Tester with a M5-012 load cell was used as the tensiometer in the experiment, with a maximum load of 500 mN and a resolution of 0.1±0.05 mN. FIG. 18J displays the average results of four tensile tests of a printed part being removed from the resin-vapor interface.

As the part was raised from the fluid, its weight no longer became supported by the fluid's buoyancy, increasing the force on the tensiometer. The peak load incurred when the part is removed from the fluid, and the part was pulled downwards by the fluid before the surface tension is broken. The difference between the max force experienced by the part and the force due to gravity of the part outside of the saline solution is found to be 1.1±0.1 mN. Using the part's perimeter of 0.0227 m, the surface tension acting on the plate from the uncured resin-air interface can be estimated to be 24.19±3 mN/m. This result closely matches a liquid-vapor interface surface tension for an EHA and HDDA solution with surface tensions described in Example 2. The surface defects present within the wetting plate and the incomplete wetting onto the plate (contact angle greater than 0°) can be attributed to any discrepancies in the experimental surface tension.

The interfacial tension between the support fluid and resin, γᵣₗ, was found to be ˜14 mN/m. Utilizing this, it can be determined that the forces a part experiences within the fluid interface of the FISP system is 58% of those experienced by a part in a bottom-up printing configuration. However, utilizing a similar deflection model as from 6.2, with the creation of a 20×10×0.2 mm cantilever overhang, the maximum deflection from surface tension at the end of the beam was only −7.0 um and 4.1 um for a part within a traditional bottom-up printing system and the FISP system respectively. This is a negligible displacement for the tolerances within the FISP system. Therefore, the forces from surface tension can be reasonably assumed to be negligible for macro geometry deflection within either type of printing system. The 58% reduction of pull from surface tension due to the interfacial fluidic tension opens for potential microfabrication applications for parts within a FISP system.

Deflection from Internal Stresses

### Preliminary Results Motivation Experimentation

To determine if part fabrication within a fluid interface is feasible, preliminary polymerization systems were developed, and experiments were performed. These experiments began to provide an empirical demonstration of the variables within the system that affect feasibility. The feasibility of the production of unsupported geometry was initially demonstrated via the creation of bridge geometry from Form Labs grey resin, as shown in FIG. 18K.

The bridge geometry displays layers with obvious failures to adhere to subsequent layers and appears poorly constructed. However, this experiment displays promising results for unsupported bridge geometry feasibility. The Formlabs resin was eventually abandoned after significant experimentation due to the unknown variables within the resin that affect polymerization behavior. Alternative resin compositions and curing methods that display the desired material characteristics outlined previously were investigated, and HDDA is implemented as the base monomer for experimental validation. Preliminary printed parts demonstrated successful polymerization. When creating large cross sections of overhanging geometry, however, parts tend to display warping behavior. Herein, warping, curling, and deformation are used synonymously to describe any cantilever print that has bent above or below the horizontal plane after polymerization has been completed. Delamination is the term used to describe geometry that rapidly separates from the build window or the printing plane, curling away from the UV light source, during or immediately after polymerization. FIG. 18L displays delaminating warping behavior from a print within a Formlabs printer and within the FISP system. Both of these prints displayed delamination of the first thin layer from the away from the build window and UV light source, even though the Formlabs print was conducted in a bottom-up printer and the FISP print was done top-down.

The thin layer deformation present within both types of printing systems indicated that this behavior was not exclusive to the FISP system. Additionally, since the Formlabs printing process was a bottom-up printing process compared to the top-down FISP process, and the thin layer deformation was present in both, it can be determined that gravity was not the driving factor of this deformation. Due to the rigidity of this thin layer and the presence of deformation after the completion of the printing process in the FISP system, the only force component that can be rationally attributed to this behavior was due to internal stresses, as outlined in FIG. 18D. The curling in FIG. 18L was on an order of magnitude greater than, and directionally contrary to prior literature (see K. Xu and Y. Chen, “Mask Image Planning for Deformation Control in Projection-Based Stereolithography Process,” Journal of Manufacturing Science and Engineering, vol. 137, no. 3, 2015), where residual internal stresses were noted to warp the beams towards the UV source. The proceeding section will investigate this behavior.

Varied experimentation displayed this as a persistent problem for the system variables tested. In fact, the internal stress due to polymerization shrinkage (αₗₙ) has been shown to manifest itself physically in multiple forms throughout experimentation. These forms will be classified and displayed in FIG. 18M as inhomogeneous and gradient polymerization. Note that the warping diagrams are not exclusive to FISP.

In FIG. 18M, case I displays two instances of inhomogeneous curing shrinkage stress concentration, where a localized area displays a higher degree of compressive shrinkage strain in the beam. Case II displays warping due to a polymerization gradient within the beam, where there exists incremental shrinkage strains across the beam thickness that causes deflection. Case III displays instances where the curing beam is constrained to a surface that the beam can adhere to during polymerization, counteracting warping due to shrinkage strains.

Case I displays a moment within the beam from a localized stress concentration, resulting in warping towards or away from the light source. This can be typically attributed to an inhomogeneous UV exposure, inhomogeneous free-radical initiation, or inhomogeneous distribution of photoinitiator throughout the resin. The opposing side of the deflecting beam was simultaneously under tension from the opposing compression, while also undergoing compression from the polymerization shrinkage, just to a lesser degree. This polymerization gradient in Case II occured when there exists an incremental degree of crosslinking across the beam thickness. In a system with tight process control and a lower degree of entropy, Case I became less common, and the mechanics of Case II can be better analyzed. Prior literature indicates gradient shrinkage towards the UV source is common, as the surface nearest the UV source receives the highest incident exposure and therefore undergoes shrinkage strain and the largest degree of crosslinking first, causing the part to warp in that direction.

FIG. 15 displays the resulting polymerization behavior of a 1% DMPA, 99% HDDA sample exposed to 8-10 mW of UV light for 8 seconds. Specifically, FIG. 15 shows 1% PI, 0% EHA, 8s exposure cantilever beam overhang geometry test prints with no initial build window at 8.23 mW (left) and beneath a build window at 10 mW (right).

This beam deflected away from the UV source both with and without the presence of the build window. This deflection occured under a different set of circumstances yet to be extensively detailed in prior literature. Two possible explanations may exist for this warping behavior. The beam that warped away from the build plane exposed to air may have a large degree of oxygen inhibition at the top layer, meaning the thickness of the beam further from the UV source is able to crosslink first and further, displaying more shrinkage strain towards the bottom of the beam. In the second case, where the FEP constrained the top surface of the beam, the beam may be deflecting downwards due to a large degree of built-up internal stresses, similar to the cantilevers shown in FIG. 18L. These cantilevers may be distorting away from the build window since the surface against the build window is constrained, while the remaining unconstrained part body is free to contract due to inherent volumetric shrinkage. Case III displays more information about this constraining surface, and it is noted that the internal stresses are built up as the part is built upon a constraining surface, but the part does not deflect due to the adhesion between the part and that surface. This surface may be supporting features, a build window, or prior layers that the part can adhere to during printing, mitigating possible deflection that would be present when the part was not constrained to a static surface. Part deflection, therefore, was present when the resulting forces from internal stresses (F_{In}) are greater than the adhesion force between the solidifying part and the build window (F_{ad}). Additional adhesion to the build window may increase the probability of fracture from the part's removal but would simultaneously act against the beam curling from internal stresses away from the build window before the part had undergone sufficient polymerization. The ability of the FISP system to reduce support structure necessity relies on the feasibility of part production without deformation due to internal stresses. To address this, the material compositions and process parameters necessary to validate the feasibility of the FISP system were evaluated to minimize this deformation.

### Relation to Existing Work

Shrinkage strains in stereolithography are a direct result of internal stresses, and many studies have been done to investigate the curing of photopolymers and the mechanisms of the resulting shrinkage. However, predicting curling behavior from polymerization is a difficult challenge, even for commercial processes. An experimental study (see J. S. Ullett, R. P. Chartoff, A. J. Lightman, J. P. Murphy, and J. Li, “Reducing warpage in stereolithography through novel draw styles,” in 1994 International Solid Freeform Fabrication Symposium, 1994) of process parameters affecting curl in stereolithography was conducted using a variety of hatching process parameters with a SLA-250 machine and reported the hatch spacing was the most important parameter affecting the curl, but ultimately reported that there was a need for more experiments to get better statistical curl information for the parameters they presented within their mathematical model. Furthermore, a prediction of shrinkage strains in stereolithography was done through the creation of a genetic algorithm which was proposed for the prediction and the minimization of shrinkage strains in lengthwise and breadthwise axes for a laser-SLA system by controlling the major process parameters of laser hatch spacing, exposure time, overcure, and hatch fill curve for a set of hatch patterns, in order to construct a CAD model with built-in shrinkage determination built-in (see K. Chockalingam, N. Jawahar, and E. Vijaybabu, “Optimization of process parameters in stereolithography using genetic algorithm,” in Smart Materials, Structures, and Systems, 2003, vol. 5062: International Society for Optics and Photonics, pp. 417-424). Similarly, neural network prediction of process parameter effects on part geometry error had been refined for laser-SLA systems for over 13 years (see S. Rahmati and F. Ghadami, “Process Parameters Optimization to Improve Dimensional Accuracy of Stereolithography Parts,” Journal of Advanced Design and Manufacturing Technology, vol. Vol. 7, pp. 59-65, Mar. 1, 2014; and S.-K. Lee, W.-S. Park, H. Cho, W. Zhang, and M. Leu, “A neural network approach to the modelling and analysis of stereolithography processes,” Proceedings of The Institution of Mechanical Engineers Part B-journal of Engineering Manufacture—PROC INST MECH ENG B-J ENG MA, vol. 215, pp. 1719-1733, Dec. 1, 2001) and the authors were able to achieve an error prediction down to 3.73% for commercial stereolithography machines. The authors of these papers noted that no exact relationships have been developed for process variables and accuracy, and that the process variables must be carefully balanced to create accurate parts. The authors propose methods of precisely tuning the process variables to fabricate parts in existing systems the minimal dimensional inaccuracies. The degree of this control is unnecessary in the experimental FISP system to eliminate dimensional inaccuracies, however, the principle of error reduction through process variable control will be applied to the FISP system to mitigate the deflection from internal stresses.

Unfortunately, many of these studies cannot be directly applied to the experimental process for the FISP system, as the optical setup utilizes a masked projection method rather than a hatching laser. Literature on masked projection stereolithography does demonstrate the ability to reduce warpage due to shrinkage strains in a DMD projection system by algorithmically dividing the mask geometry into multiple sub-exposures and selectively exposing individual pixels in the projected geometry, effectively reducing warping behavior up to 32% from the commercial baseline. This method of warping reduction cannot be applied to the FISP system with its current optical projection method but should be considered for future implementations of the system.

Any of these methods should be viable and applicable to mitigate internal stresses within future fluid interface supported printing systems, depending on the optical system and resin used. However, lateral inaccuracies and deformations are not of interest given the 2D diagram presented in FIG. 18E, and the characterization of them is unnecessary for the development of the feasibility of FISP. The deformation presented in FIG. 18L is much larger than the deformation identified in prior literature. The deformation degree due to internal stresses does not need to be zero either, as long as it is negligible during the fabrication of parts in the system. Volumetric shrinkage has been indicated to play less of a role in warpage compared to inhomogeneous shrinkage strain, and it has been observed that the revision of process parameters enables a reduction of shrinkage strains during polymerization (see W. L. Wang, C. M. Cheah, J. Y. H. Fuh, and L. Lu, “Influence of process parameters on stereolithography part shrinkage,” Materials & Design, vol. 17, no. 4, pp. 205-213, 1996/01/01/1996). In other words, warping behavior is likely due to inconsistent shrinkage across the part, creating an induced internal stress field. The authors claim that resins with high shrinkage percentages were tolerable if the shrinkage rate is much larger than the scan rate, which is achieved through a larger scan time. It has been determined that the rate of polymerization affects shrinkage strains as well, noting that the freer movement of radicals through the resin enables less warping behavior, which is achieved by a slower polymerization rate in the study. The authors note that inhomogeneous shrinkage seems to be mostly due to radicals trapped within the 3D acrylic structure, leaving unpolymerized groups.

### Data Analysis for Experimental Overhang Geometry

Due to the requisite of a reduction in the vertical deformation in the part geometry to demonstrate the feasibility of the FISP system, it was hypothesized that a reduction in warping behavior can be achieved through a similar variation of input parameters in the experimental setup. Additionally, in prior literature regarding the reduction of warping due to shrinkage strains, few mention adjustment of the photoinitiator concentration in the system. Theoretically, photoinitiator concentration adjustments within the resin should display a positive correlation to the diffusion of the photoinitiator throughout the resin and increase the rate of polymerization. Prior literature indicates that increasing the photoinitiator concentration past a certain threshold does not benefit the final degree of crosslinking conversion. Increasing the rate of polymerization and the free radical concentration could accelerate crosslinking conversion to occur before warping deformation occurs, while simultaneously increasing polymerization homogeneity throughout the cured resin. Increasing the rate of polymerization may also increase the adhesion to the build window, acting against the stresses driving warping. This motivated the identification and variation of material composition variables in the FISP system to validate the feasibility of part fabrication without deflection due to internal stresses.

In all experiments performed, the temperature of the system was held between roughly 20 to 23.5 degrees Celsius. Distance from the UV light source is kept at 33 mm, the FEP film is tensioned, so it vibrates between 400-600 Hz, and the UV light source waveform was unaltered. The masks used in the system are numbered, however only three were chosen for overhanging part fabrication, masks 11, 8, and 6, as shown in FIG. 14A. In each trial, 600 μl of resin is deposited initially, and each resin has a 5% EHA concentration. All remaining systematic variables and random variates were held constant, or their deviation was attempted to be minimized. The photoinitiator concentration, as well as the UV power and exposure time, were adjusted systematically and the resulting warping behavior of the cured CLs was evaluated.

An adjustment of the cure time and UV incident power was conducted for each photoinitiator composition tested. Results indicated that for large, overhanging CLs created within the experimental system, the adjustment of these process parameters alone would be insufficient to minimize cured part warping. The exposure power was adjusted for a range of 0.5 mW to 90 mW between the tower optical system and the Galilean beam expander. Quantification was conducted for the number of CLs displayed delamination (N_{D}) or warped part geometry (N_{w}). Delaminated cures are those in which the internal stresses present within the part geometry resulted in the deflection of the CL downwards, away from the build window during or after exposure. Not all warped cures delaminate from the build window downwards during printing, but every delaminated part displays warping behavior. The total number of trials for each set of parameters conducted were quantified with Nₙₑₜ. Note that rapid polymerization and adhesion to the build window was desired, and prior experimentation with 1% PI displayed somewhat inconsistent curing with the UV exposure available, so a much higher degree of photoinitiator than is classically utilized is implemented.

A subset of this data was selected for the 5% PI, 5% EHA solution CL trials. This dataset was selected to compare the deflection of CLs for the widest range of UV power tested and is presented within Table 7. In this, and following tables, | [symbol] | is the average of the absolute magnitude of the warped beams, and [symbol] is the average dislocation of the CLs in both the negative and positive direction. For example, an experimental dataset with similar process parameters may result in a part that warps upwards 2 mm and a part that delaminates during printing −1 mm. This dataset would have a N_{D} of 1, a N_{w} and Nₙₑₜ of 2, a [symbol] of 0.5, and a | [symbol] | of 1.5. Note that delamination (N_{D}) only describes parts that deflect downwards during or immediately after polymerization, while curling describes parts display warping up or down behavior after removal from the supporting solution and polymerization system. The standard deviation of the curvature in both the positive and negative directions is denoted by σw.

TABLE 7
Cured Part Curvature and Delamination Data for Variation
in UV Power for 5% PI, 5% EHA solution

| Pϕ | Exposure Time | | | | | W̅ | σ_{W} |
|---|---|---|---|---|---|---|---|
| (mW) | Range (s) | N_{D} | N_{W} | Nₙₑₜ | [symbol] mm) | (mm) | (mm) |
| 0.5 mW | 12, 18, 25 | 2 | 3 | 3 | 1.85 | −0.32 | 0.96 |
| 3.0 mW | 12, 16, 20 | 2 | 2 | 3 | 1.47 | −1.47 | 1.33 |
| 10.0 mW | 3 through 18 | 5 | 7 | 8 | 2.84 | −2.49 | 2.04 |
| 13.75 mW | 6, 9 | 2 | 2 | 2 | 7.97 | −7.97 | 0.35 |
| 15.5 mW | 6, 9 | 1 | 2 | 2 | 2.15 | −2.15 | 3.04 |
| 90.0 mW | 1, 2, 3 | 3 | 3 | 3 | 4.07 | −5.40 | 1.46 |

The data demonstrated little correlation between the variation of power and whether warping behavior in the cured resin was observed. As expected, lowering the power of the exposure does appear to lower the magnitude of part curling, but it does not eliminate it from the system. For each intensity, the warping behavior of the cured CL was also time dependent.

The exposure time of the photopolymer to the incident UV light defined the overall incident power in the system. An evaluation of the exposure time-dependency of the resulting warping behavior for a 15.5 mW exposure of a 10% PI, 5% EHA sample is displayed in FIG. 18N. This dataset was chosen due to its ability to demonstrate deformations that are exposure-time dependent. Parts that delaminate were those that warp downwards during or immediately (less than twenty seconds) after exposure, while warping was quantified after part removal from the supporting solution (minimum 3 minutes). This smaller dataset highlighted the influence of exposure time on warping, containing six experiments with the same incident UV power. Table 8 describes displays formatted results for the same dataset case study.

TABLE 8
Comparison of different exposure times for a 10% molar DMPA,
5% molar EHA solution exposed to 15.5 mW of UV
light, inside and outside of the supporting solution

| Pϕ | Exposure | | | | | W̅ | σ_{W} |
|---|---|---|---|---|---|---|---|
| (mW) | Time | N_{D} | N_{W} | Nₙₑₜ | [symbol] mm) | (mm) | (mm) |
| 15.5 | All | 5 | 1 | 6 | 1.666667 | 1.166667 | 2.065591 |
| 15.5 | 3 | 1 | 0 | 1 | 0 | 0 | — |
| 15.5 | 5 | 2 | 0 | 2 | 3.5 | 3.5 | 0.707107 |
| 15.5 | 6 | 2 | 1 | 2 | 1.5 | 0 | 2.12132 |
| 15.5 | 9 | 0 | 0 | 1 | 0 | 0 | — |

For low energy doses, i.e., 3 seconds at 15.5 mW, the resulting CL would have a low degree of crosslinking conversion. This makes it susceptible to bending downwards due to gravity once removed from the supporting solution. CL deflection inside of the supporting solution comes primarily from internal stresses in the print, as the density differences between the supporting solution and the cured part will not cause substantial deflection. The three-second exposure example shown in the figure almost perfectly demonstrates the desired beneficial behavior of the FISP system, where discrete layers within the system can be produced with minimal deflection within the support fluid. This minimal deflection was observed when deflection due to internal stresses was absent, and the forces from density differences were absent that would be otherwise present outside the supporting solution. For this PI concentration and UV power, CLs that were made at 5 seconds of exposure consistently display sufficient crosslinking to support their own weight, but residual cross-linking and shrinkage strains (see D. Karalekas and A. Aggelopoulos, “Study of shrinkage strains in a stereolithography cured acrylic photopolymer resin,” Journal of Materials Processing Technology, vol. 136, no. 1, pp. 146-150, 2003/05/10/2003) after the UV-exposure cause the beam to curl upwards.

The upward curl from residual stresses in the beam may not be present immediately after the print is removed either, as the pictures from the five-second exposure time experiment do not display the warping behavior until some time after the removal of the print from the FEP film. This may be due to dark reaction crosslinking. When the time of exposure was increased for this resin combination, many of the residual free radicals present in the system more fully crosslink the monomer, reducing the dark reaction and solidifying the part. The higher degree of crosslinking produces CLs that were a single, self-supporting layer. The increased crosslinking of the resin combination led to stiffer parts that are able to overcome F_{ad} and F_{In} when being removed from the FEP film, as displayed in the 9 second exposure case of FIG. 18N. Similarly, 5% PI 5% EHA beams under 0.5 mW of power, displayed flexible beams, upwards curling, and static geometry when cured for 12, 18, and 25 seconds. Combinations of a series of exposures and exposure sizes were conducted as well, with varying results.

Variation of the PI % is conducted for 2.%, 5&, 10%, 15%, and 20% P concentration. Experiments were bounded by the power adjustment range available with the Galilean beam expander optical setup described in section 5.3 completed under 10, 13.75, 15.5 mW of power between 4-14 seconds using mask number 11, and the results are displayed in the table below. Only tests with successful CL geometry were retained in the data table.

TABLE 15
Warping behavior depending on Photoinitiator
composition in cantilever beam geometry

| | Behavior For | | | | W̅ | σ_{W} |
|---|---|---|---|---|---|---|
| | each PI% | N_{D} | Nₙₑₜ | [symbol] mm) | (mm) | (mm) |
| | All 2.5% | 5 | 7 | 3.92 | −3.92 | 3.69 |
| 2.5% | Curve Down | 5 | 5 | 6.53 | −6.53 | 1.29 |
| | Curve Negligible | — | 2 | — | — | |
| | Curve Up | — | — | | | |
| | All 5.0% | 12 | 18 | 2.97 | −2.70 | 2.54 |
| 5.0% | Curve Down | 12 | 14 | 3.71 | −3.71 | 2.41 |
| | Curve Negligible | — | 3 | — | — | |
| | Curve Up | — | 1 | 2.30 | 2.30 | |
| | All 10.0% | 7 | 16 | 1.12 | 0.36 | 1.32 |
| 10% | Curve Down | 5 | 5 | 1.10 | −1.10 | 1.16 |
| | Curve Negligible | — | 4 | — | — | |
| | Curve Up | 2 | 7 | 1.88 | 1.61 | 1.41 |
| | All 15.0% | 2 | 20 | 0.70 | 0.14 | 1.36 |
| 10% | Curve Down | 2 | 4 | 1.40 | −1.40 | 0.64 |
| | Curve Negligible | — | 14 | — | — | |
| | Curve Up | — | 2 | 4.15 | 4.15 | 1.20 |
| | All 20.0% | — | 7 | 0.57 | 0.57 | 1.51 |
| 10% | Curve Down | — | — | — | — | — |
| | Curve Negligible | — | 6 | — | — | — |
| | Curve Up | — | 1 | 4.00 | 4.00 | — |

This table summarizes the motivation behind the very high PI % present within the study, as a trend is visible between the increase in photoinitiator composition and the number of warped CLs. Increasing the photoinitiator concentration increased the rate of crosslinking in the curing layer. Increasing the molar photoinitiator composition all to 20% in the resin layer increased the rate of crosslinking throughout the resin while creating a uniform and sturdy beam. However, due to the relatively large amount of photoinitiator present in the resin, the large number of free radicals present under the irradiance of the UV-light caused the parts to cure to the FEP film. A 15% molar PI and 5% molar EHA combination proved to have one of the largest ranges of success given the time and intensity parameters set forth in the experimental setup for the time and irradiances tested. The imperfect exposure control variables were compensated by the large amount of PI present within the resin. The resin displays successful one-layer CL beam prints for 6 s to 10 s for 13.75 mW and 7.5 s to 12 s for 10 mW without deflection post-curing. The set of IVs producing the most successful printing results is found to be 15% PI, 5% EHA, 10 mW, and 8-9s.

Ideally, the resin would have a uniform distribution of EHA and PI with a planar diffusion of oxygen, resulting in uniform surface topology and no internal discrepancies.

Literature indicates that warping is also directly influenced by thin layer deformation because the cured resin could not resist the adhesive forces acting upon it during shrinkage. High photoinitiator concentrations and incident irradiance causes the deadzone to disappear (see C. E. Hoyle, “An overview of oxygen inhibition in photocuring,” in Technical Conference Proceedings-UV & EB Technology Expo & Conference, Charlotte, NC, United States, 2004, pp. 892-899), causing the resin to adhere to the FEP film surface. This was believed to provide a surface for the crosslinking resin to adhere to, preventing warping behavior. Prior literature and experimentation displayed an almost complete elimination of the oxygen inhibited dead-zone at 5% wt concentrations of DMPA in HDDA. Additionally, it has been shown that inadequate polymerization is correlated to an increase of water sorption (see G. J. Pearson and C. M. Longman, “Water sorption and solubility of resin-based materials following inadequate polymerization by a visible-light curing system,” (in eng), Journal of oral rehabilitation, vol. 16(1), pp. 57-61, 1989). To mitigate the influence of water sorption on polymerization deflection, therefore, is compensated through the addition of a surplus of PI within the system to increase the degree of photopolymerization. The reduction of warping in unsupported structures is therefore reasoned to be dependent on the large degree of crosslinking in the layers formed by the 15% PI resin combination during printing, and the adhesion to the build window during printing from the elimination of the oxygen dead zone from the propagation of excess free radicals throughout the resin. This results in a stiff part that retains its shape even after removal from the build window.

### Lateral Growth

In the study, the resulting geometry of the parts was quantifiable and predictable for the system to meet the minimum desired specifications. Lateral growth in cured discrete resin layers has been previously identified to increase as the concentration of the photoinitiator in the solution increases. This may be due to the surplus of free-radicals present at geometric borders from the excitation of photoinitiator within the solution. Due to some photoinitiator concentrations investigated in the CL testing was almost an order of magnitude larger than commonly cited literature values, characterizing the relative change in lateral growth between the photoinitiator concentrations is necessary. For the full dataset of single-layer CL printing experiments performed, the lateral width of the CLs were compared, as the longitudinal length is observed to vary significantly depending on the curling behaviour observed. Table 9 displays a collection of lateral width data collected for various exposure powers and times for different PI concentrations, displaying a trend of increasing lateral width for increasing photoinitiator concentration. The exposure for lower power covered a larger area from the collimation knob, giving it an intrinsically larger lateral width. Every experiment was performed with DMPA as the photoinitiator with 5% EHA added for enhanced spreading characteristics.

TABLE 9
Average Lateral Width for
Certain Exposures within the FISP System

| | | Lateral Width [symbol] for each | | | | |
|---|---|---|---|---|---|---|
| | | PI concentration | | | | |
| Power (Pϕ) | Time (s) | 2.50% | 5% | 10% | 15% | 20% |
| 10 mW | 9 | 10.12 | 9.90 | — | 11.85 | — |
| 10 mW | 12 | 9.80 | 10.85 | — | 11.50 | — |
| 13.75 mW | 6 | 9.50 | 9.60 | 9.89 | 10.32 | — |
| 13.75 mW | 9 | 8.50 | 9.21 | 10.64 | 10.42 | 10.17 |
| 13.75 mW | 12 | — | — | 10.06 | 10.30 | — |

The dataset was selected because it contains the most lateral width information out of all the times and powers used during experimentation. The dataset showed a clear increase in lateral width as the photoinitiator concentration is increased. At 20% PI, however, this trend appeared to be broken, but this can be attributed to insignificant data at this photoinitiator concentration. The time of light exposure does influence lateral growth, increasing the amount of surplus free radicals present in the solution. However, the data indicate that the relative influence of time was less significant than the influence of photoinitiator concentration on the resulting lateral width of the cantilever beam. Interestingly, the resulting width of the cantilever beams appears to be varied, with some PI concentrations showing a slight increase or decrease in width with increasing exposure time. This variance can be attributed to both poor process control and the variation of crosslinking propagation from excess free radicals.

As outlined previously, the Galilean beam expander collimation knob can influence the beam angle of the incident light while attenuating the output power, meaning the data between exposure powers is not directly comparable. Due to this, the data necessitated grouping by the output power of the beam expander.

Table 10 shows the data corresponding to the lateral width (LW), and standard deviation of total lateral width (σ_{Lw}) of the samples for the parameters outlined.

TABLE 10
Lateral Width Data for Exposure Times Between 4 and
14 Seconds for Various Photoinitiator Concentrations

| | | | | |
|---|---|---|---|---|
| Pϕ | [PI] | L̅W | σ_{Lw} | Nₙₑₜ |

| | | | | |
|---|---|---|---|---|
| Mask | Average of Mask #8 | 10.25 | 0.83 | 49 |

| | | | | | | |
|---|---|---|---|---|---|---|
| #8 | 10 | mW | All | 11.07 | 0.89 | 13 |
| | 10 | mW | 2.5% PI | 9.96 | 0.23 | 3 |
| | 10 | mW | 5.0% PI | 10.38 | 0.47 | 3 |
| | 10 | mW | 15.0% PI | 11.68 | 0.45 | 6 |
| | 13.75 | mW | All | 9.89 | 0.63 | 25 |
| | 13.75 | mW | 2.5% PI | 8.83 | 0.58 | 3 |
| | 13.75 | mW | 5.0% PI | 9.41 | 0.28 | 3 |
| | 13.75 | mW | 10.0% PI | 10.15 | 0.54 | 7 |
| | 13.75 | mW | 15.0% PI | 10.76 | 0.18 | 6 |
| | 15.5 | mW | All | 10.04 | 0.26 | 11 |
| | 15.5 | mW | 5.0% PI | 10.09 | 0.50 | 1 |
| | 15.5 | mW | 10.0% PI | 10.04 | 0.28 | 6 |

| | | | | |
|---|---|---|---|---|
| Mask | Average of Mask #11 | 16.03 | 3.23 | 5 |

| | | | | | | |
|---|---|---|---|---|---|---|
| #11 | 10 | mW | All | 17.47 | 0.37 | 4 |
| | 10 | mW | 5.0% PI | 17.48 | 0.46 | 3 |
| | 10 | mW | 15.0% PI | 17.42 | — | 1 |
| | 13.75 | mW | All | 10.29 | — | 1 |
| | 10 | mW | 10% PI | 10.29 | — | 1 |

The data supported the prior literature regarding the correlation between photoinitiator concentration and lateral growth. Lateral growth by itself does not inherently indicate a failure to meet the system specifications of predictable geometry fabrication. Rather, through the quantification of this lateral growth, specific predictions can be made about the resulting cured geometry. The correlation between lateral growth, photoinitiator concentration, and light collimation was further observed in FIG. 18O.

Two important results can be obtained from the figure: lower power exposure from the Galilean beam expander correlates to a greater beam angle and increasing mol fraction of the photoinitiator strongly linearly correlates with the lateral size of the cured part. For the twenty-five 13.75 mW single-layer CL prints, a linear trendline can be fit to the lateral size of the cured geometry (y) to the mol fraction of the PI (x), displaying an average 0.067 mm increase in lateral width, or a 0.033 mm linear increase for every percent addition of photoinitiator mol fraction.

### Creation of Unsupported Geometry

Using the material compositions, system design, and process parameters developed throughout the study, several print tests were performed to evaluate the ability of the FISP system to fabricate unsupported geometry. The study confirmed that it is possible to create unsupported three-dimensional structures through photopolymerization within the FISP system.

The set of resin material compositions identified for utilization within this example was an 80% HDDA 15% DMPA 5% EHA resin composition. The associated set of process parameters that result in no deflection and a homogeneous cure was from an exposure of 10 mW, 365 nm UV light for 8-9 seconds. These parameters result in a cure depth of 0.20 mm, and sufficient layer adhesion occurred when the control system z-axis platform was moved 0.18 mm between layers.

To evaluate, sets of unsupported geometries were fabricated within the system. Three geometries were evaluated: overhanging bridge geometry compared to a commercial SLA system, a macro-cantilever beam, and a multi-layer print at a shallow angle.

Bridge geometry with a large overhang was created to validate the ability of the system to print unsupported overhangs. The printed geometry had a 20×12×1.8 mm bridge between the supporting struts, fabricated from 10 layers. This geometry was evaluated against a commercial SLA printer (Bottom-up, Formlabs Form 3 printer, black resin, 25 um layer height) to evaluate the retention of dimensional accuracy of part fabrication in accordance with the research sub-hypothesis. FIG. 18P displays the resulting bridge geometry in comparison to the commercial SLA part.

The prints from both printing systems highlight some of the advantages and disadvantages of the current FISP design. When observing the top of the FISP print, voids and rounded corners can be seen due to imperfections in the printing setup. Parts can be weakened from unvacated air during the start of the print that finds its way into the part when raising and lowering subsequent layers. The lack of a fluid management and resin refill system results in insufficient resin to resupply the used resin layer. The beam expansion of the partially collimated light from the Galilean beam expander, and the lateral growth of the photopolymer create rounded edges in large-area exposures. In the side view, the bridge of the FISP print is not perfectly level, as both the FEP film and print bed are manually located and subject to placement error. In the FISP print, however, the layers did not delaminate in the unsupported section of the bridge, unlike the commercial print. This showed a successful demonstration of the FISP system in reducing support structure necessity.

The study determined that a reasonable demonstration of support structure reduction would be from the fabrication of multi-layer part geometry less than 19°-from-level, and a cantilever beam overhang area of at least 10×10 mm with a thickness between 150-200 μm. These geometries were developed as baseline metrics to evaluate the hypothesis to the primary research question. Utilizing the outlined set of parameters and material compositions, single-layer cantilever beam prints and multi-layer 15° overhang prints were fabricated within the FISP system. FIG. 18Q displays the resulting part geometries.

In the left column of FIG. 18Q, printed geometry is displayed 90 degrees from the vertical, with single-layer geometry. Using the inputs described, the resulting cantilever beam was 26.9×10.5×0.2 mm, with overhangs on each side of the build plate, the largest of which was 17 mm. The 17 mm overhang displayed an 85:1 length-to-height aspect ratio, a ratio 1.6 times greater than previously reported in prior literature, even within microstructure geometry fabrications. The deflection present within the beam was evidentially less than the thin layer thickness (200 μm).

In the right column, printed geometry was displayed for a 15° overhang for twenty 0.18 mm thick layers. The angle of the printed overhang was less than the minimum recommended angle of 19° outlined in the study, even though the length of the part geometry was lesser than that presented within Formlabs, limited by the absence of a resin refill system. The resulting overhang was 13 mm wide, 14.2 mm long, and 3.6 mm tall, with a resulting volume of approximately 665 mm³.

Both geometries displayed a low degree of print discrepancies, with no observable porosity or fracturing. The overall print speed of the experimental FISP system with a 9s exposure, Is delay, and a z-axis move speed of 0.0039 mm/s was predicted and observed to be approximately 22.5 mm/hr. This print speed made the experimental FISP system competitive to existing commercial printing systems and fits within the desired system control specifications.

The properties of the 15% molar PI resin formulation can be extrapolated to other printing systems as a method of increasing individual layer stiffness and reducing the relative effects of internal part strains.

### Discussion

Much literature in the last two decades has been produced for the process optimization of existing SLA systems to decrease print time and material waste from support structures through the optimization of support structure placement and the design. The optimization of support structure design included the optimization of their shape and structure. Print orientation is a primary area of focus in minimizing support structures. A method of support structure reduction was achieved through a weighting algorithm of overhanging area and support volume of support structures, which are factored into an algorithm for print direction optimization (see D. T. Pham, S. S. Dimov, and R. S. Gault, “Part Orientation in Stereolithography,” The International Journal of Advanced Manufacturing Technology, vol. 15, no. 9, pp. 674-682, 1999). Another study proposed a genetic algorithmic optimization of fabrication direction to reduce post-production time was reported through a weighting schema between print and post processing time, resulting in an overall reduction of support structures in many print orientations through a balance of the time-dependent weighting factors. Utilizing a compromise DSP, a computational method of support structure reduction had been completed through the optimization of layer thickness, and hatch spacing to achieve desired surface finish, build time, and accuracy (see J. E. McClurkin and D. W. Rosen, “Computer aided build style decision support for stereolithography,” Rapid Prototyping Journal, vol. 4, no. 1, pp. 4-13, 1998). It had been suggested that support-free 3D printing can be achieved by completely eliminating overhangs, through algorithmically splicing CAD geometry into separate sections that can be printed separately (see X. Wei, S. Qiu, L. Zhu, R. Feng, Y. Tian, J. Xi, and Y. Zheng, “Toward Support—Free 3D Printing: A Skeletal Approach for Partitioning Models,” IEEE Transactions on Visualization and Computer Graphics, vol. 24, no. 10, pp. 2799-2812, 2018). This method was effective in reducing the surface defects in 3D printing, but required the part geometry to be split up and reattached after production through the use of adhesives or fasteners, severely impacting the functionality of implementing the process. These are a few of many examples of print direction and support structure fabrication optimization in existing literature. However, these studies focused on the reduction of supports in existing processes, and do not consider methods of reducing support structures through the development of novel process design.

Support structure placement in SLA was necessitated to reduce deflection and dislocation of part geometry during fabrication. Some methods of support structure reduction through the redesign of the system have been proposed. One group of researchers utilized a fine powder within the liquid photopolymer to increase the viscosity of the solution to act as a support for the layers above, but does not detail any theory on how this functionally reduces the support structure necessity (see A. Y. C. Nee, J. Y. H. Fuh, and T. Miyazawa, “On the improvement of the stereolithography (SL) process,” Journal of Materials Processing Technology, pp. 262-268, 2001). It may be inferred that the authors argue that the viscosity of the fluid provides a force counteracting deflection from internal stresses; however, the minimal reduction of warping within the part geometry could also be reasoned to be due to the differing material composition.

The force required to separate a part from a build window in which there is no oxygen inhibition has been modeled and experimentally validated using a linear elastic fracture mechanic model (see F. Yadegari, R. Fesharakifard, and F. Barazandeh, “Numerical and experimental investigation of effective parameters on separation force in bottom-up stereolithography process,” (in en), AUT Journal of Mechanical Engineering, vol. 5, no. 3, pp. 4-4, 2021), where the authors quantify the pull-off force with crack propagation, damage initiation, and full separation. For macro geometry with a 10×10 mm cross-section, they reported an experimentally validated separation force of 3N. The model used is based on an interfacial delamination model developed at Georgia Tech (see M. Sai Krishnan, S. Jeyanthi, P. K. Mani, K. T. Hareesh, and M. C. Lenin Babu, “Cohesive Zone Modeling for Predicting Interfacial Delamination in over mold Components,” IOP Conference Series: Materials Science and Engineering, vol. 1128, no. 1, p. 012018, 2021 Apr. 1, 2021), predicting the force required to separate microelectronics through crack tip propagation through cohesive zone modeling. A separate study reports a reduction of separation energy from the build window of 22% through the use of a flexible film by reducing the stiffness of the separation force curve (see X. Wu, C. Xu, and Z. Zhang, “Flexible film separation analysis of LCD based mask stereolithography,” Journal of Materials Processing Technology, vol. 288, p. 116916, 2021/02/01/2021).

Cantilever beam production was the best stand-in for unsupported overhangs within stereolithography, given the similitude between an initial discrete layer within a produced part. Analysis and modelling of defects in unsupported overhanging features in micro-stereolithography have been reported previously (see V. Basile, F. Modica, and I. Fassi, “Analysis and Modeling of Defects in Unsupported Overhanging Features in Micro-Stereolithography,”presented at the ASME 2016 International Design Engineering Technical Conferences and Computers and Information in Engineering Conference, 2016. [Online]. Available: https://doi.org/10.1115/DETC2016-60092), noting the detachment pressure from the build window as the primary factor influencing defects within the production of cantilever beams within commercial applications. Within the constraints of a commercial stereolithography machine, however, the researchers are unable to quantify cantilever geometry deflection due to changes in process parameters or material characteristics. The production of cantilever beam geometry has been conducted for geometries up to 9 mm long, 600 um wide, and 150-200 um thick (see C. Credi, A. Fiorese, M. Tironi, R. Bernasconi, L. Magagnin, M. Levi, and S. Turri, “3D Printing of Cantilever-Type Microstructures by Stereolithography of Ferromagnetic Photopolymers,” ACS Appl Mater Interfaces, vol. 8, no. 39, pp. 26332-26342, Oct. 5 2016). The authors utilize a magnetic coating on an acrylate resin to fabricate cantilever beams responsive to magnetic fields. The author's claim that the small sensitivities of Dₚ and E_{c} coupled with the self-standing properties of the composite resin enabled the fabrication of microcantilevers. It was hypothesized that the same self-standing behavior could be translated to macro geometry applications as within the FISP system, but a demonstration of macro geometry fabrication for beams with a width greater than 600 um is not displayed. The border between microscale and macroscale has been loosely defined as objects that are greater than 100 um, visible with the naked eye, or geometry on the order of millimeters and above (see B. P. Hung, P. Y. Huri, J. P. Temple, A. Dorafshar, and W. L. Grayson, “Chapter 10—Craniofacial Bone,” in 3D Bioprinting and Nanotechnology in Tissue Engineering and Regenerative Medicine, L. G. Zhang, J. P. Fisher, and K. W. Leong Eds.: Academic Press, 2015, pp. 215-230). Macro geometry was defined in this study as a geometry that contains at least two dimensions in the order of millimeters, which are unreasonable to quantify in microns, such as parts that have a cross-sectional area of 10000 μm² or 1 cm².

In a study of multi-material hydrogel cantilevers within stereolithography (see V. Chan, J. H. Jeong, P. Bajaj, M. Collens, T. Saif, H. Kong, and R. Bashir, “Multi-material bio-fabrication of hydrogel cantilevers and actuators with stereolithography,” Lab Chip, vol. 12, no. 1, pp. 88-98, Jan. 7 2012), the authors characterize cantilever beam geometry behavior through the fabrication of beams up to 2×4×0.45 mm. The authors predicted the deflection of the beam due to the introduction of internal stress within the beam and identify deflection in both upward and downward directions. They note the bending angle of the cantilevers would increase as the thickness decreased, where the highest concentration of energy is focused at the face of the surface in the pre-polymer solution. The beams were observed to deflect downward in the Z-direction over time, a result from the PEGDA hydrogels characteristically imbibing water and due to cell traction forces from cardiomyocyte reorganization. A study on the fabrication of polymer ceramics with macro cantilever geometry (see J. M. Hundley, Z. C. Eckel, E. Schueller, K. Cante, S. M. Biesboer, B. D. Yahata, and T. A. Schaedler, “Geometric characterization of additively manufactured polymer derived ceramics,” Additive Manufacturing, vol. 18, pp. 95-102, 2017) has been completed for supported cantilever beams up to 10.7×12.7×2.0 mm to quantify potential relaxation or sagging of the structure during fabrication and post-fabrication heating and pyrolysis. The authors quantified the necessity of supporting structures for overhanging geometry with an aspect ratio of greater than 5:1 (length or width to thickness) was required to maintain geometric fidelity without support, noting the influence of linear shrinkage on the geometric accuracy. Existing literature displayed a gap in the fabrication of macro-sized cantilever geometries, as prior literature has only demonstrated unsupported cantilever geometry less than 10×10 mm in surface area.

Carbon's M1 DLP printer used Continuous Liquid Interface Production (CLIP) technology to print parts at incredible speeds, 20-50 times faster than other SLA or DLP printers. In some cases, using CLIP can make the difference between a print taking 3 hours to about 6 minutes. Though this printer had no support reduction capabilities, its speed was a unique advantage. The same company, Carbon 3D, disclosed a patent application WO/2015/164234 that utilizes an immiscible pool of fluid in which the liquid resin rests atop, similar to the FISP system.

Bhanvadia et al. detail a static liquid constrained interface utilizing Fluorinert, to conduct both continuous and layer-by-layer SLA printing (see A. A. Bhanvadia, R. T. Farley, Y. Noh, and T. Nishida, “High-resolution stereolithography using a static liquid constrained interface,” Communications Materials, vol. 2, no. 1, 2021). This system was capable of printing overhangs of approximately 1.5 mm without sacrificial supports. Using a bottom-up curing approach, they have recently demonstrated the feasibility of printing high-resolution prints with the liquid interface. The associated patent application US 2020/0324466 for “three-dimensional fabrication at inert immiscible liquid interface” included the detail of their fluid interface printing system. The authors note a high stiction force from a solid constrained interface for microstructures and remedy this stiction force through the introduction of a static liquid interface on the surface of the part fabrication zone. They demonstrated microfabrication of geometry for large aspect ratios (up to 50:1), with 60 um wide, 1.5 mm long geometries. The authors presented a system that can produce detailed parts with little fracturing, and successfully introduce the concept of a liquid interface for polymerization.

In contrast, the exemplary systems detailed in the patents and the disclosed process utilizes an inert immiscible liquid in conjunction with a photopolymerizable liquid to fabricate three dimensional objects in which the cured geometry is retained inside of the secondary liquid throughout the printing process. The inert liquid exists to minimize forces due to density differences from the cured resin and the medium in which it rests and therefore reduce support structure necessity when printing.

This is contrary to the cured geometry in which photopolymerization occurs after the irradiating UV light passes through some portion of the inert immiscible liquid. The inert fluid acts as a medium in which to prevent stiction to the build window, a barrier to control oxygen inhibition throughout the fluid, and a method to draw heat from the printing system.

There exists little literature regarding the subject of surface tension in Stereolithography. This may be due in part to the relatively low magnitude of surface tension forces, and in part due to surface tension's complexity. In the fabrication of microstructures using stereolithography, the surface tension was noted as one of the predominant forces acting upon the parts at their scale (see C. W. Ha and D. Yang, “Fabrication of micro open structure using 3D laser scanning method in nano-stereolithography,” in 2014 International Conference on Manipulation, Manufacturing and Measurement on the Nanoscale (3M-NANO), 27-31 Oct. 2014 2014, pp. 299-303); however, the authors made no estimation for the magnitude of these forces acting upon the parts and instead designed the parts to have a minimal surface area to counteract it. Surface tension has been used beneficially in Stereolithography to reduce discrepancies between layers by curing small menisci between layers (see P. E. Reeves and R. C. Cobb, “Reducing the surface deviation of stereolithography using in-process techniques,” Rapid Prototyping Journal, vol. 3, no. 1, pp. 20-31, 1997), but no evaluation of the forces from surface tension was made.

1. A method for forming a three-dimensional workpiece, comprising:
(i) dispensing a resin in a liquid state into a container configured to house a support fluid to form a fluid interface having (a) a resin layer above and in immediate contact with (b) the support fluid, wherein the resin is substantially immiscible with the support fluid;
(ii) irradiating at least a portion of the resin layer at the fluid interface with light to polymerize an irradiated portion of the resin layer as a current build layer of the three-dimensional workpiece at the fluid interface, wherein a portion of the three-dimensional workpiece is affixed to a build platform immersed in the support fluid; and
(iii) advancing the build platform to a next position in the support fluid to submerge the current build layer within the support fluid,
wherein the process (i), (ii), and (iii) is repeated to successively build the workpiece in the support fluid.

2. The method of claim 1, wherein the support fluid has a density and/or viscosity greater than the resin.

3. The method of claim 1, wherein the support fluid comprises water, an aqueous solution, or a non-aqueous liquid.

4. The method of claim 1, wherein the support fluid consists of water or an aqueous solution.

5. The method of claim 1, wherein the resin is irradiated through a build window located above or in contact with the support fluid.

6. The method of claim 5, wherein the build window comprises a build window material having reduced stiction with the current build layer thus formed.

7. The method of claim 5, wherein the build window material comprises an oxygen-permeable material.

8. The method of claim 5, wherein the build window material comprises a fluoropolymer.

9. The method of claim 1, further comprising:
removing a portion of the support fluid from the container to maintain the fluid interface or a height level of the support fluid at a pre-defined position.

10. The method of claim 1, wherein each resin layer above and in immediate contact with the support fluid has a pre-defined thickness.

11. The method of claim 10, further comprising:
adjusting a controller parameter when dispensing the resin into the container to maintain the pre-defined thickness.

12. The method of claim 1, further comprising:
varying a property of the resin or selecting from different resins to vary the successive layers of the workpiece.

13. The method of claim 1, further comprising:
varying the density of the resin or selecting from different resins between at least one successive layer to a next successive layer to form a gradient density in the workpiece.

14. The method of claim 1, further comprising:
adjusting, via a heat exchanger, temperature of the support fluid, wherein the support fluid cools the three-dimensional workpiece during fabrication.

15. The method of claim 1, further comprising:
monitoring, via an interferometry system, the current build layer to measure its thickness, degree of cure, or other property.

16. A liquid additive manufacturing system for building a three-dimensional workpiece, the liquid additive manufacturing system comprising:
a container configured to house a support fluid;
a dispensing module configured to dispense a resin into or over the support fluid of the container to form a fluid interface having a resin layer above and in immediate contact with the support fluid, wherein the resin is substantially immiscible with the support fluid;
a light projection system configured to irradiate and polymerize a portion of the resin layer at the fluid interface with light to form a top polymer layer;
a mechanized-arm system having a build platform immersed in the support fluid of the container; and
a controller having (i) a processor and (ii) a memory operatively coupled to the processor and having instructions stored thereon, wherein execution of the instructions causes the processor to direct a successive build of the workpiece in the support fluid by:
directing the dispensing module to dispense a current resin portion to form a current fluid interface of the workpiece over the support fluid, wherein the workpiece has a layer coupled to the build platform of the mechanized-arm system;
directing the light projection system to irradiate a portion of the current resin portion at the current fluid interface with light to polymerize the irradiated portion as a current build layer of the workpiece; and
advancing the build platform of the mechanized-arm system into a next position in the support fluid to submerge the current build layer within the support fluid.

17-31. (canceled)

32. A three-dimensional workpiece formed by the method of claim 1.

33. A three-dimensional workpiece formed by the system of claim 16.
